(19) United States
(12) Patent Application Publication
(10) Pub. No.: US 2026/0157823 A1
(43) Pub. Date: Jun. 11, 2026

(54) DENTAL APPLIANCES AND ASSOCIATED METHODS OF MANUFACTURING

(71) Applicant: Brius Technologies, Inc., Carrollton, TX (US)

(72) Inventors: James Sylvester Wratten, Jr., Waterville, NY (US); Seyed Mehdi Roein Peikar, Carrollton, TX (US); Yuchen Xu, Dallas, TX (US); Muhammad Fawwad, Carrollton, TX (US)

(21) Appl. No.: 18/706,878

(22) PCT Filed: Nov. 3, 2022
(86) PCT No.: PCT/US2022/079193

§ 371 Date: May 2, 2024

Related U.S. Application Data
(60) Provisional application No. 63/275,401, filed on Nov. 3, 2021.

(51) Int. Cl. A61C 7/02; A61C 7/00; A61C 7/14; A61C 7/20

(52) U.S. Cl. CPC A61C 7/02; A61C 7/145; A61C 7/20; A61C 7/002

(57) ABSTRACT

Orthodontic appliances and associated devices, systems, and methods of manufacturing are disclosed herein. Various embodiments of the present technology, for example, are directed to a shape forming fixture configured to be secured to an orthodontic appliance such that the appliance conforms to the shape forming fixture and assumes a desired 3D configuration. In some embodiments, a shape forming fixture can be configured to accurately, efficiently, and releasably retain a portion of an appliance at an intended location relative to other portions of the appliance. A method of manufacturing an orthodontic appliance in accordance with several embodiments of the present technology can comprise obtaining an appliance in a first configuration, securing the appliance to a shape forming fixture such that the appliance assumes a desired 3D configuration, and setting a shape of the appliance such that the appliance maintains the 3D configuration when released from the shape forming fixture.

### CROSS-REFERENCE TO RELATED APPLICATION(S)

The present application claims the benefit of priority to U.S. Provisional Ser. No. 63/275,401, filed Nov. 3, 2021, which is incorporated by reference herein in its entirety.

The present application is related to the following applications, each of which is incorporated by reference herein in its entirety: U.S. Provisional Ser. No. 62/842,391, filed May 2, 2019; U.S. patent application Ser. No. 16/865,323, titled DENTAL APPLIANCES, SYSTEMS AND METHODS, filed May 2, 2020; International Patent Application No. PCT/US20/31211, titled DENTAL APPLIANCES, SYSTEMS AND METHODS, filed May 2, 2020; U.S. Provisional Ser. No. 62/956,290, filed Jan. 1, 2020; U.S. patent application Ser. No. 15/929,443, titled DENTAL APPLIANCES AND ASSOCIATED SYSTEMS AND METHODS OF USE, filed May 2, 2020; U.S. patent application Ser. No. 15/929,444, titled DENTAL APPLIANCES AND ASSOCIATED SYSTEMS AND METHODS OF USE, filed May 2, 2020; U.S. Patent Application No. PCT/US 20/70017, titled DENTAL APPLIANCES AND ASSOCIATED SYSTEMS AND METHODS OF USE, filed May 2, 2020; U.S. patent application Ser. No. 15/929,442, titled DENTAL APPLIANCES AND ASSOCIATED METHODS OF MANUFACTURING, filed May 2, 2020; International Application No. PCT/US20/70016, titled DENTAL APPLIANCES AND ASSOCIATED METHODS OF MANUFACTURING, filed May 2, 2020; U.S. Provisional Ser. No. 62/704,545, titled DENTAL APPLIANCES AND ASSOCIATED SYSTEMS AND METHODS OF USE, filed May 15, 2020; U.S. patent application Ser. No. 17/302,227, titled DENTAL APPLIANCES AND ASSOCIATED SYSTEMS AND METHODS OF USE, filed Apr. 27, 2021; International Patent Application No. PCT/US21/70469, titled DENTAL APPLIANCES AND ASSOCIATED SYSTEMS AND METHODS OF USE, filed Apr. 27, 2021; International Patent Application No. PCT/US21/30377, titled DENTAL APPLIANCES AND ASSOCIATED METHODS OF MANUFACTURING, filed May 1, 2021; U.S. patent application Ser. No. 17/518,547, titled ORTHODONTIC TREATMENT AND ASSOCIATED DEVICES, SYSTEMS, AND METHODS, filed Nov. 3, 2021; and U.S. patent application Ser. No. 17/518,549, titled ORTHODONTIC TREATMENT AND ASSOCIATED DEVICES, SYSTEMS, AND METHODS, filed May 1, 2021.

### TECHNICAL FIELD

The present technology relates to the field of orthodontics. Some embodiments of the present technology are directed to devices, systems, and methods for designing and manufacturing orthodontic appliances.

### BACKGROUND

A common objective in orthodontics is to move a patient's teeth to positions where the teeth function optimally and aesthetically. To move the teeth, the orthodontist may begin by obtaining multiple scans and/or impressions of the patient's teeth to determine a series of corrective paths between the initial positions of the teeth and the desired ending positions. The orthodontist then fits the patient to one of two main appliance types: braces or aligners.

Traditional braces consist of brackets and an archwire placed across a front side of the teeth, with elastic ties or ligature wires to secure the archwire to the brackets. In some cases self-ligating brackets may be used in lieu of ties or wires. The shape and stiffness of the archwire as well as the archwire-bracket interaction governs the forces applied to the teeth and thus the direction and degree of tooth movement. To exert a desired force on the teeth, the orthodontist often manually bends the archwire. The orthodontist monitors the patient's progress through regular appointments, during which the orthodontist visually assesses the progress of the treatment and makes manual adjustments to the archwire (such as new bends) and/or replaces or repositions brackets. The adjustment process is both time consuming and tedious for the patient and more often than not results in patient discomfort for several days following the appointment. Moreover, braces are not aesthetically pleasing and make brushing, flossing, and other dental hygiene procedures difficult.

Aligners comprise clear, removable, polymeric shells having cavities shaped to receive and reposition teeth to produce a final tooth arrangement. Aligners offer patients significantly improved aesthetics over braces. Aligners do not require the orthodontists to bend wires or reposition brackets and are generally more comfortable than braces. However, unlike braces, aligners cannot effectively treat all malocclusions. Certain tooth repositioning steps, such as extrusion, translation, and certain rotations, can be difficult or impossible to achieve with aligners. Moreover, because the aligners are removable, success of treatment is highly dependent on patient compliance, which can be unpredictable and inconsistent.

Lingual braces are an alternative to aligners and traditional (buccal) braces and have been gaining popularity in recent years. Two examples of existing lingual braces are the Incognito™ Appliance System (3M United States) and INBRACE® (Swift Health Systems, Irvine, California, USA), each of which consists of brackets and an archwire placed on the lingual, or tongue side, of the teeth. In contrast to traditional braces, lingual braces are virtually invisible, and, unlike aligners, lingual braces are fixed to the patient's teeth and force compliance. These existing lingual technologies, however, also come with several disadvantages. Most notably, conventional lingual appliances still rely on a bracket-archwire system to move the teeth, thus requiring multiple office visits and painful adjustments. For example, lingual technologies have a relatively short inter-bracket distance, which generally makes compliance of the archwire stiffer. As a result, the overall lingual appliance is more sensitive to archwire adjustments and causes more pain for the patient. Moreover, the lingual surfaces of the appliance can irritate the tongue and impact speech, and make the appliance difficult to clean.

Therefore, a need exists for improved orthodontic appliances.

### SUMMARY

The present technology is directed to orthodontic appliances and associated devices, systems, and methods of manufacturing. In some embodiments, a method of manufacturing an orthodontic appliance comprises securing the appliance to a shape forming fixture such that the appliance assumes a three-dimensional (3D) configuration based on a 3D configuration of the shape forming fixture. A shape forming fixture can comprise one or more securing portions that are each configured to releasably retain an attachment portion of the appliance at an intended position relative to other portions of the appliance. Various embodiments of the present technology are directed to securing portions configured to retain attachment portions at intended locations with high accuracy. Additionally or alternatively, securing portions disclosed herein can be configured to be secured to attachment portions in a manner that is efficient and scalable. The subject technology is illustrated, for example, according to various aspects described below, including with reference to FIGS. 1A-27. Various examples of aspects of the subject technology are described as numbered clauses (1, 2, 3, etc.) for convenience. These are provided as examples and do not limit the subject technology.
1. A device for holding a planar configuration of an orthodontic appliance in a three-dimensional configuration while a heat treatment is applied to the orthodontic appliance, the orthodontic appliance comprising an attachment portion configured to be secured to an orthodontic bracket coupled to a tooth of a patient, the attachment portion comprising a first region and a second region extending at an angle from the first region, the first region being occlusal to the second region, the device comprising:
   a body portion comprising a surface having a shape corresponding at least in part to a gingiva of a patient; and
   a securing portion carried by the body portion and configured to retain the attachment portion in a desired position during the heat treatment, wherein the securing portion comprises a first engagement surface, a second engagement surface, and a gap between the first and second engagement surfaces, wherein the gap is configured to receive the attachment portion such that a first region of the attachment portion is positioned adjacent the first engagement surface and a second region of the attachment portion is positioned adjacent the second engagement surface.
2. The device of Clause 1, wherein the securing portion is configured to limit motion of the attachment portion with respect to the securing portion along a first and second dimension of the securing portion.
3. The device of Clause 2, wherein the first engagement surface is configured to limit motion of the attachment portion along the first dimension.
4. The device of Clause 2 or Clause 3, the second engagement surface is configured to limit motion of the attachment portion along the second dimension. 5. The device of any one of Clauses 2 to 4, wherein the securing portion comprises a third engagement surface configured to limit motion of the attachment portion along the first and/or second dimension.
6. The device of any one of Clauses 1 to 5, wherein, when the attachment is retained by the securing portion at the desired position, the securing portion engages the attachment portion at two or more locations.
7. The device of any one of Clauses 1 to 6, wherein, when the attachment portion is retained by the securing portion at the desired position, two or more edges of the attachment portion are free.
8. The device of any one of Clauses 1 to 7, wherein the securing portion is configured to retain an attachment portion having a width within 0.1 mm and −0.1 mm of a nominal width of the attachment portion.
9 The device of any one of Clauses 1 to 8, wherein at least one of the engagement surfaces comprises a raised region of the securing portion.
10. The device of any one of Clauses 1 to 9, wherein the attachment portion is configured to be releasably secured to the securing portion such that motion of the attachment portion along a third dimension is limited.
11. The device of Clause 10, wherein the attachment portion is configured to be releasably secured to the securing portion of the device by wrapping an elongated member around the attachment portion and the securing portion.
12. The device of Clause 11, wherein the elongated member is wrapped along a generally diagonal path with respect to the first and/or second dimensions.
13. The device of Clause 11 or Clause 12, wherein the securing portion includes a recess configured to receive at least a portion of the elongated member.
14. The device of any one of Clauses 1 to 13, wherein the desired position of the attachment portion is based at least in part on a desired position of a tooth of the patient.
15. The device of any one of Clauses 1 to 14, wherein, when the attachment portion is retained by the securing portion, one or more portions of the appliance substantially conforms to the body portion of the device.
16. The device of any one of Clauses 1 to 15, wherein the attachment portion of the appliance has a first projection extending along a first direction and a second projection extending along a second direction disposed at an angle to the first direction, and wherein, when the attachment portion is retained by the securing portion at the desired position, the first projection engages the first engagement surface and the second projection engages the second engagement surface.
17. The device of Clause 16, wherein the first engagement surface is substantially parallel to the first direction.
18. The device of Clause 16 or Clause 17, wherein the second engagement surface is substantially parallel to the second direction.
19. The device of any one of Clauses 16 to 18, wherein the first and second directions are substantially orthogonal.
20. The device of any one of Clauses 16 to 19, wherein, when the attachment portion is retained by the securing portion at the desired position, a first surface of the first projection engages the first engagement surface and a second surface of the first projection is free and a first surface of the second projection engages the second engagement surface and a second surface of the second projection is free.
21. A method of manufacturing an orthodontic appliance, the method comprising:
   obtaining an orthodontic appliance in a substantially planar configuration, the appliance comprising an attachment portion including a first projection extending along a first direction and a second projection extending along a second direction disposed at an angle to the first direction;
   obtaining a fixture comprising any of the devices of Clauses 1 to 20;
   positioning the attachment portion at the desired position such that the first projection engages the first engagement surface and the second projection engages the second engagement surface;
   securing the appliance to the fixture such that the attachment portion is retained by the securing portion at the desired position; and
   forming a three-dimensional configuration of the appliance while the appliance is secured to the fixture.
22. The method of Clause 21, wherein securing the appliance to the fixture comprises wrapping an elongated member about the securing member and the attachment portion.
23. The method of Clause 22, wherein wrapping the elongated member about the securing member and the attachment portion comprises wrapping the elongated member along a third direction that is disposed at an angle to the first and second directions.
24. The method of Clause 23, wherein the angle is about 45 degrees.
25. The method of any of Clauses 21 to 24, wherein forming the three-dimensional configuration comprises heat-treating the appliance and fixture.
26. A device for forming a three-dimensional configuration of an orthodontic appliance comprising an attachment portion configured to be secured to an orthodontic bracket coupled to a tooth of a patient, the attachment portion comprising first and second regions extending along a first direction and third and fourth regions extending along a second direction disposed at an angle to the first direction, wherein, when the appliance is installed in a mouth of a patient, the first region is closer to the patient's gingiva than the second, third, and fourth regions and the third and fourth regions are closer to the patient's gingiva than the second region, the device comprising:
   a body portion comprising a surface corresponding at least in part to a gingival surface of a patient; and
   a securing portion carried by the body portion and configured to retain the attachment portion of the orthodontic appliance at an intended position, the securing portion comprising first and second engagement surfaces that are substantially parallel to the first direction and a third engagement surface that is substantially parallel to the second direction,
   wherein, when the attachment portion is retained by the securing portion at the intended position, the first region engages the first engagement surface, the second region engages the second engagement surface, and at least one of the third region or the fourth region engages the third engagement surface.
27. The device of Clause 26, wherein, when the attachment portion is retained by the securing portion at the intended position, a first surface of the first region engages the first engagement surface, a first surface of the second region engages the second engagement surface, and a first surface of at least one of the third region or the fourth region engages the third engagement surface.
28. The device of Clause 27, wherein, when the attachment portion is retained by the securing portion at the intended position, a second surface of the first region opposite the first surface along a width of the first region does not engage the securing portion.
29. The device of Clause 27 or Clause 28, wherein, when the attachment portion is retained by the securing portion at the intended position, a second surface of the second region opposite the first surface along a width of the second region does not engage the securing portion.
30. The device of any one of Clauses 27 to 29, wherein, when the attachment portion is retained by the securing portion at the intended position, a second surface of the third region opposite the first surface along a width of the third region does not engage the securing portion.
31. The device of any one of Clauses 27 to 30, wherein, when the attachment portion is retained by the securing portion at the intended position, a second surface of the fourth region opposite the first surface along a width of the fourth region does not engage the securing portion.
32. The device of any one of Clauses 26 to 31, wherein the third engagement surface is spaced apart from the first engagement surface along the second direction.
33. The device of any one of Clauses 26 to 32, wherein the third engagement surface is spaced apart from the second engagement surface along the second direction.
34. The device of any one of Clauses 26 to 33, wherein the first engagement surface is spaced apart from the second engagement surface along the second direction.
35. The device of any one of Clauses 26 to 34, wherein the first and second directions are substantially orthogonal.
36. The device of any one of Clauses 26 to 35, wherein the intended position corresponds to or is derived from a desired position of a tooth of the patient to be moved by the appliance.
37. The device of any one of Clauses 26 to 36, wherein when the attachment portion is retained by the securing portion, one or more portions of the appliance substantially conforms to the body portion of the device.
38. A method of manufacturing an orthodontic appliance, the method comprising:
   obtaining an orthodontic appliance in a substantially planar configuration, the appliance an attachment portion configured to be secured to an orthodontic bracket coupled to a tooth of a patient, the attachment portion comprising first and second regions extending along a first direction and third and fourth regions extending along a second direction disposed at an angle to the first direction, wherein, when the appliance is installed in a mouth of a patient, the first region is closer to the patient's gingiva than the second, third, and fourth regions and the third and fourth regions are closer to the patient's gingiva than the second region;
   obtaining a fixture comprising any of the devices of Clauses 26 to 37;
   positioning the attachment portion at the intended position such that the first region engages the first engagement surface, the second region engages the second engagement surface, and at least one of the third region or the fourth region engages the third engagement surface;
   securing the appliance to the fixture such that the attachment portion is retained by the securing portion at the intended position; and
   forming a three-dimensional configuration of the appliance while the appliance is secured to the fixture.
39. The method of Clause 38, wherein, when the attachment portion is positioned at the intended position, the third region or the fourth region does not engage the first engagement surface, the second engagement surface, or the third engagement surface.
40. The method of Clause 38 or Clause 39, wherein forming the three-dimensional configuration of the appliance while the appliance is secured to the fixture comprises subjecting the appliance and the fixture to heat.
41. The method of Clause 40, wherein subjecting the appliance and the fixture to heat comprises heating to at least 200 degrees centigrade.
42. The method of Clause 41, further comprising, after heating, cooling the appliance and the fixture via liquid quench or air cooling.
43. The method of any one of Clauses 38 to 42, further comprising removing the appliance from the fixture.
44. The method of Clause 43, wherein after removing the appliance from the fixture, the appliance maintains the three-dimensional configuration such that the attachment portion is at the intended position.
45. A device for forming a three-dimensional configuration of an orthodontic appliance comprising an attachment portion having a first projection extending along a first direction and a second projection extending along a second direction disposed at an angle to the first direction, the device comprising:
   a body portion comprising a surface corresponding at least in part to a gingival surface of a patient; and
   a securing portion carried by the body portion and configured to retain the attachment portion of the arm of the orthodontic appliance at an intended position, the securing portion comprising a first channel extending along the first direction, a second channel extending along the second direction,
   wherein, when the attachment portion is retained by the securing portion at the intended position, the first projection is positioned within the first channel and the second projection is positioned within the second channel such that a surface of the first projection is substantially in contact with the first channel and a surface of the second projection is substantially in contact with the second channel.
46. The device of Clause 45, further comprising a third channel extending along a third direction disposed at an angle to the first and second directions, wherein the third channel is configured to receive an elongated member therein such that the elongated member releasably secures the attachment portion of the arm to the securing portion of the device.
47. The device of Clause 45 or Clause 46, wherein the channel extends partially into a thickness of the securing portion.
48. A method of manufacturing an orthodontic appliance, the method comprising:
   obtaining an orthodontic appliance in a substantially planar configuration, the appliance comprising an attachment portion having a first projection extending along a first direction and a second projection extending along a second direction disposed at an angle to the first direction;
   obtaining a fixture comprising any of the devices of Clauses 45 to 47;
   positioning the attachment portion at the intended position such that the first projection is positioned within the first channel and the surface of the first projection is substantially in contact with the first channel and such that the second projection is positioned within the second channel and the surface of the second projection is substantially in contact with the second channel;
   securing the appliance to the fixture such that the attachment portion is retained by the securing portion at the intended position; and
   forming a three-dimensional configuration of the appliance while the appliance is secured to the fixture.
49. The method of Clause 48, wherein, when the attachment portion is positioned at the intended position, another surface of the first projection and another surface of the second projection do not substantially contact the fixture.
50. A device for forming a three-dimensional configuration of an orthodontic appliance comprising an attachment portion configured to be secured to an orthodontic bracket coupled to a tooth of a patient, the device comprising:
   a body portion comprising a surface corresponding at least in part to a gingival surface of a patient; and
   a securing portion carried by the body portion and configured to position the attachment portion of the orthodontic appliance at an intended position, the securing portion comprising an appliance-facing surface including one or more protrusions extending from the appliance-facing surface away from the securing member, wherein the one or more protrusions define at least two engagement surfaces,
   wherein, when the attachment portion is retained by the securing portion at the intended position, the attachment portion contacts the at least two engagement surfaces.
51. The device of Clause 50, wherein, when the attachment portion is retained by the securing portion at the intended position, at least one region of the attachment portion does not contact the at least two engagement surfaces.
52. The device of Clause 50 or Clause 51, wherein the one or more protrusions comprise three protrusions.
53. The device of any one of Clauses 50 to 52, wherein the one or more protrusions define three engagement surfaces.
54. The device of any one of the preceding Clauses, wherein the device comprises a metal.
55. The device of any one of the preceding Clauses, wherein the device is formed by additive manufacturing.
56. The device of any one of the preceding Clauses, wherein the device is formed by investment casting.
57. The device of any one of the preceding Clauses, wherein the body portion is monolithic with the securing portion.
58. The device of any one of the preceding Clauses, further comprising an opening extending therethrough, wherein the opening is configured to receive a fastener therein.
59. The device of any one of the preceding Clauses, wherein the elongated member is a ligature wire.
60. The device of any one of the preceding Clauses, wherein the appliance comprises an anchor configured be positioned adjacent to and extend along the patient's teeth.
61. The device of any one of the preceding Clauses, wherein the appliance comprises an arm extending from a first end positioned at an anchor to a free second end, wherein the free second end includes the attachment portion.
62. The device of any one of the preceding Clauses, wherein the surface of the body corresponds at least in part to a gingival surface of a patient when the patient's teeth are in an original arrangement.
63. The device of any one of the preceding Clauses, wherein the surface of the body corresponds at least in part to a gingival surface of a patient when the patient's teeth are in a final arrangement.
64. The device of any one of the preceding Clauses, wherein, when the attachment portion is retained by the securing portion at the intended position, the anchor substantially conforms to the body portion.
65. A device for forming a three-dimensional configuration of an orthodontic appliance, the device comprising:
   a first forming member comprising a gingiva portion having a first surface and a second surface opposite the first surface along a thickness of the gingiva portion, the first surface having a first topography corresponding at least in part to a topography of a gingival surface of a patient; and
   a second forming member comprising a gingiva portion having a first surface and a second surface opposite the first surface along a thickness of the gingiva portion, the first surface having a second topography, wherein the second topography is complementary to the first topography,
   wherein the orthodontic appliance is configured to be positioned between the first surface of the first forming member and the first surface of the second forming member such that the orthodontic appliance conforms to the first surfaces.
66. The device of Clause 65, wherein the gingival surface is an actual gingival surface of the patient or a predicted gingival surface of the patient.
67. The device of Clause 65 or Clause 66, wherein the first topography is modified with respect to the topography of the gingival surface.
68. The device of any one of Clauses 65 to 67, wherein the first and second forming members are configured to compress the orthodontic appliance between the first surfaces to conform the appliance to the first surfaces.
69. The device of any one of Clauses 65 to 68, wherein the first and second forming members are configured to be releasably secured to one another.
70. The device of any one of Clauses 65 to 69, wherein at least one of the first forming member or the second forming member comprises a fastening portion defining an opening extending therethrough and configured to receive a fastener therein.
71. The device of Clause 70, wherein the fastening portion extends away from the gingiva portion along at least one of a gingival direction or a distal direction.
72. The device of any one of Clauses 65 to 71, wherein the first forming member comprises a securing portion carried by the gingiva portion, the securing portion being configured to releasably retain an attachment portion of the orthodontic appliance.
73. The device of Clause 72, wherein the securing portion extends away from the gingiva portion along an occlusal direction.
74. The device of any one of Clauses 65 to 73, wherein the gingiva portion of the second forming member comprises two or more separate regions configured to be releasably secured to the first forming member.
75. The device of Clause 74, wherein a first one of the two or more separate regions is configured to be positioned at a first side of a mesiodistal midline of the gingiva portion of the first forming member and a second one of the two or more separate regions is configured to be positioned at a second side of the mesiodistal midline of the gingiva portion of the first forming member.
76. The device of any one of Clauses 65 to 75, wherein the first surface of the second forming member has an area less than an area of the first surface of the first forming member.
77. A device for holding an orthodontic appliance in a three-dimensional configuration while forming a shape of the orthodontic appliance, the orthodontic appliance comprising an attachment portion configured to be secured to an orthodontic bracket coupled to a tooth of a patient, the device comprising:
   a body portion comprising a surface having a shape corresponding at least in part to a gingiva of a patient;
   a securing portion carried by the body portion and configured to retain the attachment portion of the orthodontic appliance in a desired position while forming the shape of the orthodontic appliance, wherein the securing portion comprises a first engagement surface, a second engagement surface, and a gap between the first and second engagement surfaces, wherein the gap is configured to receive the attachment portion such that the first engagement surface limits motion of the attachment portion relative to the securing portion along a first dimension and the second engagement surface limits motion of the attachment portion relative to the securing portion along a second dimension angled with respect to the first dimension; and
   a restraint configured to limit motion of the attachment portion with respect to the securing portion along, at least, a third dimension substantially perpendicular to at least one of the first dimension or the second dimension.
78. The device of Clause 77, wherein forming the shape of the orthodontic appliance comprises heat treating the appliance and the device.
79. The device of Clause 77 or Clause 78, wherein the restraint is integral with the securing portion.
80. The device of any one of Clauses 77 to 79, wherein the restraint comprises an arm extending from a first end portion at the securing portion to a second end portion spaced apart from the securing portion, and wherein the arm is movable between an open configuration and a closed configuration.
81. The device of Clause 80, wherein, when the arm is in the closed configuration and the attachment portion is positioned in the gap, the arm limits motion of the attachment portion away from the securing portion.
82. The device of Clause 80 or Clause 81, wherein the arm is movable between the open and closed configurations via deformation of the arm.
83. The device of Clause 77 or Clause 78, wherein the restraint is separate from the securing portion.
84. The device of Clause 83, wherein the restraint is configured to be secured to securing portion via a fastener.
85. The device of Clause 84, wherein the fastener comprises at least one of a screw, a pin, a rod, a clip, a clamp, or a magnet.
86. The device of Clause 84 or Clause 85, wherein the securing portion defines an opening configured to receive the fastener therein.
87. The device of any one of Clauses 77 to 86, wherein the restraint defines an opening configured to receive the fastener therein.
88. A device configured to releasably retain an attachment portion of an orthodontic appliance, the device comprising:
   a retainer comprising a first engagement surface, a second engagement surface, and a gap between the first and second engagement surfaces, wherein the gap is configured to receive the attachment portion such that the first engagement surface limits motion of the attachment portion relative to the securing portion along a first dimension and the second engagement surface limits motion of the attachment portion relative to the securing portion along a second dimension angled with respect to the first dimension; and
   a restraint configured to limit motion of the attachment portion with respect to the securing portion along a third dimension substantially perpendicular to at least one of the first dimension or the second dimension.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B schematically illustrate directional references relative to a patient's dentition.

FIG. 2A shows the schematic representation of an orthodontic appliance configured in accordance with the present technology installed in a patient's mouth adjacent the patient's dentition.

FIG. 2B is a schematic depiction of connection configuration options configured in accordance with embodiments of the present technology.

FIG. 2C is a schematic depiction of a portion of an appliance configured in accordance with embodiments of the present technology.

FIGS. 3A and 3B are elevation views of an appliance configured in accordance with several embodiments of the present technology installed in an upper and lower jaw of a patient's mouth with the patient's teeth in an original tooth arrangement and a final tooth arrangement, respectively.

FIG. 3C depicts example stress-strain curves of nitinol and steel.

FIG. 4 is a flow diagram of a process for making an orthodontic appliance in accordance with the present technology.

FIG. 5 is a flow diagram of a process for making an orthodontic appliance in accordance with the present technology.

FIG. 6 illustrates scanning a patient's teeth to obtain original tooth arrangement data.

FIG. 7 illustrates an example of a digital model of a patient's teeth and gingiva in an original tooth arrangement.

FIG. 8 illustrates an example of a digital model of a patient's teeth and gingiva in a final tooth arrangement.

FIG. 9 illustrates an example of a digital model of a securing member.

FIG. 10 illustrates an example of a digital model of a patient's teeth and gingiva and a plurality of securing members in an original tooth arrangement.

FIG. 11 illustrates an example of a digital model of a patient's teeth and gingiva and a plurality of securing members in a final tooth arrangement.

FIG. 12 illustrates an example of a digital model of a fixture.

FIG. 13 illustrates an example of a digital model of a three-dimensional appliance template that is based on the fixture model.

FIG. 14 illustrates an example of a digital model of a substantially planar appliance template.

FIG. 15 illustrates an example of a digital model of a substantially planar appliance with unique arm geometry based on determined displacement of each tooth.

FIG. 16 illustrates a perspective view of an orthodontic appliance in accordance with embodiments of the present technology.

FIG. 17 illustrates a perspective view of a fixture for forming an appliance in accordance with the present technology.

FIG. 18 is a perspective view of an orthodontic appliance fastened to a fixture in accordance with the present technology.

FIG. 19A is a perspective view of a shape forming fixture in accordance with the present technology.

FIGS. 19B and 19C are front and side views, respectively, of a securing portion of the shape forming fixture shown in FIG. 19A in accordance with the present technology.

FIG. 19D depicts an attachment portion of an orthodontic appliance secured to the securing portion of the shape forming fixture shown in FIGS. 19A-19C in accordance with the present technology.

FIG. 20A depicts an attachment portion of an orthodontic appliance secured to a securing portion of a shape forming fixture in accordance with the present technology.

FIG. 20B is a perspective view of the securing portion of FIG. 20A in accordance with the present technology.

FIG. 21A is a perspective view of a securing portion for a shape forming fixture in accordance with the present technology.

FIGS. 21B-D are left, right, and back views, respectively, of the securing portion shown in FIG. 21A.

FIG. 21E depicts an attachment portion of an orthodontic appliance positioned at a broad surface of the securing portion shown in FIGS. 21A-21D.

FIG. 21F depicts the attachment portion of the orthodontic appliance of FIG. 21E secured to the securing portion of FIGS. 21A-21E.

FIG. 22A is a side view of an attachment portion secured to a securing portion assembly in accordance with the present technology.

FIGS. 22B-22E are perspective views of the attachment portion, a securing portion, a restraint, and a locker, respectively, of FIG. 22A.

FIG. 23A is a side view of an attachment portion secured to a securing portion assembly in accordance with the present technology.

FIGS. 23B and 23C are perspective views of a securing portion and a restraint, respectively, of the securing portion assembly shown in FIG. 23A.

FIG. 24A depicts a shape forming comprising first and second forming members in accordance with the present technology.

FIG. 24B depicts an isolated view of the first forming member of the shape forming fixture shown in FIG. 24A.

FIG. 25 depicts a shape forming fixture comprising first and second forming members in accordance with the present technology.

FIG. 26 depicts a shape forming fixture in accordance with the present technology.

FIG. 27 depicts a shape forming fixture in accordance with the present technology.

### DETAILED DESCRIPTION

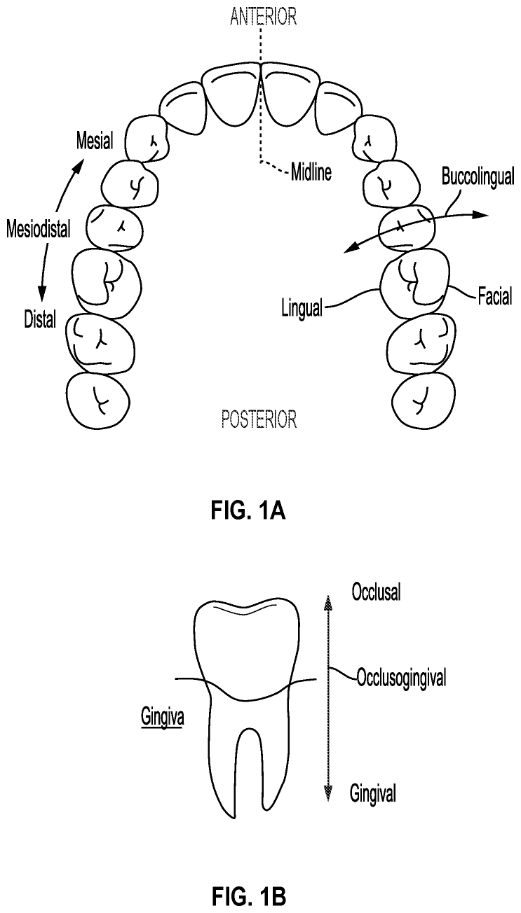

The present technology relates to orthodontic appliances and associated devices, systems, and methods of manufacturing. Some embodiments of the present technology, for example, are directed to a devices and methods for forming a 3D configuration of an appliance. Various embodiments are directed to a shape forming fixture configured to facilitate efficiently and accurately securing and conforming an appliance to the shape forming fixture. In some embodiments, a shape forming fixture is configured to facilitate positioning an attachment portion of an appliance at a specific location relative to other portions of the appliance. Specific details of several embodiments of the technology are described below with reference to FIGS. 1A-27.

### I. Definitions

FIGS. 1A and 1B schematically depict several directional terms related to a patient's dentition. Terms used herein to provide anatomical direction or orientation are intended to encompass different orientations of the appliance as installed in the patient's mouth, regardless of whether the structure being described is shown installed in a mouth in the drawings. As illustrated in FIGS. 1A and 1B: “mesial” means in a direction toward the midline of the patient's face along the patient's curved dental arch; “distal” means in a direction away from the midline of the patient's face along the patient's curved dental arch; “occlusal” means in a direction toward the chewing surfaces of the patient's teeth; “gingival” means in a direction toward the patient's gums or gingiva; “facial” means in a direction toward the patient's lips or cheeks (used interchangeably herein with “buccal” and “labial”); “lingual” means in a direction toward the patient's tongue; “anterior” means in a direction toward a front of the patient's body; and “posterior” means in a direction toward a back of the patient's body.

As used herein, the terms “proximal” and “distal” refer to a position that is closer and farther, respectively, from a given reference point. In many cases, the reference point is a certain connector, such as an anchor, and “proximal” and “distal” refer to a position that is closer and farther, respectively, from the reference connector along a line passing through the centroid of the cross-section of the portion of the appliance branching from the reference connector.

As used herein, the terms “generally,” “substantially,” “about,” and similar terms are used as terms of approximation and not as terms of degree, and are intended to account for the inherent variations in measured or calculated values that would be recognized by those of ordinary skill in the art.

As used herein, the term “operator” refers to a clinician, practitioner, technician or any person or machine that designs and/or manufactures an orthodontic appliance or portion thereof, and/or facilitates the design and/or manufacture of the appliance or portion thereof, and/or any person or machine associated with installing the appliance in the patient's mouth and/or any subsequent treatment of the patient associated with the appliance.

As used herein, the term “force” refers to the magnitude and/or direction of a force, a torque, or a combination thereof.

### II. Overview of Orthodontic Appliances of the Present Technology

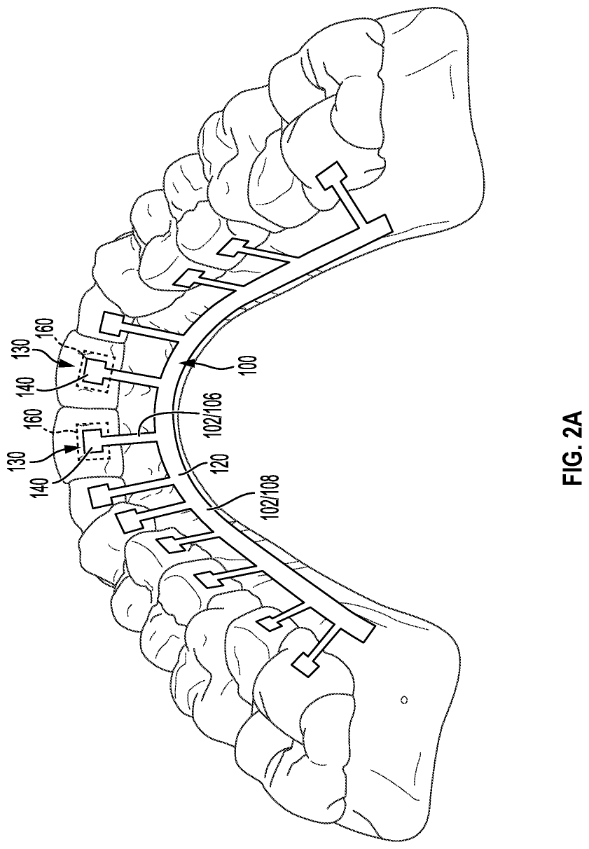

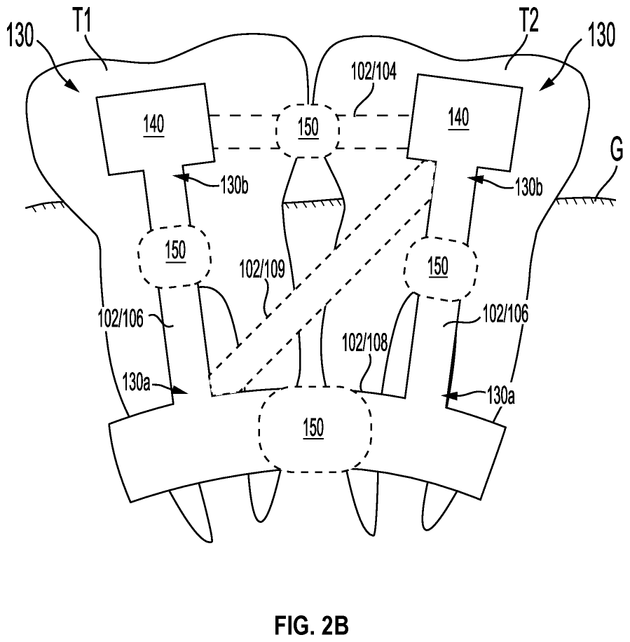

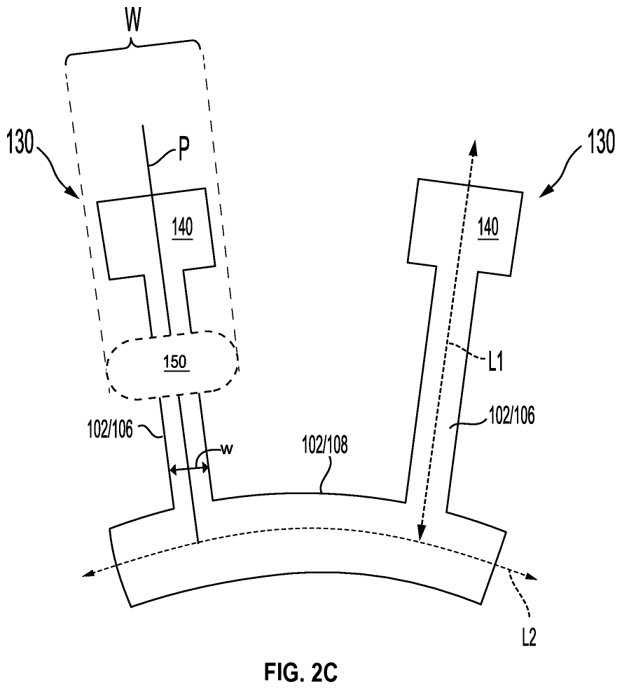

FIG. 2A is a schematic representation of an orthodontic appliance 100 (or “appliance 100”) configured in accordance with embodiments of the present technology, shown positioned in a patient's mouth adjacent the patient's teeth. FIG. 2B is an enlarged view of a portion of the appliance 100. The appliance 100 is configured to be installed within a patient's mouth to impart forces on one or more of the teeth to reposition all or some of the teeth. In some cases, the appliance 100 may additionally or alternatively be configured to maintain a position of one or more teeth. As shown schematically in FIGS. 2A and 2B, the appliance 100 can comprise a deformable member that includes one or more attachment portions 140 (each represented schematically by a box), each configured to be secured to a tooth surface directly or indirectly via a securing member 160. The appliance 100 may further comprise one or more connectors 102 (also depicted schematically), each extending directly between attachment portions 140 (“first connectors 104”), between an attachment portion 140 and one or more other connectors 102 (“second connectors 106”), or between two or more other connectors 102 (“third connectors 108”). Only two attachment portions 140 and two connectors 102 are labeled in FIG. 2A for ease of illustration. As discussed herein, the number, configuration, and location of the connectors 102 and attachment portions 140 may be selected to provide a desired force on one or more of the teeth when the appliance 100 is installed.

The attachment portions 140 may be configured to be detachably coupled to a securing member 160 that is bonded, adhered, or otherwise secured to a surface of one of the teeth to be moved. In some embodiments, one or more of the attachment portions 140 may be directly bonded, adhered, or otherwise secured to a corresponding tooth without a securing member or other connection interface at the tooth. The attachment portions 140 may also be referred to as “bracket connectors” or “male connector elements” herein. The different attachment portions 140 of a given appliance 100 may have the same or different shape, same or different size, and/or same or different configuration. The attachment portions 140 may comprise any of the attachment portions, bracket connectors, and/or male connector elements disclosed in U.S. patent application Ser. No. 15/370,704 (Publ. No. 2017/0156823) filed Dec. 6, 2016, U.S. patent application Ser. No. 15/929,443 (Publ. No. 2021/0007830) filed May 2, 2020, and U.S. patent application Ser. No. 15/929,444 (Publ. No. 2020/0390524) filed May 2, 2020, which are incorporated by reference herein in their entirety.

The appliance 100 may include any number of attachment portions 140 suitable for securely attaching the appliance 100 to the patient's tooth or teeth in order to achieve a desired movement. In some examples, multiple attachment portions 140 may be attached to a single tooth. The appliance 100 may include an attachment portion for every tooth, fewer attachment portions than teeth, or more attachment portions 140 than teeth. In these and other embodiments, the appliance 100 one or more of the attachment portions 140 may be configured to be coupled to one, two, three, four, five or more connectors 102.

As previously mentioned, the connectors 102 may comprise one or more first connectors 104 that extend directly between attachment portions 140. The one or more first connectors 104 may extend along a generally mesiodistal dimension when the appliance 100 is installed in the patient's mouth. In these and other embodiments, the appliance 100 may include one or more first connectors 104 that extend along a generally occlusogingival and/or buccolingual dimension when the appliance 100 is installed in the patient's mouth. In some embodiments, the appliance 100 does not include any first connectors 104.

Additionally or alternatively, the connectors 102 may comprise one or more second connectors 106 that extend between one or more attachment portions 140 and one or more connectors 102. The one or more second connectors 106 can extend along a generally occlusogingival dimension when the appliance 100 is installed in the patient's mouth. In these and other embodiments, the appliance 100 may include one or more second connectors 106 that extend along a generally mesiodistal and/or buccolingual dimension when the appliance 100 is installed in the patient's mouth. In some embodiments, the appliance 100 does not include any second connectors 106. In such embodiments, the appliance 100 would only include first connectors 104 extending between attachment portions 140. A second connector 106 and the attachment portion 140 to which it is attached may comprise an “arm,” as used herein (such as arm 130 in FIGS. 2A and 2B). In some embodiments, multiple second connectors 106 may extend from the same location along the appliance 100 to the same attachment portion 140. In such cases, the multiple second connectors 106 and the attachment portion 140 together comprise an “arm,” as used herein. The use of two or more connectors to connect two points on the appliance 100 enables application of a greater force (relative to a single connector connecting the same points) without increasing the strain on the individual connectors. Such a configuration is especially beneficial given the spatial constraints of the fixed displacement treatments herein.

Additionally or alternatively, the connectors 102 may comprise one or more third connectors 108 that extend between two or more other connectors 102. The one or more third connectors 108 may extend along a generally mesiodistal dimension when the appliance 100 is installed in the patient's mouth. In these and other embodiments, the appliance 100 may include one or more third connectors 108 that extend along a generally occlusogingival and/or buccolingual dimension when the appliance 100 is installed in the patient's mouth. In some embodiments, the appliance 100 does not include any third connectors 108. One, some, or all of the third connectors 108 may be positioned gingival to one, some, or all of the first connectors 104. In some embodiments, the appliance 100 includes a single third connector 108 that extends along at least two adjacent teeth and provides a common attachment for two or more second connectors 106. In several embodiments, the appliance 100 includes multiple non-contiguous third connectors 108, each extending along at least two adjacent teeth.

As shown in FIG. 2A, in some embodiments the appliance 100 may be configured such that all or a portion of one, some, or all of the connectors 102 are disposed proximate the patient's gingiva when the appliance 100 is installed within the patient's mouth. For example, one or more third connectors 108 may be configured such that all or a portion of the one or more third connectors 108 is positioned below the patient's gum line and adjacent to but spaced apart from the gingiva. In many cases it may be beneficial to provide a small gap (e.g., 0.5 mm or less) between the third connector(s) 108 and the patient's gingiva, as contact between the third connector(s) 108 (or any portion of the appliance 100) and the gingiva can cause irritation and patient discomfort. In some embodiments, all or a portion of the third connector(s) 108 is configured to be in direct contact with the gingiva when the appliance 100 is disposed in the patient's mouth. Additionally or alternatively, all or a portion of one or more first connectors 104 and/or second connectors 106 may be configured to be disposed proximate the gingiva.

According to some embodiments, one or more connectors 102 may extend between an attachment portion 140 or connector 102 and a joint comprising (a) two or more connectors 102, (b) two or more attachment portions 140, or (c) at least one attachment portion 140 and at least one connector 102. According to some embodiments, one or more connectors 102 may extend between a first joint comprising (a) two or more connectors 102, (b) two or more attachment portions 140, or (c) at least one attachment member and at least one connector 102, and a second joint comprising (a) two or more connectors 102, (b) two or more attachment portions 140, or (c) at least one attachment portion 140 and at least one connector 102. An example of a connector 102 extending between (a) a joint between a second and third connector 106, 108, and (b) a joint between a second connector 106 and an attachment portion 140 is depicted schematically and labeled 109 in FIG. 2B.

Each of the connectors 102 may be designed to have a desired stiffness so that an individual connector 102 or combination of connectors 102 imparts a desired force on one or more of the teeth. In many cases, the force applied by a given connector 102 may be governed by Hooke's Law, or F=k×x, where F is the restoring force exerted by the connector 102, k is the stiffness coefficient of the connector 102, and x is the displacement. In the most basic example, if a connector 102 does not exist between two points on the appliance 100, then the stiffness coefficient along that path is zero and no forces are applied. In the present case, the individual connectors 102 of the present technology may have varying non-zero stiffness coefficients. For example, one or more of the connectors 102 may be rigid (i.e., the stiffness coefficient is infinite) such that the connector 102 will not flex or bend between its two end points. In some embodiments, one or more of the connectors 102 may be “flexible” (i.e., the stiffness coefficient is non-zero and positive) such that the connector 102 can deform to impart (or absorb) a force on the associated tooth or teeth or other connector 102.

In some embodiments it may be beneficial to include one or more rigid connectors between two or more teeth. A rigid connector 102 is sometimes referred to herein as a “rigid bar” or an “anchor.” Each rigid connector 102 may have sufficient rigidity to hold and maintain its shape and resist bending. The rigidity of the connector 102 can be achieved by selecting a particular shape, width, length, thickness, and/or material. Connectors 102 configured to be relatively rigid may be employed, for example, when the tooth to be connected to the connector 102 or arm is not to be moved (or moved by a limited amount) and can be used for anchorage. Molar teeth, for example, can provide good anchorage as molar teeth have larger roots than most teeth and thus require greater forces to be moved. Moreover, anchoring one or more portions of the appliance 100 to multiple teeth is more secure than anchoring to a single tooth. As another example, a rigid connection may be desired when moving a group of teeth relative to one or more other teeth. Consider, for instance, a case in which the patient has five teeth separated from a single tooth by a gap, and the treatment plan is to close the gap. The best course of treatment is typically to move the one tooth towards the five teeth, and not vice versa. In this case, it may be beneficial to provide one or more rigid connectors between the five teeth. For all of the foregoing reasons and many others, the appliance 100 may include one or more rigid first connectors 104, one or more rigid second connectors 106, and/or one or more rigid third connectors 108.

In these and other embodiments, the appliance 100 may include one or more flexible first connectors 104, one or more flexible second connectors 106, and/or one or more flexible third connectors 108. Each flexible connector 102 may have a particular shape, width, thickness, length, material, and/or other parameters to provide a desired degree of flexibility. According to some embodiments of the present technology, the stiffness of a given connector 102 may be tuned via incorporation of a one or more resiliently flexible biasing portions 150. As shown schematically in FIG. 2B, one, some, or all of the connectors 102 may include one or more biasing portion 150, such as springs, each configured to apply a customized force specific to the tooth to which it is attached.

As depicted in the schematic shown in FIG. 2C, the biasing portion(s) 150 may extend along all or a portion of the longitudinal axis L1 of the respective connector 102 (only the longitudinal axis L1 for second connector 106 and the longitudinal axis L2 for third connector 108 is labeled in FIG. 2C). The direction and magnitude of the force and torque applied on a tooth by a biasing portion 150 depends, at least in part, on the shape, width, thickness, length, material, shape set conditions, and other parameters of the biasing portion 150. As such, one or more aspects of the biasing portion 150 (including the aforementioned parameters) may be varied so that the corresponding arm 130, connector 102, and/or biasing portion 150 produces a desired tooth movement when the appliance 100 is installed in the patient's mouth. Each arm 130 and/or biasing portion 150 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation).

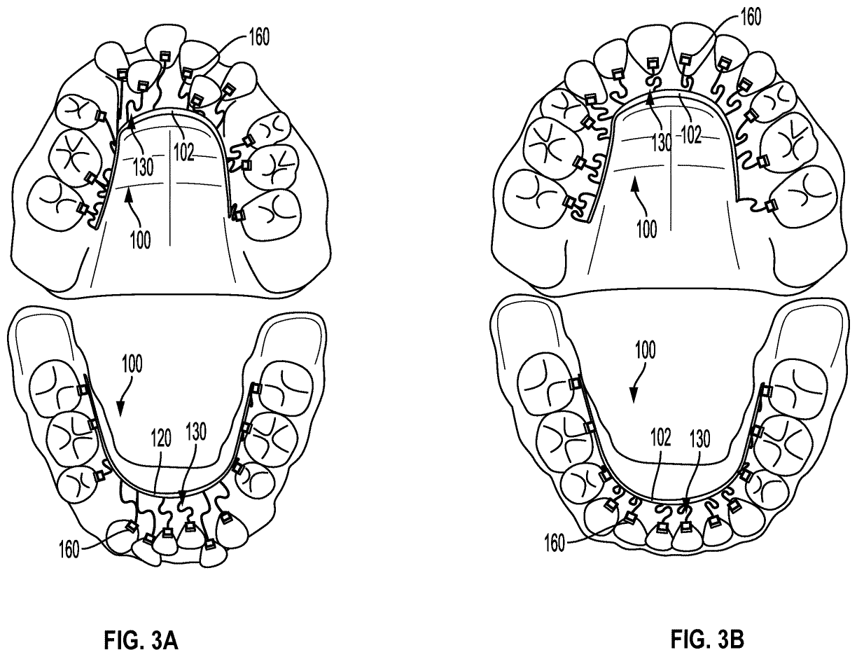

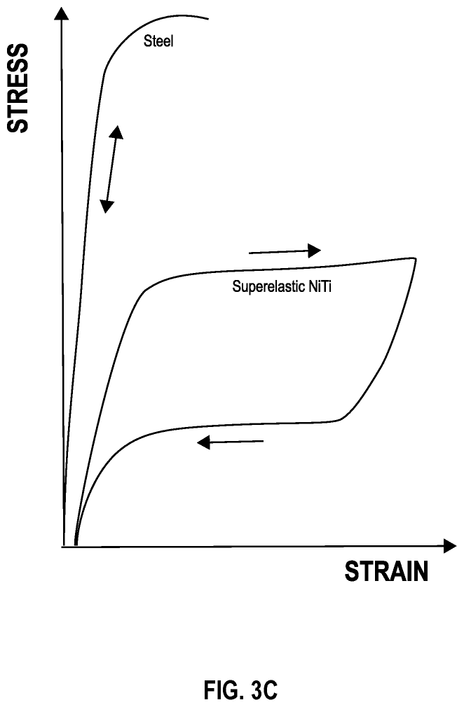

The biasing portions 150 of the present technology can have any length, width, shape, and/or size sufficient to move the respective tooth towards a desired position. In some embodiments, one, some, or all of the connectors 102 may have one or more inflection points along a respective biasing portion 150. The connectors 102 and/or biasing portions 150 may have a serpentine configuration such that the connector 102 and/or biasing portion 150 doubles back on itself at least one or more times before extending towards the attachment portion 140. For example, in some embodiments the second connectors 106 double back on themselves two times along the biasing portion 150, thereby forming first and second concave regions facing in generally different directions relative to one another (as an example, see FIG. 3B). The open loops or overlapping portions of the connector 102 corresponding to the biasing portion 150 may be disposed on either side of a plane P (FIG. 2C) bisecting an overall width W (FIG. 2C) of the arm 130 and/or connector 102 such that the extra length of the arm 130 and/or connector 102 is accommodated by the space medial and/or distal to the arm 130 and/or connector 102. This allows the arm 130 and/or connector 102 to have a longer length (as compared to a linear arm) to accommodate greater tooth movement, despite the limited space in the occlusal-gingival or vertical dimension between any associated third connector 108 and the location at which the arm 130 attaches to the tooth.

It will be appreciated that the biasing portion 150 may have other shapes or configurations. For example, in some embodiments the connector 102 and/or biasing portion 150 may include one or more linear regions that zig-zag towards the attachment portion 140. One, some, or all of the connectors 102 and/or biasing portions 150 may have only linear segments or regions, or may have a combination of curved and linear regions. In some embodiments, one, some, or all of the connectors 102 and/or biasing portions 150 do not include any curved portions.

According to some examples, a single connector 102 may have multiple biasing portions 150 in series along the longitudinal axis of the respective connector 102. In some embodiments, multiple connectors 102 may extend between two points along the same or different paths. In such embodiments, the different connectors 102 may have the same stiffness or different stiffnesses.

In those embodiments where the appliance 100 has two or more connectors 102 with biasing portions 150, some, none, or all of the connectors 102 may have the same or different lengths, the same or different widths, the same or different thicknesses, the same or different shapes, and/or may be made of the same or different materials, amongst other properties. In some embodiments, less than all of the connectors 102 have biasing portions 150. Connectors 102 without biasing portions 150 may, for example, comprise one or more rigid connections between a rigid third connector 108 and the attachment portion 140. In some embodiments, none of the connectors 102 of the appliance 100 have a biasing portion 150.

According to some embodiments, for example as depicted schematically in FIG. 2A, the appliance 100 may include a single, continuous, substantially rigid third connector (referred to as “anchor 120”) and a plurality of flexible arms 130 extending away from the anchor 120. When the appliance 100 is installed in the patient's mouth, each of the arms 130 may connect to a different one of the teeth to be moved and exerts a specific force on its respective tooth, thereby allowing an operator to move each tooth independently. Such a configuration provides a notable improvement over traditional braces in which all of the teeth are connected by a single archwire, such that movement of one tooth can cause unintentional movement of one or more nearby teeth. The independent and customized tooth movement enabled by the appliances of the present technology allows the operator to move the teeth from an original tooth arrangement (“OTA”) to a final tooth arrangement (“FTA”) more efficiently, thereby obviating periodic adjustments, reducing the number of office visits, and reducing or eliminating patient discomfort, and reducing the overall treatment time (i.e., the length of time the appliance is installed in the patient's mouth) by at least 50% relative to the overall treatment time for traditional braces.

The anchor 120 may comprise any structure of any shape and size configured to comfortably fit within the patient's mouth and provide a common support for one or more of the arms 130. In many embodiments, the anchor 120 is disposed proximate the patient's gingiva when the appliance 100 is installed within the patient's mouth, for example as shown in FIG. 2B. For instance, the appliance may be designed such that, when installed in the patient's mouth, all or a portion of the anchor 120 is positioned below the patient's gum line and adjacent but spaced apart from the gingiva. In many cases it may be beneficial to provide a small gap (e.g., 0.5 mm or less) between the anchor 120 (or any portion of the appliance 100) and the patient's gingiva as contact between the anchor 120 and the gingiva can cause irritation and patient discomfort. In some embodiments, all or a portion of the anchor 120 is configured to be in contact with the gingiva when the appliance 100 is disposed in the patient's mouth.

The anchor 120 may be significantly more rigid than the arms 130 such that the equal and opposite forces experienced by each of the arms 130 when exerting a force on its respective tooth are countered by the rigidity of the anchor 120 and the forces applied by the other arms 130, and do not meaningfully affect the forces on other teeth. As such, the anchor 120 effectively isolates the forces experienced by each arm 130 from the rest of the arms 130, thereby enabling independent tooth movement.

According to some embodiments, for example as shown schematically in FIGS. 2A and 2B, the anchor 120 comprises an elongated member having a longitudinal axis L2 (see FIG. 2C) and forming an arched shape configured to extend along a patient's jaw when the appliance 100 is installed. In these and other embodiments, the anchor 120 may be shaped and sized to span two or more of the patient's teeth when positioned in the patient's mouth. In some examples, the anchor 120 includes a rigid, linear bar, or may comprise a structure having both linear and curved segments. In these and other embodiments, the anchor 120 may extend laterally across all or a portion of the patient's mouth (e.g., across all or a portion of the palate, across all or a portion of the lower jaw, etc.) and/or in a generally anterior-posterior direction. Moreover, the appliance 100 may comprise a single anchor or multiple anchors. For example, the appliance 100 may comprise multiple, discrete, spaced apart anchors, each having two or more arms 130 extending therefrom. In these and other embodiments, the appliance 100 may include one or more other connectors extending between adjacent arms 130.

Any and all of the features discussed above with respect to anchor 120 applies to any of the third connectors 108 disclosed herein.

As shown in FIG. 2B, each of the arms 130 may extend between a proximal or first end portion 130a and a distal or second end portion 130b, and may have a longitudinal axis L extending between the first end portion 130a and the second end portion 130b. The first end portion 130a of one, some, or all of the arms 130 may be disposed at the anchor 120. In some embodiments, one, some, or all of the arms 130 are integral with the anchor 120 such that the first end portion 130a of such arms are continuous with the anchor 120. The arms 130 may extend from the anchor 120 at spaced intervals along the longitudinal axis L2 of the, as shown in FIG. 2A. In some embodiments, the arms 130 may be spaced at even intervals relative to each other, or at uneven intervals relative to each other, along the longitudinal axis L2 of the anchor 120.

One, some, or all of the arms 130 may include an attachment portion 140 at or near the second end portion 130b. In some embodiments, for example as shown in FIGS. 2A-2C, one or more of the arms 130 is cantilevered from the anchor 120 such that the second end portion 130b of the cantilevered arm(s) 130 has a free distal end portion 130b. In these and other embodiments, a distal terminus of the attachment portion 140 may coincide with a distal terminus of the arm 130. The attachment portion 140 may be configured to detachably couple the respective arm 130 to a securing member (e.g., a bracket) that is bonded, adhered, or otherwise secured to a surface of one of the teeth to be moved. In some embodiments, the attachment portion 140 may be directly bonded, adhered, or otherwise secured to a corresponding tooth without a securing member or other connection interface at the tooth.

Referring to still to FIGS. 2A and 2B, one, some, or all of the arms 130 may include one or more resiliently flexible biasing portions 150, such as springs, each configured to apply a customized force, torque or combination of force and torque specific to the tooth to which it is attached. The biasing portion(s) 150 may extend along all or a portion of the longitudinal axis L1 of the respective arm 130 between the anchor 120 and the attachment portion 140. The direction and magnitude of the force and torque applied on a tooth by a biasing portion 150 depends, at least in part, on the shape, width, thickness, length, material, shape set conditions, and other parameters of the biasing portion 150. As such, one or more aspects of the arm 130 and/or biasing portion 150 (including the aforementioned parameters) may be varied so that the arm 130 and/or biasing portion 150 produce a desired tooth movement when the appliance 100 is installed in the patient's mouth. Each arm 130 and/or biasing portion 150 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation).

The biasing portions 150 of the present technology can have any length, width, shape, and/or size sufficient to move the respective tooth towards a desired FTA. In some embodiments, one, some, or all of the arms 130 may have one or more inflection points along a respective biasing portion 150. The arms 130 and/or biasing portions 150 may have a serpentine configuration such that the arm 130 and/or biasing portion 150 doubles back on itself at least one or more times before extending towards the attachment portion 140. In FIG. 2B, the arm 130 doubles back on itself two times along the biasing portion 150, thereby forming first and second concave regions facing in generally different directions relative to one another. The open loops or overlapping portions of the arm 130 corresponding to the biasing portion 150 may be disposed on either side of a plane P bisecting an overall width W of the arm 130 such that the extra length of the arm 130 is accommodated by the space medial and/or distal to the arm 130. This allows the arm 130 to have a longer length (as compared to a linear arm) to accommodate greater tooth movement, despite the limited space in the occlusal-gingival or vertical dimension between the anchor 120 and the location at which the arm 130 attaches to the tooth.

It will be appreciated that the biasing portion 150 may have other shapes or configurations. For example, in some embodiments the arm 130 and/or biasing portion 150 may include one or more linear regions that zig-zag towards the attachment portion 140. One, some, or all of the arms 130 and/or biasing portions 150 may have only linear segments or regions, or may have a combination of curved and linear regions. In some embodiments, one, some, or all of the arms 130 and/or biasing portions 150 do not include any curved portions.

According to some examples, a single arm 130 may have multiple biasing portions 150. The multiple biasing portions 150 may be in series along the longitudinal axis L1 of the respective arm 120. In some embodiments, multiple arms 130 may extend in parallel between two points along the same path or along different paths. In such embodiments, the different arms 130 may have the same stiffness or different stiffnesses.

In those embodiments where the appliance 100 has two or more arms 130 with biasing portions 150, some, none, or all of the arms 130 may have the same or different lengths, the same or different widths, the same or different thicknesses, the same or different shapes, and/or may be made of the same or different materials, amongst other properties. In some embodiments, less than all of the arms 130 have biasing portions 150. Arms 130 without biasing portions 150 may, for example, comprise one or more rigid connections between the anchor 120 and the attachment portion 140. In some embodiments, none of the arms 130 of the appliance 100 have a biasing portion 150.

The appliances of the present technology may include any number of arms 130 suitable for repositioning the patient's teeth while taking into account the patient's comfort. Unless explicitly limited to a certain number of arms in the specification, the appliances of the present technology may comprise a single arm, two arms, three arms, five arms, ten arms, sixteen arms, etc. In some examples, one, some, or all of the arms 130 of the appliance may be configured to individually connect to more than one tooth (i.e., a single arm 130 may be configured to couple to two teeth at the same time). In these and other embodiments, the appliance 100 may include two or more arms 130 configured to connect to the same tooth at the same time.

Any portion of the appliances of the present technology may include a biasing portion 150. For example, in some embodiments, portions thereof (e.g., the anchor(s), the arm(s), the biasing portion(s), the attachment portion(s), the link(s), etc.) may comprise one or more superelastic materials.

Additional details related to the individual directional force(s) applied via the biasing portion 150 or, more generally the arm 130, are described in U.S. application Ser. No. 15/370,704, now U.S. Pat. No. 10,383,707, issued Aug. 20, 2019, the disclosure of which is incorporated by reference herein in its entirety.

The appliances disclosed herein and/or any portion thereof (e.g., the anchor(s), the arm(s), the biasing portion(s), the attachment portion(s), the link(s), etc.) may comprise one or more superelastic materials. The appliances disclosed herein and/or any portion thereof (e.g., the anchor(s), the arm(s), the biasing portion(s), the attachment portion(s), the link(s), etc.) may comprise Nitinol, stainless steel, beta-titanium, cobalt chrome, MP35N, 35N LT, one or more metal alloys, one or more polymers, one or more ceramics, and/or combinations thereof.

FIGS. 3A and 3B are elevation views of the appliance 100 installed on both the upper and lower arches of a patient's mouth with the arms 130 coupled to securing members 160 attached to the lingual surfaces of the teeth. It will be appreciated that the appliance 100 of one or both of the upper and lower arches may be positioned proximate a buccal side of a patient's teeth, and that the securing members 160 and/or arms 130 may alternatively be coupled to the buccal surface of the teeth.

FIG. 3A shows the teeth in an OTA with the arms 130 in a deformed or loaded state, and FIG. 3B shows the teeth in the FTA with the arms 130 in a substantially unloaded state. When the arms 130 are initially secured to the securing members 160 when the teeth are in the OTA, the arms 130 are forced to take a shape or path different than their “as designed” configurations. Because of the inherent memory of the resilient biasing portions 150, the arms 130 impart a continuous, corrective force on the teeth to move the teeth towards the FTA, which is where the biasing portions 150 are in their as-designed or unloaded configurations. As such, tooth repositioning using the appliances of the present technology can be accomplished in a single step, using a single appliance. In addition to enabling fewer office visits and a shorter treatment time, the appliances of the present technology greatly reduce or eliminate the pain experienced by the patient as the result of the teeth moving as compared to braces. With traditional braces, every time the orthodontist makes an adjustment (such as installing a new archwire, bending the existing archwire, repositioning a bracket, etc.), the affected teeth experience a high force which is very painful for the patient. Over time, the applied force weakens until eventually a new wire is required. The appliances of the present technology, however, apply a movement-generating force on the teeth continuously while the appliance is installed, which allows the teeth to move at a slower rate that is much less painful (if painful at all) for the patient. Even though the appliances disclosed herein apply a lower and less painful force to the teeth, because the forces being applied are continuous and the teeth can move independently (and thus more efficiently), the appliances of the present technology arrive at the FTA faster than traditional braces or aligners, as both alternatives require intermediate adjustments.

In many embodiments, the movement-generating force is lower than that applied by traditional braces. In those embodiments in which the appliance comprises a superelastic material (such as nitinol), the superelastic material behaves like a constant force spring for certain ranges of strain, and thus the force applied does not drop appreciably as the tooth moves. For example, as shown in the stress-strain curves of nitinol and steel in FIG. 3C, the curve for nitinol is relatively flat compared to that of steel. Thus, the superelastic connectors, biasing portions, and/or arms of the present technology apply essentially the same stress for many different levels of strain (e.g., deflection). As a result, the force applied to a given tooth stays constant as the teeth move during treatment, at least up until the teeth are very close or in the final arrangement. The appliances of the present technology are configured to apply a force just below the pain threshold, such that the appliance applies the maximum non-painful force to the tooth (or teeth) at all times during tooth movement. This results in the most efficient (i.e., fastest) tooth movement without pain.

Embodiments involving multiple steps (or multiple appliances, or both) may include one or more intermediate tooth arrangements (ITAs) between an original tooth arrangement (OTA) and a desired final tooth arrangement (FTA). Likewise, the appliances disclosed herein may be designed to be installed after a first or subsequently used appliance had moved the teeth from an OTA to an ITA (or from one ITA to another ITA) and was subsequently removed. Thus, the appliances of the present technology may be designed to move the teeth from an ITA to an FTA (or to another ITA). Additionally or alternatively, the appliances may be designed to move the teeth from an OTA to an ITA, or from an OTA to an FTA without changing appliances at an ITA.

In some embodiments, the appliances disclosed herein may be configured such that, once installed on the patient's teeth, the appliance cannot be removed by the patient. In some embodiments, the appliance may be removable by the patient.

Any of the example appliances or appliance portions described herein may be made of any suitable material or materials, such as, but not limited to Nitinol (NiTi), stainless steel, beta-titanium, cobalt chrome or other metal alloy, polymers, or ceramics, and may be made as a single, unitarily-formed structure or, alternatively, in multiple separately-formed components connected together in single structure. However, in particular examples, the rigid bars, bracket connectors and loop or curved features of an appliance (or portion of an appliance) described in those examples are made by cutting a two dimensional (2D) form of the appliance from a 2D sheet of material and bending the 2D form into a desired 3D shape of the appliance, according to processes as described in U.S. Pat. No. 10,383,707, U.S. patent application Ser. No. 15/929,442 (Publ. No. 2020/0345455), filed May 2, 2020, or other suitable processes.

### III. Selected Methods for Manufacturing Orthodontic Appliances and Fixtures

Several of the methods disclosed herein can be performed using one or more aspects of a manufacturing system. The system can include an imaging device configured to be communicatively coupled to a computing device. The imaging device can include any suitable device or collection of devices configured to obtain image data or other digital representation of a patient's teeth, gingiva, and other dental anatomy. For example, the imaging device can include an optical scanning device (e.g., as commercially sold by ITERO, 3SHAPE, and others), a cone-beam computed tomography scanner, or any other suitable imaging device.

The computing device can be any suitable combination of software and hardware. For example, the computing device can include a special purpose computer or data processor that is specifically programmed, configured, or constructed to perform one or more of the computer-executable instructions explained in detail herein. Additionally or alternatively, the computing device can include a distributed computing environment in which tasks or modules are performed by remote processing devices, which are linked through a communication network (e.g., a wireless communication network, a wired communication network, a cellular communication network, the Internet, a short-range radio network (e.g., via Bluetooth)). In a distributed computing environment, program modules may be located in both local and remote memory storage devices.

Computer-implemented instructions, data structures, and other data under aspects of the technology may be stored or distributed on computer-readable storage media, including magnetically or optically readable computer disks, as microcode on semiconductor memory, nanotechnology memory, organic or optical memory, or other portable and/or non-transitory data storage media. In some embodiments, aspects of the technology may be distributed over the Internet or over other networks (e.g. a Bluetooth network) on a propagated signal on a propagation medium (e.g., an electromagnetic wave(s), a sound wave) over a period of time, or may be provided on any analog or digital network (packet switched, circuit switched, or other scheme).

The system can also include one or more input devices (e.g., touch screen, keyboard, mouse, microphone, camera, etc.) and one or more output devices (e.g., display, speaker, etc.) configured to be communicatively coupled to the computing device. In operation, a user can provide instructions to the computing device and receive output from the computing device via the input and output devices.

The computing device may be configured to be communicatively connected to one or more fabricating systems (including fabricating machines) for fabricating appliances, shape setting fixtures, and any other components thereof and associated tools, as described herein. The computing device can be connected to the fabricating system(s) by any suitable communication connection including, but not limited to a direct electronic connection, network connection, or the like. Alternatively, or in addition, the connection may be provided by delivery to the fabricating system of a physical, non-transient storage medium on which data from the computing device has been stored.

### Methods of Designing and Manufacturing Orthodontic Appliances and Fixtures

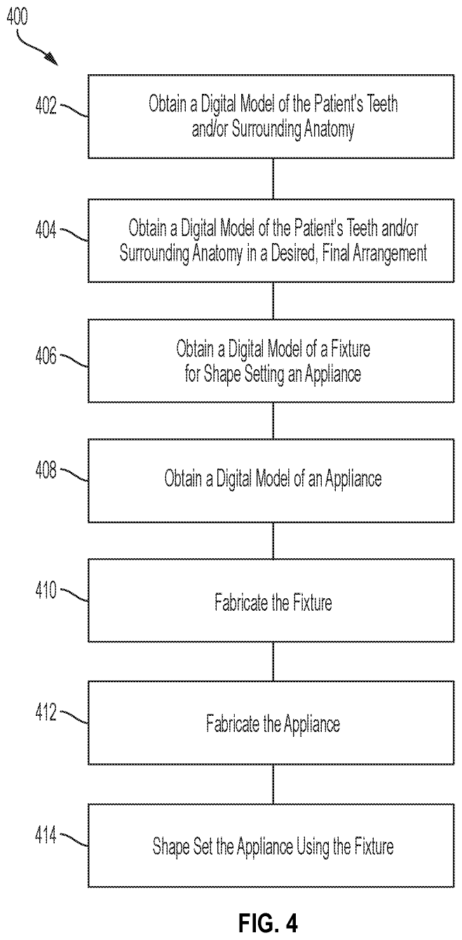

FIG. 4 is a flow diagram of a process 400 for making an orthodontic appliance. The process 400 begins at block 402 with obtaining a digital model of the patient's teeth and/or surrounding anatomy (such as the gingiva) in the OTA. The process 400 continues at block 404 with obtaining a digital model of the patient's teeth and/or surrounding anatomy in the FTA. Next the process 400 comprises obtaining a digital model (block 406) of a fixture for shape setting the appliance. The process 400 further includes obtaining an appliance digital model (block 408). As shown at blocks 410 and 412, the process 400 continues with fabricating the fixture and fabricating the appliance. Finally, the process 400 includes shape setting the appliance using the fixture (block 414). While the foregoing steps are presented in a particular order, it will be appreciated they need not be executed in the presented order. For example, in some embodiments obtaining the appliance digital model occurs prior to and/or at the same time as obtaining the fixture digital model. In other embodiments, obtaining the appliance digital model occurs after and/or at the same time as obtaining the fixture digital model.

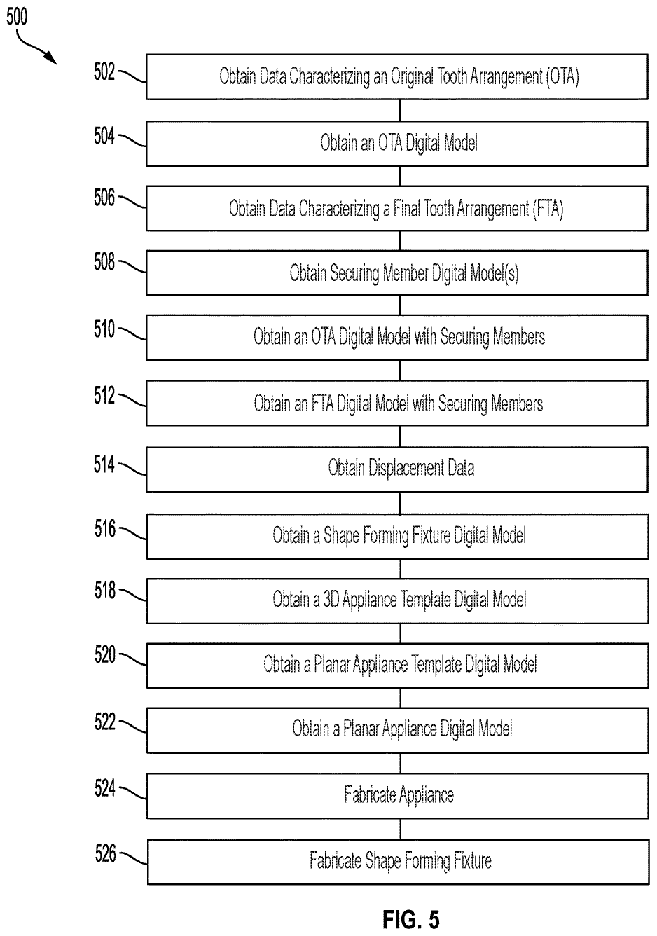

FIG. 5 is a flow diagram of an example process 500 for making an orthodontic appliance of the present technology. The process 500 begins at block 502 with obtaining data characterizing an OTA. For example, as shown in FIG. 6, the OTA data can be obtained by scanning the patient's teeth using an intraoral optical scanner 600. Such a scanner 600 can be used to scan the patient's oral anatomy to obtain data characterizing a property (e.g., a shape, a color, a material property, etc.) of the anatomy. For example, the scanner 600 can be used to scan the patient's upper dental arch, the patient's lower dental arch, one or more of the patient's teeth, the patient's oral tissues (such as gingival tissue), and/or the patient's oral or facial bones. The scanning can be performed using any suitable technique, for example using a dental cone beam CT scanner, a magnetic resonance imaging (MRI) device, or a similar device or technique. In some examples, the OTA data can be obtained using an impression made of the patient's upper and lower jaws (e.g., using polyvinyl siloxane or any other suitable impression material). The impression can then be scanned to create 3D data, which can include the relationship between the upper and lower jaw (e.g., to record the patient's bite). In examples in which impressions are used, the relationship between the teeth in the upper and lower arches (inter-arch relationship) can be obtained by taking a wax bite of the patient in the centric position. In various embodiments, the OTA data can be obtained directly (e.g., by imaging the patient's mouth using an appropriate imaging device) or indirectly (e.g., by receiving pre-existing OTA data from an operator or another source).

The OTA data can include data characterizing the roots of the teeth as well as the exposed portions (e.g., the crowns), which may be advantageous in designing an appropriate orthodontic appliance. Additionally or alternatively, the OTA data can include data characterizing the patient's oral tissues such as the gingiva, palate, tongue, etc.

In some embodiments, the OTA data comprises a point cloud including a plurality of points and coordinates associated with each point. According to various embodiments, the OTA data can comprise image data. For example, the OTA data can comprise one or more 2D images obtained, for example, via mobile phone imaging, CT scanning, MRI, etc.

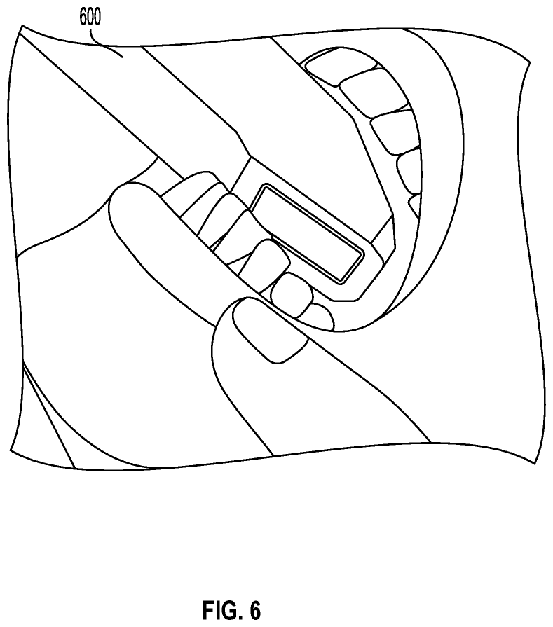

Returning to FIG. 5, the process 500 continues with obtaining an OTA digital model at block 504. FIG. 7 is a graphical representation of an example of an OTA digital model 700. The digital model 700 can virtually represent or characterize the arrangement of the patient's teeth and gingiva in the original tooth arrangement. As seen in FIG. 7, the teeth in the OTA may be maloccluded, mis-aligned, crowded, or otherwise in need of orthodontic correction. In some embodiments, one or more teeth present in the OTA may be designated for extraction prior to use of the orthodontic appliance. The OTA digital model 700 can include a teeth portion 702 comprising one, some, or all of the patient's teeth and a gingiva portion 704.

In some embodiments, the OTA digital model comprises a mesh model (e.g., a triangle mesh model, a polygon mesh model, a volumetric mesh model, etc.), a surface model (e.g., a non-uniform rational basis spline (NURBS) surface model, a T-Spline surface model, etc.), a parametric CAD model, or another suitable type of model. The OTA digital model can be based, at least in part, on the OTA data. For example, if the OTA data comprises a point cloud, obtaining the OTA digital model can comprise converting the point cloud to a 3D surface model via surface reconstruction methods. Such surface reconstruction methods can include, for example, Delaunay triangulation, alpha shapes, ball pivoting, or other suitable methods. In some embodiments, a 3D OTA digital model can be obtained from two or more 2D images. For example, OTA data comprising a plurality of 2D images obtained via CT scanning can be segmented to identify portions of the images that correspond to one or more specific anatomical feature (e.g., bone, soft tissue, a specific tooth or teeth, the mandible, the maxilla, the skull, etc.) and a 3D model can be generated from the segmented image data.

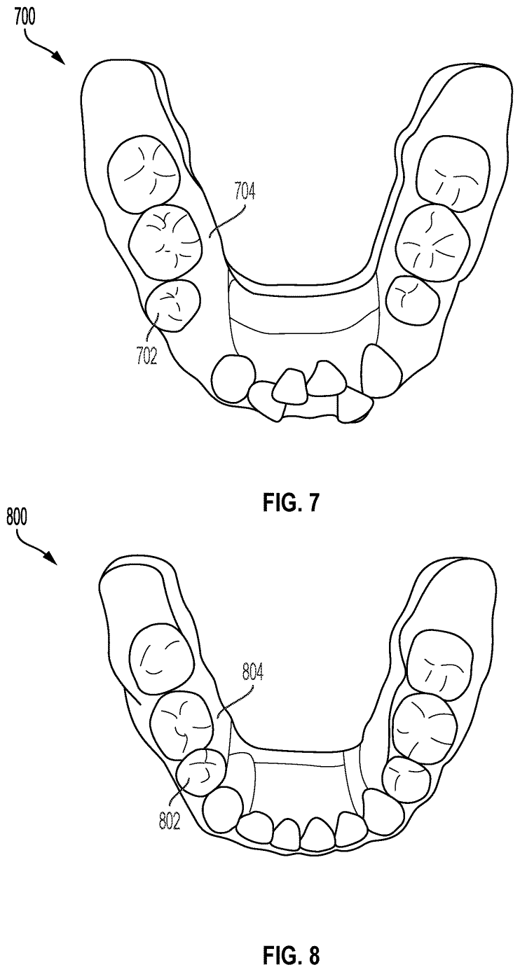

In some embodiments, obtaining the OTA digital model corresponding to the OTA data can include first obtaining a single complex 3D database of the patient's jaw, which is then segmented to separate the patient's teeth into separate 3D bodies (e.g., individual teeth or blocks of multiple teeth) that can then be manipulated virtually by an operator. In embodiments in which the OTA digital model comprises a mesh model, a single, continuous mesh model of the patient's jaw can be segmented to obtain two or more mesh models each characterizing one of the patient's teeth or gingiva. For example, one digital model in an STL file format can be segmented into two or more individual STL files. Such segmentation can be performed using any suitable techniques or software. Following segmentation, the resulting 3D databases of upper and lower teeth can include a model of the gingiva and an independent model of each tooth. As a result, the OTA data can be manipulated by an operator to virtually move teeth relative to the gingiva. For example, at process portion 506, the teeth can be manipulated from the OTA towards a final tooth arrangement (FTA) to obtain FTA data. FIG. 8 illustrates an example digital model 800 of an FTA. Similar to the OTA digital model 700, the FTA digital model 800 includes a teeth portion 802 and a gingiva portion 804. The FTA digital model 800 can be based at least in part on data characterizing the teeth in the FTA. Such FTA data can include a digital representation of the desired final positions and orientations of the patient's teeth relative to one another and to the gingiva. The FTA data can be obtained directly (e.g., generated by the operator) or may be received from an external source (e.g., the FTA data may be generated by a third party and provided to an operator for design of an appropriate orthodontic appliance). In some cases, virtual movement of the teeth relative to the OTA also results in movement of the virtual gingiva (relative to the virtual gingiva in the OTA) in order to maintain the natural look of the gingiva and more accurately reflect the orientation and position of the gingiva when the teeth are at the FTA. This movement of the gingiva can be achieved using gingiva morphing or other suitable techniques. Accordingly, in some embodiments, the gingiva portion 804 in the FTA digital model 800 is different than the gingiva portion 704 in the OTA digital model 700. In some embodiments the gingival surface is not affected by the movement of the teeth and the gingiva portions 804, 704 of the FTA and OTA digital models 800, 700 are substantially the same.

As seen in FIG. 8, the teeth in the FTA digital model may be more aligned, less mal-occluded, and otherwise aesthetically and functionally improved relative to the OTA digital model 700. In some embodiments, the FTA can have desired or favorable inter-arch and intra-arch arrangements, for example, based on an operator's prescription. For example, one or more (or all) teeth from the upper or lower jaws (or both) are moved until their cusps have a good interdigitation and fit.

According to various embodiments, obtaining the OTA digital model and/or obtaining the FTA digital model can comprise obtaining a local coordinate system for one or more portions of the model. For example, in embodiments in which the OTA digital model comprises a plurality of individual models representing individual teeth of a patient, a local coordinate system can be obtained for one or more of the teeth. In some embodiments, the local coordinate system comprises three orthogonal axes. One or more of the three axes can substantially correspond to an occlusogingival dimension of the tooth, a buccolingual dimension of the tooth, and/or a mesiodistal dimension of the tooth. Additionally or alternatively, the axes can comprise other standard anatomical axes (e.g., anteroposterior, mediolateral, longitudinal, etc.) or other suitable axes. An origin of a local coordinate system of a tooth can be located at a center of mass of the tooth, a center of mass of the crown of the tooth, a surface of the tooth, or another suitable location. The location of the origin of the local coordinate system can be selected to facilitate moving and/or aligning the individual tooth models in a digital environment. The local coordinate system for each individual tooth model in the OTA or FTA digital model can be unique to the specific tooth. In some embodiments, the local coordinate systems for two or more individual tooth models can be the same. According to various embodiments, a local coordinate system can be defined for any number or combination of portions of a digital model of the present technology (e.g., an OTA digital model, an FTA digital model, etc.). For example, a local coordinate system can be defined for each of the teeth in one of the patient's dental arches, each of the teeth in one of the patient's dental arches and the surrounding bone of the corresponding jaw (e.g., the mandible or the maxilla), each of the teeth in both of the patient's dental arches, combinations thereof, and/or others.

In some embodiments, individual models of a patient's teeth in an OTA digital model can be virtually moved with reference to the local coordinate system of the tooth to generate an FTA digital model. In various embodiments, a human operator can view and/or interact with the digital models disclosed herein in a digital environment, e.g., via a user interface. The operator can specify a desired movement of one or more of the individual tooth models along and/or about the axes of the local coordinate system of the tooth model. For example, the operator can select (e.g., via an input device such as a mouse) a graphical representation of an axis of a local coordinate system (or a portion thereof) of a tooth model to move the tooth. In some embodiments, selecting the graphical representation of the axis changes the position of the tooth model in the digital environment by a predetermined translation along the axis and/or rotation about the axis. In some embodiments, the operator can select a graphical representation of an allowable movement of an individual tooth model (e.g., a rotation about an axis of a local coordinate system, a translation along an axis of a local coordinate system, etc.) to move the tooth model in the direction of the allowable movement. In some embodiments, selection of the graphical representation of the allowable movement moves the tooth model by a predetermined distance. Additionally or alternatively, an operator can select and drag the graphical representation of the local coordinate system (or a portion thereof) and/or the graphical representation of one or more allowable movements to move the tooth model. A magnitude of the virtual movement of the tooth model can be based, at least in part, on the duration and/or distance of the drag. In some examples, the operator can select the tooth model directly to move the tooth model by a predetermined amount and/or the operator can select and drag the tooth model directly to move the tooth model by an amount is based on the drag duration and/or distance. In various embodiments, the digital environment can include an input field into which an operator can enter a numerical value for a desired movement of the tooth. For example, the digital environment can comprise input fields for translations along the axes of the tooth local coordinate system and/or rotations about the axes of the tooth local coordinate system. According to various embodiments, movement of the teeth in the digital environment can be performed automatically. For example, processors of a computing device can be configured to move the teeth to accomplish an objective such as reducing a contact between adjacent teeth, reducing excessive spacing between the teeth, etc.

Referring back to FIG. 5, the process 500 continues in block 508 with obtaining securing member digital model(s). As discussed previously, securing members (e.g., securing members 160, brackets, etc.) can be coupled to the patient's teeth to allow for an orthodontic appliance (e.g., appliance 100) to be mated thereto. The securing member digital models can include a virtual representation of the geometry and/or other structural characteristics of the securing member(s). The securing member digital model(s) can comprise a mesh model, a parametric CAD model, or any other suitable type of digital model. In various embodiments, the securing member digital models can be identical for each securing member, or may vary among the securing members. For example, different securing members may be used for molars than for incisors. FIG. 9 illustrates an example securing member digital model 900.

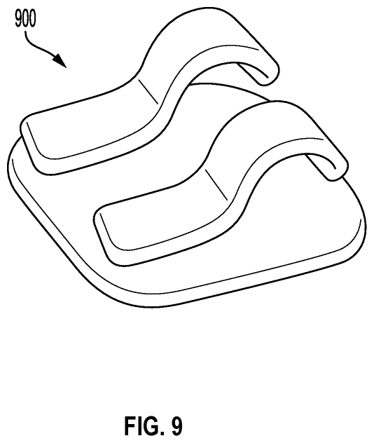

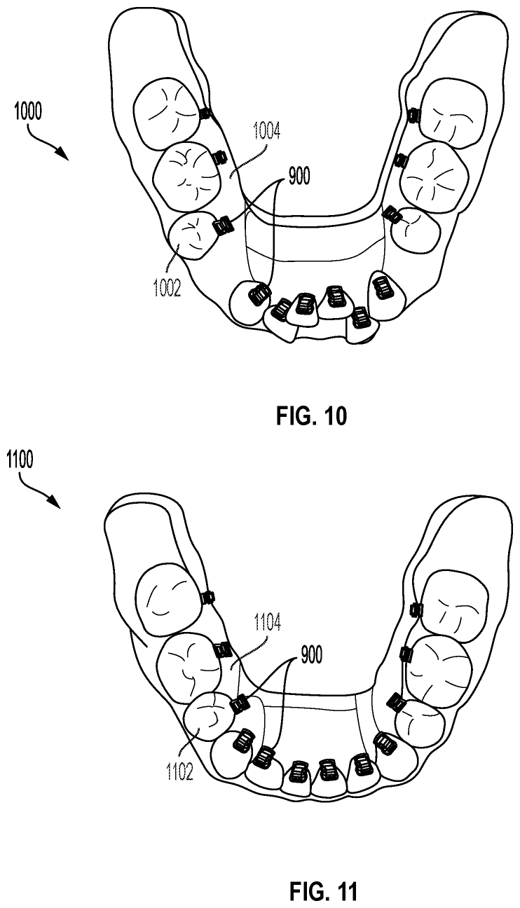

With continued reference to FIG. 5, the process 500 continues in block 510 with obtaining an OTA digital model with securing members positioned on the teeth. For example, a securing member digital model 900 (FIG. 9) can be applied to appropriate locations on the patient's teeth within the OTA digital model 700 (FIG. 7). The resulting digital model 1000 is shown in FIG. 10, in which a plurality of digital models of securing members 900 are disposed at the lingual surfaces of the patient's teeth. In some embodiments, the securing member digital models 900 are disposed at the buccal surfaces of the patient's teeth. The securing member can be positioned on one, some, or all of the teeth of the OTA digital model 700. In some embodiments the process 500 does not include obtaining an OTA digital model with securing members.

In some examples, the digital models 900 of the securing members can be virtually positioned on the teeth in the OTA using appropriate software. In some embodiments, virtually positioning the securing members can include selecting virtual models of particular securing members from a library of available securing members, and then virtually positioning the selected securing members on one or more teeth. In some embodiments, the bracket positioning can be assigned automatically (e.g., by automatically positioning the bracket in a central or the pre-defined portion of the tooth) or manually (e.g., by an operator selecting and/or manipulating the attachment location for each securing member). In some embodiments, the position of each securing member can be refined by the operator as desired. For example, it may be desirable to position the securing members as close to the gingiva as possible so as to avoid interference with securing members on the other jaw or interference with the teeth from the other jaw when the mouth is closed. In various embodiments, the desired position of a securing member on one tooth may be different than the desired position of a securing member on another tooth. For example, it may be advantageous to position securing members on the anterior teeth gingivally to prevent or limit collision of securing members on the upper and lower jaws during chewing, while it may be advantageous to position securing members on the posterior teeth at mesial portions and/or distal portions of the posterior teeth to prevent or limit undesired rotation of the posterior teeth during closing of a space resulting from extraction of one or more of the patient's teeth.

In some embodiments, the OTA digital model with securing members 1000 can be used to determine a configuration of a bonding tray, which may then be used to physically attach securing members to the patient's teeth by an operator. For example, the bonding tray can be configured to fit over the patient's teeth similar to an aligner, and can include recesses on a side of each tooth that are sized and configured to receive an appropriate securing member (e.g., bracket) therein. In various embodiments, such recesses can be positioned on the lingual, buccal, mesial/distal, occlusal, root, or any suitable surface of a tooth to which a corresponding bracket is intended to be bonded. In operation, an appropriate securing member can be placed in each recess of the bonding tray and then an adhesive (e.g., an adhesive that cures when illuminated by ultraviolet light) can be applied to the bonding surface of each securing member. The tray can then be placed over the patient's teeth and the adhesive cured to bond all the securing members to the appropriate location on each tooth.

To generate such a bonding tray, the OTA digital model with securing members 1000 can be manipulated, for example, to remove excess virtual gingiva to limit the size of the tray to only what is necessary to hold the securing members in position against the patient's teeth.

The trimmed digital model can then be used to generate a physical 3D model of the patient's teeth with the securing members disposed thereon, for example using 3D printing in a polymer resin or other suitable technique. In some embodiments, a suitable material (e.g., a clear polymer resin) can then be formed over (e.g., thermoformed over) the physical model of the patient's teeth with securing members in the OTA. This can create the aligner-like tray with recesses shaped and configured to receive securing members therein. The securing members can then be placed into corresponding recesses of the tray, and the tray can be applied to the patient's teeth with a curable adhesive to attach the securing members to the patient's teeth in the OTA. The tray may then be removed, leaving the securing members in place.

In some embodiments, the bonding tray can be 3D printed directly, without the need for a physical model of the patient's teeth and without the use of thermoforming. For example, a digital model of a bonding tray can be derived from the digital model 1000 characterizing the teeth in the OTA with securing members attached. In some embodiments, a negative of the digital model 1000 can be generated then trimmed to provide a general tray-like structure with a surface corresponding to the teeth and securing members in the digital model 1000. This resulting model can be manipulated to provide features for retaining brackets in the corresponding recesses. Finally, the bonding tray can be 3D printed based on this digital model, for example using 3D printable polymer resins or other suitable materials or deposition techniques.

Alternatively, the operator may attach securing members to the patient's teeth directly, without the assistance of a tray.

Referring back to FIG. 5, the process 500 continues at block 512 with obtaining an FTA digital model. In some embodiments, the FTA digital model is generated using the OTA digital model without the securing members (as shown in FIGS. 7 and 8) and the securing members can later be added to the FTA digital model. In some embodiments, the FTA digital model is generated using the OTA digital model with the securing members. In either case, the process 500 includes obtaining an FTA digital model with securing members, an example of which is shown in FIG. 11. As depicted, the FTA digital model 1100 with securing members 900 comprises a teeth portion 1102 and a gingiva portion 1104. The FTA digital model with securing members 1100 can be based at least in part on data characterizing the teeth in the FTA. Such FTA data can include a digital representation of the desired final positions and orientations of the patient's teeth relative to one another and to the gingiva. The FTA data can be obtained directly (e.g., generated by the operator) or may be received from an external source (e.g., the FTA data may be generated by a third party and provided to an operator for design of an appropriate orthodontic appliance).

As previously mentioned, in some embodiments the FTA data can be obtained by manipulating the OTA data to virtually move the patient's teeth. Suitable software can be used by an operator to move the teeth to a desired FTA. For example, a tooth of the OTA digital model can be moved based on translations and/or rotations of the tooth relative to a local coordinate system. In some cases, virtual movement of the teeth relative to the OTA also results in movement of the virtual gingiva (relative to the virtual gingiva in the OTA) in order to maintain the natural look of the gingiva and more accurately reflect the orientation and position of the gingiva when the teeth are at the FTA. This movement of the gingiva can be achieved using gingiva morphing or other suitable techniques. The gingiva portion 1104 of the FTA digital model with securing members may be the same as or different than the gingiva portion 704 of the OTA digital model.

In some embodiments, the FTA can reflect changes to the patient's teeth that may occur as part of the treatment process. For example, an operator may extract one or more teeth of the patient as part of the treatment (for example because of lack of space for all of the teeth to fit in the arch or other reasons). In that event, the extracted teeth can be excluded from the FTA data. If the operator decides that the teeth need to become smaller due to a lack of space, then interproximal reduction (IPR) may be performed on the patient. In this case, stripping and reducing the size of the teeth in the FTA can be performed so as to match the IPR done by the operator.

In some embodiments, a proposed FTA can be developed by an operator (e.g., independently or based in whole or in part on input from a treating orthodontist) and then sent to a treating orthodontist for review and comment. If the treating orthodontist has comments, she can provide input to the operator (e.g., written notes, proposed manipulation of one or more teeth or securing members, etc.) that can be transmitted electronically or otherwise. The operator may then revise the FTA and send a revised proposed FTA back to the treating orthodontist for further review and comment. This iterative process may repeat until the treating orthodontist approves the proposed FTA, and the resulting digital model 1100.

Referring still to FIG. 5, the process 500 continues at block 514 with determining the displacements of individual teeth or groups or teeth between the OTA and the FTA. For example, the displacement of each tooth between the OTA and FTA can be described using six degrees of freedom (e.g., translation along X, Y, and Z axes, and rotation around the same three axes; or alternatively translation along mesiodistal, buccolingual, and/or occlusogingival directions, and rotation in the form of buccolingual root torque, mesiodistal angulation, and/or mesial out-in rotation). In some embodiments, these values can be determined by calculating the difference between the location of each tooth in the FTA data and the OTA data. This can be performed for each tooth in each jaw to generate a dataset that includes the required displacement along six degrees of freedom for each tooth.

In some embodiments, the process 500 can include evaluating proposed displacements of the patient's teeth and, based on the evaluation, modifying the proposed displacements and/or final positions of the patient's teeth. For example, the process 500 can include decomposing an overall displacement of one or more of the patient's teeth into component displacements. A component displacement can comprise a common displacement of all of the patient's teeth, a common displacement of all of the teeth in one of the patient's dental arches, a displacement that is unique to an individual tooth, or another displacement of one or more teeth. Additional details related to evaluating and modifying proposed final positions and displacements of the patient's teeth are described in U.S. patent application Ser. No. 17/518,547, titled ORTHODONTIC TREATMENT AND ASSOCIATED DEVICES, SYSTEMS, AND METHODS, filed concurrently herewith and U.S. patent application Ser. No. 17/518,549, titled ORTHODONTIC TREATMENT AND ASSOCIATED DEVICES, SYSTEMS, AND METHODS, filed concurrently herewith, the disclosure of which are incorporated by reference herein in their entirety.

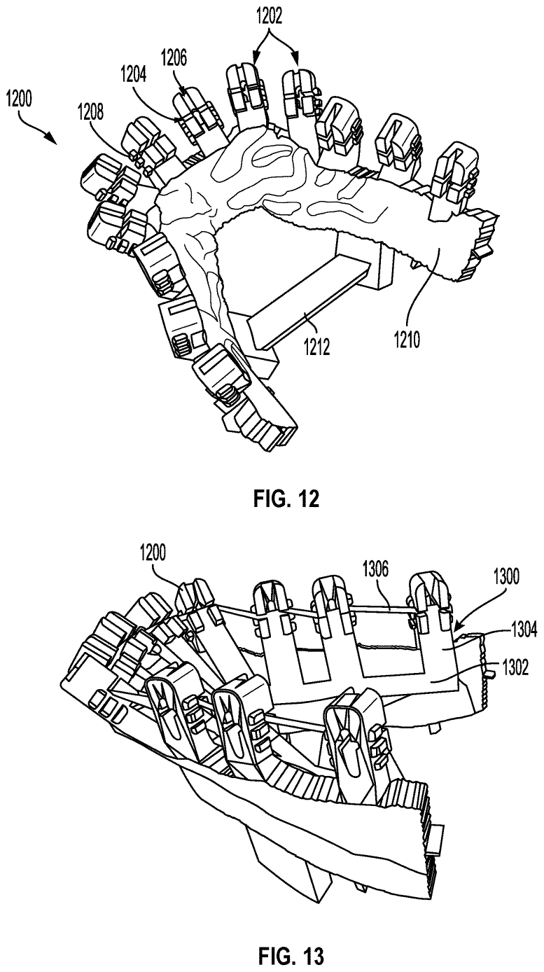

The process 500 continues at block 516 with obtaining a digital model of a fixture that, in its physical form, is used to shape set the appliance. FIG. 12 illustrates an example fixture digital model 1200, which can be generated by manipulating the digital model of the OTA, the digital model of the FTA, the digital model of the OTA with securing members attached, and/or the digital model of the FTA with securing members attached. The digital model(s) 700, 800, 1000, 1100 can be manipulated in a number of ways to generate suitable fixture data.

As shown in FIG. 12, the fixture digital model 1200 can comprise one or more securing portions 1202 and a gingiva portion 1210. In their physical form, the securing portions 1202 can be configured to releasably retain one or more portions of an appliance at a specific location relative to other portions of the appliance. For example, the securing portions 1202 can be configured to retain attachment portions (e.g., attachment portions 140, etc.) of an appliance during a shape setting procedure in positions corresponding to intended positions of corresponding securing members when the appliance is later installed in the patient's mouth and the securing members are secured to the patient's teeth (for example, when the teeth, and thus securing members, are in an OTA or FTA). In some embodiments, the securing portions 1202 are positioned relative to one another and to the gingiva portion 1210 to reflect the positions of the teeth in the FTA. In other embodiments, the securing portions 1202 are positioned to reflect the teeth in the OTA or an ITA.

The fixture model can be generated based on one, some, or all of the OTA and FTA digital models (with and/or without the securing members). In some embodiments, the fixture digital model 1200 can be generated by using one of the FTA digital models to position the securing portions 1202 of the fixture digital model 1200 at desired locations and merging the digital model of the securing portions 1202 with a digital model of the patient's gingiva obtained from one of the OTA digital models. For example, generating the fixture digital model 1200 can include obtaining the “FTA with securing members” digital model and one-by-one replacing individual securing members with individual securing portions such that the securing portions are located at positions corresponding to positions of the securing members in the “FTA with securing members” digital model. In some embodiments, positioning a digital model of a securing portion (e.g., securing portion 1202, etc.) at a position corresponding to a position of a securing member in the “FTA with securing members” digital model comprises aligning a local coordinate system of the securing portion digital model with a local coordinate system of the securing member digital model, which can comprise positioning an origin of the local coordinate system of the securing portion digital model at a position of an origin of the local coordinate system of the securing member digital model. In some cases, axes of the local coordinate system of the securing portion digital model can be aligned with axes of the local coordinate system of the securing member digital model. Additionally or alternatively, the securing portion digital model can be transformed to align the axes of the local coordinate systems.

Once the securing portions 1202 are positioned at their intended locations, the portions of the FTA with securing members digital model corresponding to the securing members, the teeth, and/or the gingiva can be deleted. Additionally or alternatively, the securing members can be replaced with the securing portions in a single step. The resulting digital model can be saved as the fixture digital model 1200 or a component digital model thereof. In some embodiments, obtaining the fixture digital model 1200 comprises merging two or more digital models. For example, obtaining the fixture digital model 1200 can comprise merging the individual digital models of the securing portions 1202 at their intended positions with an individual digital model of the gingiva portion 1210 of the fixture. According to various embodiments, such individual digital model of the gingiva portion 1210 can be obtained from one of the OTA digital models.

In some embodiments, merging the individual models of the securing portions 1202 at their intended positions with an individual digital model of the gingiva portion 1210 can comprise extruding a surface of one or more of the models of the securing portions 1202 to meet the model of the gingiva portion 1210, or vice versa. Such extrusion may be useful or necessary because a securing member, and therefore a corresponding securing portion, will often be positioned occlusally of the patient's gingiva. In such examples, it can be advantageous to extend the securing portion and/or the gingiva to meet one another such that the securing portions and gingiva comprise a single, continuous structure. Extruding a surface of a securing portion to meet the gingiva can comprise obtaining one or more references (e.g., points, lines, surfaces, and/or other features) of the digital model of the securing portion 1202, obtaining one or more corresponding references (e.g., points, lines, surfaces, and/or other features) of the digital model of the gingiva portion 1210, and/or obtaining an extrusion path based on the references of the securing portion and/or the gingiva portion. As but one example, a unique identifier can be assigned to certain distinctive reference points on the securing portion digital model. Such identifiers can comprise a label or a property (e.g., a color, an opacity, etc.). Additionally or alternatively, such reference points can comprise vertices defining a boundary of a surface of the securing portion digital model. An operator or a processor can identify the reference points and/or distinguish the reference points from the rest of the digital model based on the unique identifiers of the reference points. In some embodiments, identifying the reference points comprises identifying 3D coordinates of the reference points. In these embodiments, and in others, obtaining corresponding references of the gingiva portion digital model can comprise identifying points, lines, features, etc. of the gingiva portion digital model that are the closest and/or most similar to the references of the securing portion digital model.

In some embodiments, to obtain the fixture digital model 1200, the digital model(s) 700, 800 without securing members and/or the digital model(s) 1000, 1100 with securing members can be manipulated to remove the teeth or other structural elements not needed for shape setting the appliance, and/or to add structural features to reinforce the fixture for sufficient rigidity during the heat treatment process. For example, as shown in FIG. 12, the fixture model 1200 does not include any teeth, but retains at least a portion of the gingiva portion 1210. Additionally, the fixture model 1200 includes a stabilizing crossbar 1212 that can enhance the rigidity of the resulting fixture. Various other modifications to the digital model(s) 700, 800, 1000, 1100 can be made to achieve the desired fixture model 1200.

The securing portions 1202 can have a geometry configured to facilitate positioning and/or retaining corresponding attachment portions at the intended positions. For example, as shown in FIG. 12, the securing portions 1202 can define first channels 1204 and second channels 1206 angled with respect to the first channels 1204. The first and second channels 1204, 1206 are configured to receive attachment portions of an appliance at least partially therein to locate the attachment portions at their intended positions. The securing portions 1202 can comprise protrusions (e.g., protrusions 1208) extending away from the corresponding securing portion 1202 and defining channels. In some embodiments, the protrusions 1208 define the first and second channels 1204, 1206 and/or the protrusions 1208 can define third channels configured to receive a fastener at least partially therein. For example, an elongate member such as a ligature wire can be wound about one of the securing portions 1202 and an attachment portion of an appliance such that the ligature wire is positioned within channels defined by the protrusions 1208 and secures the attachment portion to the securing portion 1202. The securing portions 1202 can be configured to receive and/or coupled with other fasteners, such as ties, sutures, bands, clasps, and others. In various embodiments, the securing portions 1202 can define one or more through-channels, apertures, or other openings to facilitate securing of an attachment portion to the securing portion 1202 via a fastener. For example, such openings can allow a pushing tool to be inserted from the back of the securing portion 1202 (e.g., through the buccal surface of the fixture model 1200) to push an attachment portion 140 away from the securing portion 1202 after the heat treatment has been completed and the ligature wire or other fastener has been removed.

The gingiva portion 1210 of the fixture model 1200 can be a virtual representation of gingival tissue and, in its physical form, provides a surface on which a portion of the appliance is conformed during a shape setting procedure. The gingiva portion 1210 may be substantially identical to the gingiva portion from any of the OTA or FTA digital models (e.g., 700, 800, 1000, 1100). For example, it can be desirable to use the gingiva portion 704 from the OTA digital model 700 for the gingiva portion 1210 of the fixture model 1200 to prevent or limit impingement of the patient's gingiva by an appliance having a shape based on the fixture model 1200 when the appliance is installed. In some cases, the securing portions 1202 can be positioned to reflect the teeth in the FTA while the gingiva portion 1210 reflects the gingiva in the OTA.

In some embodiments, the gingiva portion 1210 of the fixture model 1200 is a modified version of the gingiva portions from any of the OTA or FTA digital models (e.g., 700, 800, 1000, 1100). When an appliance is installed, a patient may experience considerable discomfort if any portion of the appliance impinges on the gingiva. On the other hand, it is desirable to have the appliance as close to the gingiva as possible to reduce irritation of the tongue (if a lingual device) or lips (if a buccal device). Accordingly, it can be desirable to design the appliance and/or fixture so that the appliance rests as close to the patient's gingiva as possible without impinging. To achieve this balance, in some embodiments the fixture model has a gingiva portion 1210 with a modified shape and/or size relative to the shape and/or size of the gingiva of the OTA digital model, the FTA digital model, the OTA digital model with securing members, or the FTA digital model with securing members. The modifications could affect the curvature of the gingiva and/or the topography. For example, the gingiva portion 1210 of the FTA digital model 1200 can be an enlarged version of the gingiva portion in one of the OTA or FTA digital model(s) 700, 800, 1000, 1100. In such embodiments, a thickness of the gingiva portion 1210 can be modified to adjust a position of one or more surfaces of the gingiva portion 1210 relative to the securing portions 1202. The gingiva can be enlarged by about 0.1 mm, about 0.2 mm, about 0.3 mm, about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, at least about 1.5 mm, at least about 1.4 mm, at least about 1.3 mm, at least about 1.2 mm, at least about 1.1 mm, at least about 1.0 mm, at least about 0.9 mm, at least about 0.8 mm, at least about 0.7 mm, at least about 0.6 mm, at least about 0.5 mm, at least about 0.4 mess, at least about 0.3 mm, at least about 0.2 mm, or at least about 0.1 mm.

While the gingiva portion 1210 can reflect the actual curvature and topography of a patient's gingiva as defined in the OTA or FTA, in other embodiments the gingiva portion 1210 can more crudely represent the gingiva. For example, in some embodiments the gingiva portion 1210 can have the general curvature but not the surface topography of the gingiva from the OTA or FTA digital models. In certain embodiments, the gingiva portion 1210 is not derived from the gingiva portion of any of the models and instead is a generic structure that connects and holds the relative positions of the securing portions 1202. The gingiva portion can also be referred to as a “body portion” herein.

Referring back to FIG. 5, the process 500 continues at block 518 with obtaining an appliance template digital model. FIG. 13 illustrates an example of an appliance template digital model 1300, shown here in a configuration in which the appliance template digital model 1300 is secured to the fixture digital model 1200. In some embodiments, the template model 1300 can comprise an anchor portion 1302, arm portions 1304, and an attachment bar portion 1306. These components can take the form of a genericized template for an appliance that is later customized for a particular patient (as described in more detail below with respect to FIG. 15). For example, the anchor portion 1302 can correspond to the anchor 120 of the completed appliance, and the arm portions 1304 can serve as placeholders for the arms 130 of the completed appliance. The attachment bar portion 1306 takes the form of a continuous strip connecting each of the arms 130. As shown in FIG. 13, the arm portion 1306 can be configured to be received within the channels 1204 of the securing portions 1202 of the fixture model 1200. The attachment bar portion 1306 can correspond in part to portions of the attachment portions 140 of the arms 130 of the completed appliance.

In various embodiments, the appliance template digital model 1300 can be generated using surface data of the fixture model 1200. For example, the appliance template digital model 1300 can be configured to substantially conform to the surface of the fixture model 1200. The anchor portion 1302 can correspond to a curvature and/or topography of the gingiva portion 1210 of the fixture model 1200, for example. The treatment fixture model 1200 can be modified with respect to the OTA and/or FTA models (with or without securing members) by, among other things, enlarging the gingiva. As such, when the anchor portion 1302 contacts the gingiva portion 1210 of the fixture model 1200, the anchor portion 1302 may be positioned so as to be slightly spaced apart from the actual gingiva as characterized in the OTA model 700. In some embodiments, the appliance template model 1300 can have little to no thickness dimension, instead corresponding to a three-dimensional surface following a contour of the fixture model 1200. In some embodiments, the appliance template model 1300 can have at least some thickness.

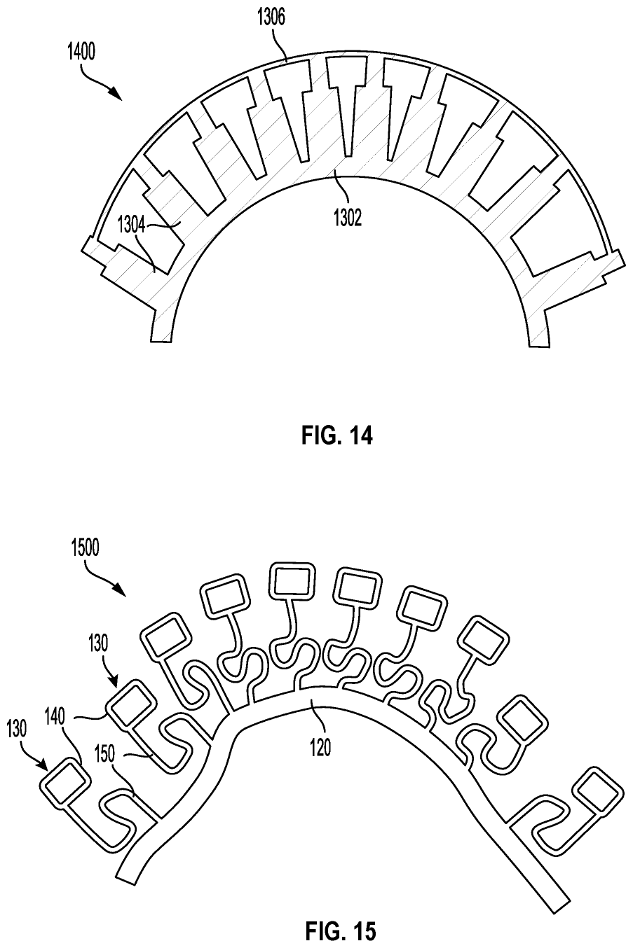

In block 520, the appliance template digital model 1300 can be flattened or otherwise manipulated to generate a planar appliance template model 1400 (FIG. 14). The planar template model 1400 can characterize the appliance template in a 2D or substantially planar data configuration. In some embodiments, the planar appliance template digital model 1400 corresponds to or is at least derived from the contoured appliance template model 1300. For example, the appliance template digital model 1300 (FIG. 13) can be converted into the planar appliance template model 1400 (FIG. 14) by flattening, planarizing, or otherwise converting the digital model 1300 to generate the planar appliance template model 1400. Such conversion may be carried out using a processor system and appropriate software such as, but not limited to ExactFlat®, Solidworks®, Autodesk® Inventor, Creo®, or other suitable software.

At block 522, the planar appliance digital model is obtained. An example of a planar appliance model 1500 is shown in FIG. 15. In this stage, the particular shape and configuration of the arms of the appliance can be determined, such as by modifying or substituting portions or components of the planar template model 1400 (FIG. 14). For example, the particular dimensions, geometry, and material properties of arms of the appliance can be selected so as to apply the necessary force and/or torque to achieve the desired displacement determined at block 512. In some embodiments, a pre-populated library of arm designs can be used to select an appropriate design and configuration to achieve the desired displacement. In some embodiments, the arm designs in the pre-populated library can be analyzed using finite element analysis (FEA) or other techniques to determine the spring force such arms would apply when deflected by particular amounts (e.g., the amount of deflection between the FTA (when the arm is at rest) and the OTA). In some embodiments, fully or partially automated selection of particular arm designs can be reviewed and/or modified by an operator based on relevant criteria. For example, if the proposed arm designs include overlapping or otherwise interfering arms, the operator may manually adjust the shape and/or configuration of the arms.

Based on the determined displacement, the required forces and/or torques required to move each tooth from the OTA to the FTA can be determined. The forces required to move teeth are generally in the range of centiNewtons, and distances moved are typically in the range of millimeters. The amount of moment (Newton-millimeter) acting to rotate a tooth can be found by multiplying the magnitude of the applied force by the force arm. In general, the displacement can be a 3D tooth movement that combines both translational and rotational motion.

The forces and/or torques required to achieve the FTA may depend on the patient's anatomy, for example the size of the particular tooth being moved, the anatomy of the root, etc. The forces and/or torques may also depend on other physiological parameters (e.g., bone density, biological determinants, sex, ethnicity, jaw (maxilla or mandible), mechanical properties of surrounding tissues (lips, tongue, gingiva, and bone) around the moving tooth, etc.). The particular force and/or torque applied to a given tooth will also depend on the particular positioning of the securing member (e.g., bracket). For example, a securing member positioned further off a center-of-resistance of a tooth will generate more torque under a given applied force than a securing member that is positioned nearer to a center-of-resistance of the tooth. Based on the desired displacement (e.g., along six degrees of freedom), the patient's anatomy, and the location of the securing member, a particular arm configuration can be selected to generate the desired force and/or torque on the subject tooth, so as to move the tooth from the OTA to the FTA. By determining appropriate thickness, widths, shapes, and configurations of the arms and other components of the orthodontic appliance, an appliance configuration that applies forces and torques to the appropriate teeth to move the teeth to the FTA is determined.

In particular examples, the design of the appliance may be performed by an operator, with the processor system and appropriate design software such as, but not limited to CAD software such as, but not limited to Solidworks®, Autodesk® Inventor, Creo®, or the like. FEA software such as, but not limited to Abaqus, Ansys, etc. may be employed to design the springs and arms in order to apply the desired or optimal force to the teeth. For example, such software and processing systems may be employed to design and alter the thickness, cut width, length, as well as the overall design of each arm based at least in part on the movement of the tooth to which the arm is connected.

In some examples, if a tooth needs to be displaced by a longer distance or the tooth is smaller (e.g. lower incisors), the arm 130 may be designed such that it is more flexible. In some embodiments, the selection or design of the arms 130 can account for variation in the rate of teeth movement based on direction. It is known that the rate of tooth movement when a given force is applied to the tooth is different depending on the direction of movement. For example, extrusion is the fastest movement for a given force, intrusion is the slowest, and mesiodistal and buccolingual movements are somewhere in between these two extremes. In one example, if a tooth moves 2 mm per month occlusally and 1 mm per month distally under the same applied force, the tooth will not move in a straight line as the occlusal movement will be more rapid than the distal movement. The occlusal movement will finish first, and then the tooth will move in a straight line from there in the distal direction until that motion is complete. It may be desired to move the tooth in a particular trajectory, and so the force applied distally can be different from the force applied occlusally. For example, it may be desired to move the tooth in a straight line, and so the distal force would have to be greater than the occlusal force in order to result in a straight trajectory from OTA to FTA.

In some embodiments, the arms 130 can be designed to impart less force on some or all of the teeth because of periodontal problems such as bone resorption, root resorption or attachment loss. The ability to customize the force or torque (or both) applied to each tooth can provide significant advantages over traditional orthodontics. In particular examples, the computer-aided procedure employs an algorithm for selecting or configuring an arm or other feature of an appliance, for example, from one or more predefined sets of options or one or more ranges of options. Thus, for example, a set of options or a range of options may be predefined for one or more parameters associated with an arm or other feature.

The one or more parameters associated with an arm 130 may include, but are not limited to, the overall length of the arm, the shape or configuration of the biasing portion 150, the shape or configuration of the attachment portion 140, the width dimension of one or more sections of the arm 130, the thickness dimension of one or more sections of the arm 130, or the like.

Obtaining the planar appliance digital model 1500 can also include determining the shape and configuration of the anchor 120. For example, the anchor 120 can be selected so as to substantially conform to the patient's gingiva without impinging thereon. The thickness, depth, or other properties of the anchor 120 can also be selected to provide sufficient rigidity against the forces generated by the arms. In some embodiments, the anchor 120 design can be automatically generated (e.g., by being automatically generated to substantially conform to the patient's gingiva or other location in the FTA model (e.g., model 1100) or the OTA model (e.g., model 700 or 1000). In some embodiments, an operator may manually select or revise the design and configuration of the anchor as desired.

Although in the illustrated embodiment, the specific features of the arms 130 are selected while the appliance model is in a substantially planar or 2D form, in other embodiments the appliance features can be selected and configured based on a digital model that is contoured to correspond to a patient's anatomy. For example, the 3D appliance template model 1300 (FIG. 13) can be modified to select particular arms 130, anchor 120, or any aspects thereof to achieve the desired appliance. In some embodiments, the template is omitted altogether, and a customized appliance model is generated based on the OTA model and/or the FTA model without the use of an intervening template model.

In some embodiments, the planar appliance model 1500 can be 2D, such that the model defines no thickness of the appliance. Such a model can be used, for example, to cut an appliance out of a sheet of material. In such cases, the thickness can be determined by selecting the sheet of material and by polishing, etching, grinding, deposition, or other techniques used to modify a final thickness of the appliance. In some embodiments, the planar appliance model 1500 can define a thickness dimension while remaining substantially planar or flat. For example, the planar appliance model 1500 can define a thickness of the appliance which may be uniform or may vary across some or all of the anchor 120 and arms 130.

In some embodiments, a 3D or contoured appliance model can be generated, for example by manipulating the planar appliance model 1500 into a curved or contoured configuration. In some embodiments, the 3D appliance model can correspond to the appliance mounted to the teeth in the OTA (e.g., by manipulating the planar appliance model 1500 using position data of the securing members 900 in the OTA model 1000 (FIG. 10), or by manipulating the planar appliance model 1500 using position data of the securing members 900 in the FTA model 1100 (FIG. 11)).

With reference to blocks 516, 518 and 520 together, in some examples a computer-aided procedure can be used to select or determine the shape and configuration of the arms, anchor, and/or any other features of an appliance. The procedure may be configured to select one (or more than one) arm, securing member, anchor, or parameter thereof, or any other aspect of the appliance based on one or more input data. For example, input data may include, but is not limited to, a type of a tooth (e.g., molar, canine, incisor, etc.) or a size of a tooth. A larger tooth (such as a molar) may require larger arms or larger, wider or thicker loop or curved features for providing a greater force, than for a smaller tooth (such as an incisor). Additionally or alternatively, input data may include the size of the periodontal ligament (PDL) of one or more teeth. The size of the PDL may be obtained by any suitable process including, but not limited to, CBCT scan or other imaging technique. Other input data may include, but is not limited to, the number or direction of forces to be applied to a tooth or teeth in a three-dimensional space. For example, a desired tooth movement direction may require one or more shapes or configurations of arms that differ from the shapes or configurations required for a different tooth movement direction. Other input data may include but is not limited to, the number or direction of rotational forces (or torque) to be applied to a tooth or teeth. For example, a desired tooth movement in a rotational direction may require one or more shapes or configurations of arms that differ from the shapes or configurations required for a different tooth movement direction. Additionally, in some embodiments two or more arms can be attached to a single tooth, either with each arm coupled to a separate securing member, or with two arms coupled to the same securing member. In such instances, the input data can include a number of arms and/or securing members coupled to each tooth, or alternatively the number of arms and/or securing members can be generated as output data.

In some embodiments, this computer-aided procedure can include an algorithm that includes, as input, (but is not limited to) one or more values representing one or more of: (a) up to three translational and up to three rotational movements from an OTA to an ITA or FTA, or from an ITA to another ITA or FTA; (b) the surface of periodontal ligament (PDL) or the area of the root of a or each tooth; (c) bone density of the patient; (d) biological determinants for example, obtained from saliva, gingival fluid (GCF), blood, urine, mucosa, or other sources; (e) gender of the patient; (f) ethnicity of the patient; (g) the jaw (maxilla or mandible) for which the appliance is to be installed; (i) the number of teeth on which the appliance is to be installed; and (j) mechanical properties of the tissue (lips, tongue, gingiva) and bone around the teeth to be moved. In various embodiments, one or more of such inputs can affect the forces (e.g., magnitude, direction, point of contact) required to move each tooth from the OTA to or toward the FTA.

In other examples, other suitable input data may be employed. The computer-aided process employs a computer programed or configured with suitable non-transient software, hardware, firmware, or combinations thereof, to generate an output (such as one or more selected arm configurations, anchor configurations, or securing member configurations), based on the one or more input data.

An output generated by the computer-aided procedure, based on such input, can include, but is not limited to one or more of: (a) a design of an arm; (b) a width or cut-width of one or more of such arms; (c) a thickness dimension of any portion of the appliance of the entire appliance; (d) mechanical properties of such arms including but not limited to amount of flexibility, or a magnitude of bias force or resilience; (e) a design of an anchor; (f) a width or thickness of the anchor; (g) connection locations between the arms and the anchor; and/or (h) transformational temperature of the nitinol (or other material) in one or more (or each) section of the appliance. As noted previously, in some embodiments the output can include particular configurations selected from among a pre-populated library of anchors and/or arms. For example, based on the inputs, a desired force (e.g., magnitude and direction) can be determined for each tooth. Based on the desired force, an appropriate anchor member and/or arm configuration can be selected that provides the desired force or a suitable approximation thereof. In some embodiments, the configuration of the appliance (including any of the outputs listed above) can be generated independently of any pre-populated library. In some embodiments, generating the output can include analyzing provisional selections or designs using finite element analysis (FEA) or other techniques to determine performance parameters, for example, the spring force such arms would apply when deflected by particular amounts (e.g., the amount of deflection between the FTA (when the arm is at rest) and the OTA).

In particular examples, computer-aided processes can be employed to make customized appliances, for each given patient. In other examples, appliances may be made in a plurality of predefined sizes, shapes, configurations, or the like, based on a population group. Accordingly, a different semi-customized size, shape or configuration would be configured to fit each different selected portion of the population group. In that manner, a more limited number of different appliance sizes, shapes and configurations may be made to accommodate a relatively large portion of the population.

Based on the determined shape and configuration of the arms and the anchor, the full appliance shape data can be generated. In some embodiments, the appliance shape data can take the form of 3D data (e.g., the appliance in its shape-set form following heat treatment or other suitable setting technique) or planar or substantially 2D data (e.g., the appliance in its laid-flat form, for example as cut out from a sheet of material).

At block 524, an appliance can be fabricated (e.g., based on the planar appliance digital model 1500 (block 520). And at block 526, a fixture can be fabricated (e.g., based on the fixture digital model 1200 (block 516). Fabrication of the fixture and the appliance are described in more detail below.

### Methods of Fabricating Orthodontic Appliances

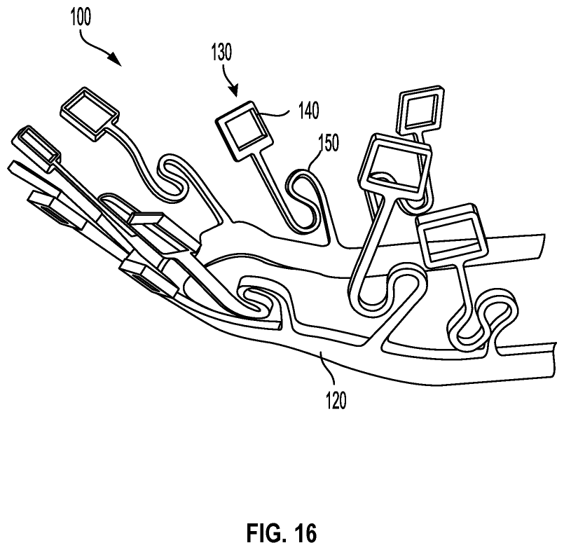

As noted above, one or more digital models can be generated that characterize or define an appliance (e.g., the planar appliance digital model 1500, or a contoured appliance digital model). In various embodiments, one or more such digital models can be used to fabricate an appliance for use in a patient. FIG. 16 illustrates an example of an appliance 100 fabricated using one or more of the digital models described herein. Certain example fabrication processes are described below. However, one of skill in the art will appreciate that any suitable fabrication process may be used to manufacture appliances (or components thereof) as disclosed herein.

In some embodiments, an orthodontic appliance 100 can be fabricated using a planar digital appliance model (e.g., the planar appliance digital model 1500). For example, the planar appliance digital model can include planar or substantially 2D shape data. The planar shape data can be provided to a suitable fabrication device (such as, but not limited to one or more machines that perform cutting, laser cutting, milling, chemical etching, wire electrical discharge machining (EDM), water jetting, punching (stamping), etc.) for cutting a flat sheet of material into a member having a shape corresponding to the planar appliance digital model 1500. The member may be cut from a flat sheet of any suitable material, such as, but not limited to Nitinol, stainless steel, cobalt chrome, or another type of metal, a polymer, a superelastic material, etc. The sheet of material can have a thickness selected to achieve the desired material properties of the resulting member. In various embodiments, the thickness of the sheet of material can be uniform or can vary (e.g., along a gradient, being thinned at particular regions using etching, grinding, etc., or thickened at particular regions using deposition, etc.). In some examples, the sheet can have a thickness of between about 0.1 mm and about 1.0 mm, between about 0.2 mm and about 0.9 mm, between about 0.3 mm and about 0.8 mm, between about 0.4 mm and about 0.7 mm, or about 0.5 mm. In some embodiments, the sheet can have a thickness of less than about 1.5 mm, less than about 1.4 mm, less than about 1.3 mm, less than about 1.2 mm, less than about 1.1 mm, less than about 1.0 mm, less than about 0.9 mm, less than about 0.8 mm, less than about 0.7 mm, less than about 0.6 mm, less than about 0.5 mm, less than about 0.4 mm, less than about 0.3 mm, less than about 0.2 mm, or less than about 0.1 mm.

Next, the cut member can be bent from its substantially planar form into a contoured arrangement. FIG. 16 illustrates an example of a completed appliance 100 resulting from such bending of a planar member. As illustrated, and as described elsewhere herein, the appliance 100 can include an anchor 120 and a plurality of arms 130 extending away from the anchor 120. Each arm 130 can include an attachment portion 140 configured to mate with a securing member adhered to a patient's tooth, and a biasing portion 150 disposed between the attachment portion 140 and the anchor 120. When the appliance 100 is installed in the patient's mouth, each of the arms 130 can connect to a different one of the teeth to be moved and exerts a specific force on its respective tooth, thereby allowing an operator to move each tooth independently.

In some embodiments, the planar member, after being cut from a sheet or otherwise formed, may be bent or otherwise manipulated into a shape or contour corresponding or substantially corresponding to the FTA configuration. For example, the member can be a shape cut from a flat sheet of Nitinol or other suitable material and assume a generally planar configuration. The member can be bent into a desired 3D or contoured configuration, for example corresponding to the contoured appliance digital model 1600. In certain examples, one or more fixtures are configured for use in bending the planar member into the desired 3D shape. In such examples, after cutting the planar member, the planar member can be fixed on or between one or more fixtures and bent or otherwise manipulated to form a desired 3D shape. In some embodiments, either before or after cutting the member from the sheet, the thickness of the member can be modified at least in some portions to achieve desired material properties. For example, the thickness of the member can be reduced in at least some regions using grinding, chemical etching, photoetching, electrical discharge machining, or any other suitable material removal process. The thickness of the member can be increased in at least some regions using thin film deposition, electroplating, or any other suitable additive technique. In some embodiments, the planar member can be formed using 3D printing or other technique instead of or in addition to cutting the planar member from a sheet of material. 3D printing may provide certain advantages, for example ease of controlling the thickness of different portions of the appliance. In some embodiments, the planar member can be formed by 3D printing metal, a polymer, or any other suitable material amendable to additive manufacturing by 3D printing.

In some embodiments, the appliance can be shape set into the desired contoured or 3D configuration (e.g., corresponding to the OTA, the FTA, the fixture, etc.). One or more shape setting procedures, such as, but not limited to heat treatment, may be applied to the appliance while held in the desired 3D shape, during or after the bending operation, to set the desired 3D shape. A shape setting procedure involving a heat treatment may include rapid cooling, following heating of the member during or after bending. Additional details regarding example heat treatment and associated fixtures are described below.

By employing a cut planar member, instead of a traditional single-diameter wire, a greater variety of resulting 3D shapes may be made, as compared to shapes made by bending single-diameter wire. The cut planar member may have designed or varying widths and lengths that, when bent into a desired shape, can result in portions of the 3D appliance having variances in thickness, width and length dimensions. In this manner, the planar member can be cut into a shape that provides a desired thickness, width and length of biasing portions, arms, or other components of the appliance. A larger variety of shapes may be provided by bending a custom cut planar member, as compared to bending a single-diameter wire.

In some examples, the entire appliance (including arms and anchor) is fabricated by bending the cut planar member into the desired 3D shaped member. In other examples, additional components may be attached to the 3D shape, for example, after bending. Such additional components may include, but are not limited to attachment portions 40, biasing portions 150, arms 130, etc. Such additional components may be attached to the 3D shaped member by any suitable attachment mechanism including, but not limited to, adhesive material, welding, friction fitting, etc.

In some embodiments, the appliance can be 3D printed directly into the desired contoured or 3D shaped configuration. In some embodiments, the 3D shaped member can be 3D printed, for example using any suitable material. In cases in which the appliance is 3D printed using Nitinol, there may be no need for a shape-setting process (e.g., heat treatment). Additionally, 3D printing may allow the use of different geometries (e.g., a cross-sectional shape of the anchor member may be oval, rather than rectangular, which may increase patient comfort on both the gingival-facing and lingual-facing sides of the anchor).

### Methods of Shape-Setting Orthodontic Appliances

In various embodiments of the present technology, a physical fixture for use in manufacturing of an orthodontic appliance can be fabricated based on a fixture digital model (such as fixture digital model 1200). The fixture can be used to shape-set the appliance. For example, the appliance can be manufactured in a planar configuration (e.g., cut from a sheet of material, 3D printed, etc.). The appliance can then be manipulated into a desired 3D configuration by securing and/or conforming the appliance to the fixture. The appliance and fixture can undergo a shape setting process while the appliance is retained in the desired 3D configuration by the fixture such that, when the appliance is separated from the fixture, the appliance retains the desired 3D configuration. In some embodiments, the appliance can be manufactured in a non-planar, first 3D configuration and manipulated into a desired second 3D configuration (different than the first 3D configuration) by securing and/or conforming the appliance to the fixture.

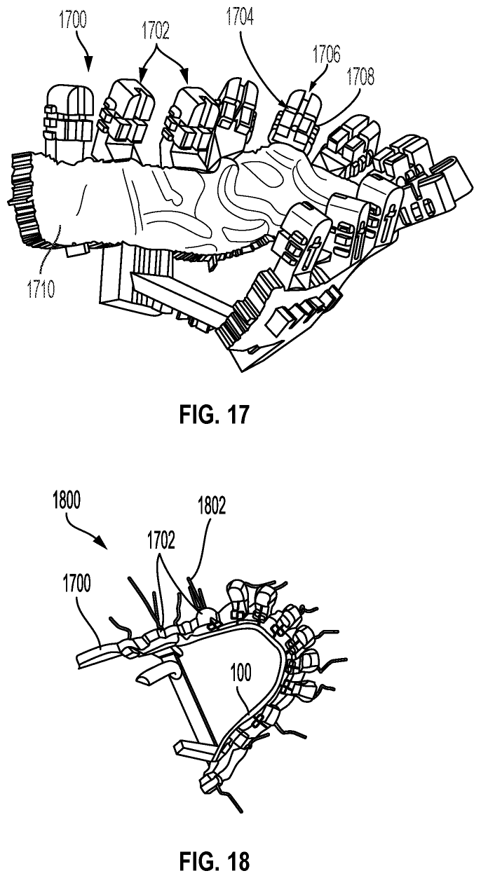

FIG. 17 illustrates an example of a fixture 1700 configured to retain a pre-installation version of the appliance in a desired configuration during a shape setting procedure. The fixture 1700 can be configured to hold a pre-installation version of the appliance in a configuration corresponding to an intended configuration of the appliance when the teeth are in the FTA. When the appliance is removed from the fixture after the shape setting procedure, the appliance is biased to maintain its shape corresponding to the FTA. When the appliance is installed in the patient's mouth in the OTA, the appliance is deformed. Because the appliance is biases to maintain its shape corresponding to the FTA, it will tend to return from a deformed configuration to its intended configuration, and thus will urge the teeth toward their desired, final positions.

The fixture 1700 can be manufactured based on the fixture digital model (e.g., the fixture digital model 1200 (FIG. 12)). For example, the fixture digital model or associated data can be provided to a fabricating system to produce a physical fixture based on the fixture digital model. In one example, the fixture data can be used to 3D print a model of the fixture in wax. The wax model may then be used to investment cast the fixture in brass or other suitable material. In some embodiments, the fixture can be 3D printed directly in brass or other suitable material (e.g., stainless steel, bronze, a ceramic or other material that tolerates high temperatures required for heat treatment).

As shown in FIG. 17, the fixture 1700 can comprise one or more securing portions 1702 and a gingiva portion 1710. The securing portions 1702 can extend away from the gingiva portion 1710. The securing portions 1702 can be configured to releasably retain one or more portions of an appliance at a specific location relative to other portions of the appliance. For example, the securing portions 1702 can be configured to retain attachment portions (e.g., attachment portions 140, etc.) of an appliance during a shape setting procedure in positions corresponding to intended positions of corresponding securing members when the appliance is later installed in the patient's mouth and the securing members are secured to the patient's teeth (for example, when the teeth, and thus securing members, are in an OTA or FTA). In some embodiments, the securing portions 1702 are positioned relative to one another and to the gingiva portion 1710 to reflect the positions of the teeth in the FTA. In other embodiments, the securing portions 1702 are positioned to reflect the teeth in the OTA or an ITA.

The securing portions 1702 can have a geometry configured to facilitate positioning and/or retaining corresponding attachment portions at the intended positions. For example, as shown in FIG. 17, the securing portions 1702 can define first channels 1704 and second channels 1706 angled with respect to the first channels 1704. The first and second channels 1704, 1706 are configured to receive attachment portions of an appliance at least partially therein to locate the attachment portions at their intended positions. The securing portions 1702 can comprise protrusions (e.g., protrusions 1708) extending away from the corresponding securing portion 1702 and defining channels. In some embodiments, the protrusions 1708 define the first and second channels 1704, 1706 and/or the protrusions 1708 can define third channels configured to receive a fastener at least partially therein. For example, an elongate member such as a ligature wire can be wound about one of the securing portions 1702 and an attachment portion of an appliance such that the ligature wire is positioned within channels defined by the protrusions 1708 and secures the attachment portion to the securing portion 1702. The securing portions 1702 can be configured to receive and/or coupled with other fasteners, such as ties, sutures, bands, clasps, and others. In various embodiments, the securing portions 1702 can define one or more through-channels, apertures, or other openings to facilitate securing of an attachment portion to the securing portion 1702 via a fastener. For example, such openings can allow a pushing tool to be inserted from the back of the securing portion 1702 (e.g., through the buccal surface of the fixture 1700) to push an attachment portion away from the securing portion 1702 after the heat treatment has been completed and the ligature wire or other fastener has been removed.

The gingiva portion 1710 of the fixture 1700 comprises the shape of gingival tissue and provides a surface on which a portion of the appliance is conformed during a shape setting procedure. Because the fixture 1700 is based on the fixture digital model 1200, the gingiva portion 1710 may be substantially identical to the gingiva portion 1210 of the fixture model 1200, which may be substantially identical to the gingiva portion from any of the OTA or FTA digital models (e.g., 700, 800, 1000, 1100). For example, it can be desirable to use the gingiva portion 704 from the OTA digital model 700 for the gingiva portion 1210 of the fixture model 1200 to prevent or limit impingement of the patient's gingiva by an appliance installed in the patient's mouth and having a shape corresponding to a shape of the fixture 1700. In some cases, the securing portions 1202 can be positioned to reflect the teeth in the FTA while the gingiva portion 1210 reflects the gingiva in the OTA.

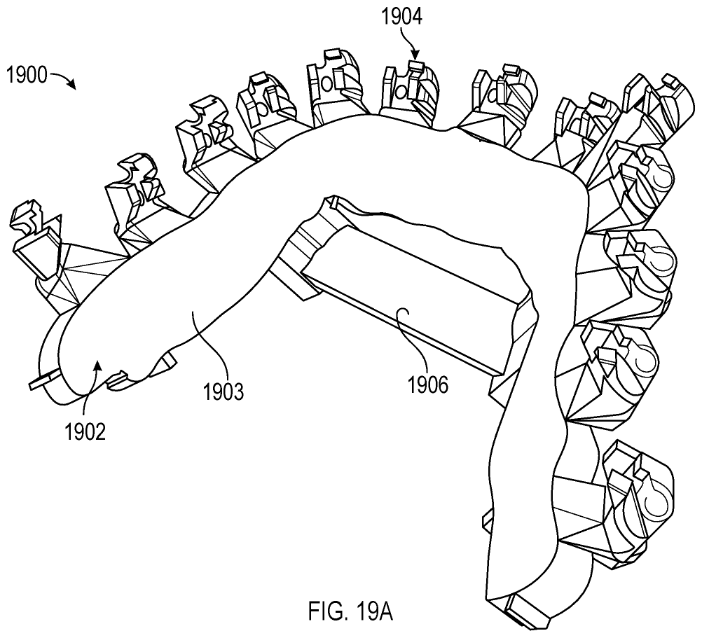

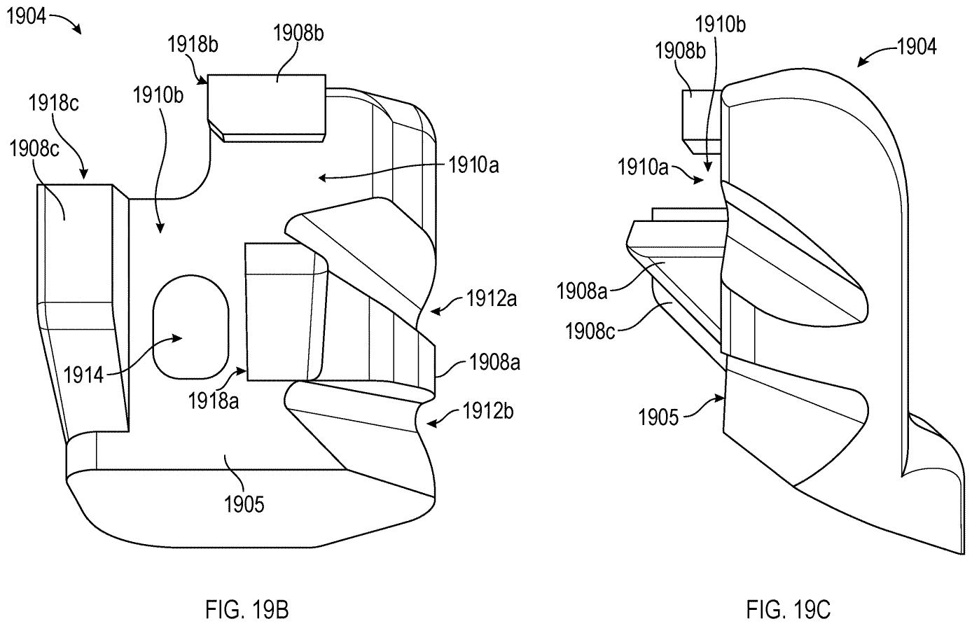

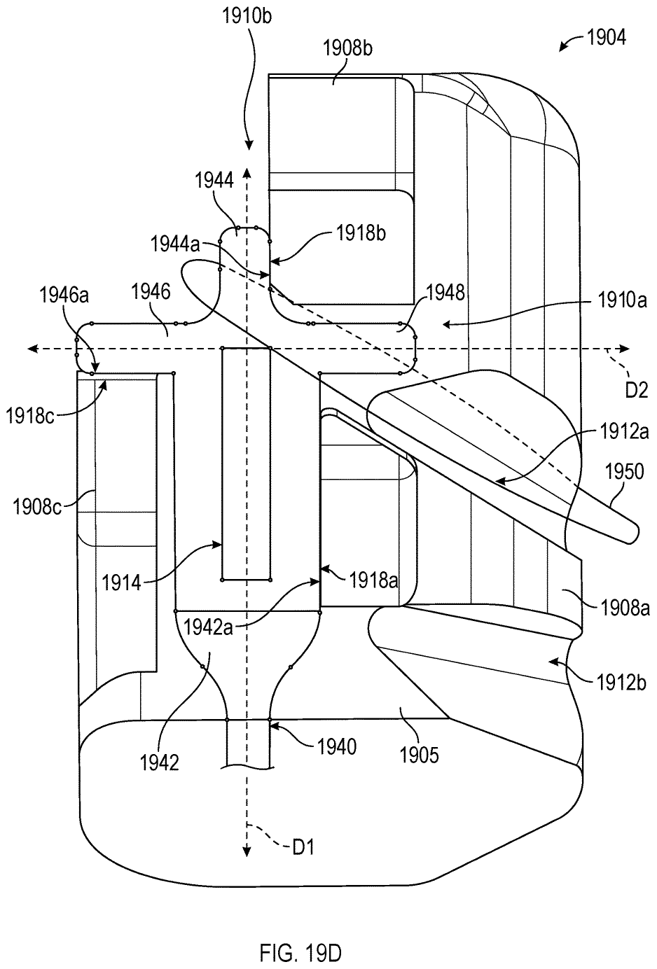

Additional details regarding fixtures and components thereof are discussed below with reference to FIGS. 19A-25.

As shown in FIG. 18, a pre-installation version of the appliance can be positioned on and secured to the fixture 1700. The combined assembly 1800 thus includes an appliance 100 that has been bent or otherwise manipulated into shape against a surface of the fixture 1700. The appliance 100 can be secured to the fixture 1700 by placing attachment portions into the securing portions 1702 of the fixture. Fasteners 1802 (e.g., ties, ligature wires, sutures, bands, wraps, etc.) can be wrapped around the appliance 100 at a plurality of positions to secure the appliance 100 with respect to the fixture 1700. Next, the shape setting procedure is performed shape set the appliance 100, after which the appliance 100 can be removed from the fixture 1700.

Some examples of a shape setting procedure can include heating the appliance 100 to a selected temperature (such as, but not limited to 525 degrees centigrade) for a selected period of time (such as, but not limited to 20 minutes), followed by rapid cooling. The rapid cooling can be achieved by any suitable cooling procedure such as, but not limited to water quench or air-cooling. In other examples, the time and temperature for heat treatment can be different than those discussed above, for example, based upon the specific treatment plan. For example, heat treatment temperatures can be within a range from 200 degrees centigrade to 700 degrees centigrade and the time of heat treatment can be a time in the range up to about one hundred and twenty minutes. In particular examples, the heat treatment procedure may be carried out in an air or vacuum furnace, salt bath, fluidized sand bed or other suitable system. After completing the heat treatment, the appliance has a desired 3D shape and configuration (e.g., corresponding substantially to the fixture and/or to the desired FTA). In other examples, other suitable heat-treating procedures may be employed including, but not limited to resistive heating or heating by running a current though the metal of the appliance structure. In some embodiments, the shape setting procedure does not rely on heat.

One or more additional post processing operations may be provided on the 3D shaped article, including, but not limited to abrasive grit blasting, shot peening, polishing, chemical etching, electropolishing, electroplating, coating, ultrasonic cleansing, sterilizing or other cleaning or decontamination procedures.

In examples in which the appliance is made of multiple components, some (or each) of the components of the appliance may be made according to methods described above, and then connected together to form the desired 3D appliance configuration. In these or other examples, the appliance (or some or each component of the appliance) may be made in other suitable methods including, but not limited to: directly printing of metal, first printing of a wax member and then investment casting the wax member into a metal or other material, printing of elastomeric material or other polymer, cutting or machining out of solid material, or cutting the components out of a sheet of metal and shape setting into the desired 3D configuration.

As discussed herein, one or more fixtures may be configured for use in bending a cut planar member into a desired 3D shape configuration. In particular examples, one or more fixtures are provided (such as, but not limited to, custom made) for each jaw of a patient. For example, the fixtures may be customized in shape and configuration for each patient and can be made in any suitable manner, including molding, machining, direct metal printing of stainless steel or other suitable metals, 3D printing of a suitable material, such as, but not limited to stainless steel via powder bed fusion, or a steel/copper mix via binder jetting, as well as first printing the configuration in wax and then investment casting the wax into various metals. In various examples described herein, the fixtures may be configured of material that is sufficiently resistant to the temperature of the heat treatment. In particular examples, one or more robots may be employed with or without the one or more fixtures, for bending the cut planar member into a desired 3D shape configuration.

In some embodiments, a single shape-setting step may be completed to deform the member from its planar configuration to its desired 3D configuration. However, in certain embodiments the shape setting may include two or more shape-setting steps (e.g., two or more heat treatment processes, potentially using two or more different fixtures). In such cases, the amount of deformation imparted to the appliance within each shape-setting step may be limited, with each subsequent shape-setting step moving the appliance further toward the desired 3D configuration.

The completed appliances can then be sent (optionally along with bonding trays and/or securing members) to the treating clinician. To install the appliances, the orthodontist can clean the lingual side of the patient's teeth to prepare them for bonding (e.g., with pumice powder). The surface of the teeth can then be sandblasted (e.g., with 50-micron aluminum oxide). The securing members can then be attached using a bonding tray as described elsewhere herein.

After the appliances are fabricated and the securing members are attached to the teeth, each arm can be coupled to its corresponding securing member element to install the appliance. Once installed, the appliance imparts forces and torques on the teeth, to move the teeth to the desired FTA. After treatment is completed (e.g., OTA to FTA, OTA to ITA, ITA to ITA, or ITA to FTA) the arms may sit passively in the securing members and force will no longer be applied to the teeth. Alternatively, any remaining force applied by the arms may fall below a threshold for causing further displacement of the teeth.

The patient can return for a check-up appointment (e.g., at approximately 2-3 months), and if the treatment is advancing as planned, nothing is done until the patient returns at a planned time for appliance removal. At this stage the securing members may be removed. If treatment is not progressing as planned, the appliance may be removed, the patient's mouth rescanned, and a new appliance can be device designed and installed based on a modified treatment plan.

### IV. Selected Embodiments of Shape Forming Fixtures

Appliances of the present technology can be configured to impart forces on a patient's teeth to move the teeth from original positions to desired, final positions. In some embodiments, an appliance is configured to apply a specific force to one or more teeth based on a 3D configuration of the appliance. For example, an appliance can have attachment portions located at positions based on desired positions of the patient's teeth. The 3D configuration can be formed by manipulating the appliance from a planar configuration into the 3D configuration (e.g., by securing the appliance to a fixture) and setting a shape of the appliance (e.g., via heat treatment, cold working, plastic deformation, etc.). When the appliance is in the 3D configuration, an attachment portion of the appliance is located at an intended position with respect to other attachment portions of the appliance and/or an anchor of the appliance. The intended position of the attachment portion can correspond to or be derived from a desired position of the tooth to which the attachment portion is configured to be secured. In operation, the appliance can move the tooth toward its desired position by moving the attachment portion toward its intended position.

Accurately locating attachment portions of an appliance at their intended positions while forming a 3D configuration of the appliance is essential to the efficacy of moving a patient's teeth to their desired, final positions. If an attachment portion is located at an incorrect position when the appliance is in the 3D configuration, the tooth may not reach its desired position when the attachment portion returns to its pre-set position. Such errors in locating the attachment portions in their intended positions can result in a need for additional appliances to complete the treatment, increased cost and time of treatment, and/or patient dissatisfaction with the treatment.

Errors in forming the 3D configuration of the appliance can occur while manipulating the appliance from the planar configuration into the 3D configuration, including while securing the appliance to the fixture and/or setting a shape of the appliance. For example, when securing the appliance to the fixture, the attachment portion can be secured at a position deviating from the intended position if there is excessive play between the attachment portion and a securing portion of the fixture configured to retain the attachment portion. In some cases, a securing portion of a fixture must be designed to accommodate attachment portions of a range of sizes due to manufacturing tolerances and errors, which can result in play between certain attachment portions and the securing portion.

Various embodiments of the present technology comprise methods of manufacturing an orthodontic appliance with high accuracy and precision. In some embodiments, the present technology comprises a fixture configured to releasably retain the appliance in the 3D configuration such that attachment portions of the appliance are located in intended positions corresponding to or derived from desired positions of the teeth to be treated. The fixture can comprise a body portion and one or more securing portions. In some embodiments, each of the securing portions is configured to retain a corresponding attachment portion of the appliance at an intended position.

FIG. 19A depicts a fixture 1900 configured in accordance with several embodiments of the present technology. The fixture 1900 can be similar to fixture 1700, except as described below. The fixture 1900 can comprise a body portion 1902 and one or more securing portions 1904 carried by the body portion 1902. The body portion 1902 can comprise a surface having a shape corresponding at least in part to a gingiva of a patient. The securing portion 1904 can be carried by the body portion 1902 and is configured to retain an attachment portion in a desired position during a shape setting procedure. As discussed below, the securing portion 1904 can comprise a first engagement surface, a second engagement surface, and a gap between the first and second engagement surfaces. The gap is configured to receive the attachment portion such that a first region of the attachment portion is positioned adjacent the first engagement surface and a second region of the attachment portion is positioned adjacent the second engagement surface.

The body portion 1902 and the securing portions 1904 can be monolithic or the securing portions 1904 can be separate pieces that are coupled to the body portion 1902. In some embodiments, the fixture 1900 includes one or more structural components that generally do not directly engage the appliance and rather stabilize the body portion and/or securing portions. The fixture 1900 in FIG. 19A, for example, includes a stabilizer 1906 that extends between opposite sides of the body portion 1902.

The fixture 1900 is configured to be releasably secured to an appliance and retain the appliance in a desired 3D configuration. In some embodiments, the appliance is releasably secured to the fixture 1900 such that an anchor of the appliance substantially conforms to the body portion 1902 of the fixture 1900. Additionally or alternatively, attachment portions of the appliance may be releasably secured to the securing portions 1904 of the fixture 1900.

As shown in FIG. 19A, the body portion 1902 of the fixture 1900 can have a first surface 1903 at a lingual side of the fixture 1900 and a second surface (not visible) at the buccal side of the fixture 1900 and opposite the first surface 1903 along a thickness of the body portion 1902. The first surface 1903 and/or the second surface can have a shape substantially corresponding to a shape of the patient's gingiva in the OTA, the FTA, and/or one or more ITAs. In some embodiments, the body portion 1902 can be a modified version of the gingiva portion of the OTA digital model, the FTA digital model, and/or another suitable digital model. For example, the body portion 1902 can be enlarged or thickened with respect to the gingiva portion of the OTA digital model and/or the FTA digital model to prevent or limit impingement of the patient's gingiva by the appliance once installed. In some embodiments, the appliance is releasably secured to the fixture 1900 such that one or more portions (e.g., an anchor, an arm, etc.) of the appliance substantially conforms to the first surface 1903.

The securing portions 1904 of the fixture 1900 can be configured to releasably secure the appliance to the fixture 1900 such that the appliance is manipulated into the desired 3D configuration. For example, each of the securing portions 1904 can be configured to releasably retain an attachment portion of the appliance at an intended position with respect to the anchor, other attachment portions, etc. Accordingly, the appliance can be shape set (e.g., heat treated, etc.) while secured to the fixture 1900 such that the attachment portion remains located at the intended position once the appliance is removed from the fixture 1900. The intended position at which the securing portion 1904 is configured to retain the attachment portion can substantially correspond to and/or be derived from a desired position of the tooth to be treated. In operation, the arm can move the attachment portion to the intended position, thereby moving the tooth to the desired position via the attachment portion.

FIGS. 19B and 19C are front and side views, respectively, of one of the securing portions 1904 shown isolated from the fixture 1900. FIG. 19D is a front view of the securing portion 1904 shown in FIGS. 19A-19C releasably secured to an attachment portion 1940 of an appliance. As shown in FIGS. 19B and 19C, the securing portion 1904 can comprise a surface 1905 configured to be positioned adjacent to and/or in contact with an attachment portion 1940. The securing portion 1904 can include one or more protrusions 1908 configured to locate the attachment portion 1940 of the appliance at the intended position. For example, the securing portion 1904 depicted in FIGS. 19A-19D includes a first protrusion 1908a, a second protrusion 1908b, and a third protrusion 1908c (collectively referred to as “protrusions 1908”) extending away from the surface 1905. The protrusions 1908 define channels therebetween that receive the attachment portion 1940. The channels can comprise a first channel 1910a and a second channel 1910b (referred to collectively as “channels 1910”). The securing portion 1904 can further include first and second grooves 1912a and 1912b (referred to collectively as “grooves 1912”) configured to receive a fastener at least partially therein. As shown in FIG. 19D, the attachment portion 1940 can be positioned against the surface 1905 between the protrusions 1908.

Although the channels 1910 in FIGS. 19A-19D are defined by protrusions 1908 extending away from the surface 1905, in some embodiments the securing portion 1904 includes channels 1910 formed by recesses in the surface 1905. The channels 1910 would thus extend into the thickness of the securing portion 1904. In these and other embodiments, the securing portion 1904 may not include protrusions 1908. In some embodiments, the securing portion 1904 does not include protrusions 1908 or channels 1910. Instead, the securing portion 1904 can comprise printed markings, for example, on the securing portion 1904 that are configured to indicate the intended position of the attachment portion 1940. In such embodiments, the corresponding attachment portion can be aligned with the markings and an integrated restraint (such as any disclosed herein) or a separate restraint (such as a ligature wire, coil, tie, suture, thread, etc.) can be used to secure the attachment portion in place.

According to some embodiments, for example as shown in FIG. 19D, the attachment portion 1940 can be positioned in, at, or adjacent to the securing portion 1904 such that the attachment portion 1940 is located at its intended position. In some embodiments, the attachment portion 1940 is positioned substantially parallel with and/or in contact with the surface 1905 of the securing portion 1904. In some embodiments, the securing portion 1904 and/or protrusions 1908 include one or more engagement surfaces 1918 configured to facilitate alignment of the attachment portion 1940 with the intended position. For example, the securing portion 1904 shown in FIGS. 19A-19D includes a first engagement surface 1918a, a second engagement surface 1918b, and a third engagement surface 1918c. The first engagement surface 1918a can be a surface of the first protrusion 1908a, the second engagement surface 1918b can be a surface of the second protrusion 1908b, and the third engagement surface 1918c can be a surface of third protrusion 1908c.

As shown in FIG. 19D, in some embodiments the attachment portion 1940 of the appliance is generally T-shaped. The attachment portion 1940 can comprise a first projection 1942 extending along a first direction D1, a second projection 1944 extending along the first direction D1, a third projection 1946 extending along a second direction D2, and/or a fourth projection 1948 extending along the second direction D2 (collectively “projections 1942-1948” and “directions D”). In some embodiments, for example as shown in FIG. 19D, the first direction DI is generally orthogonal to the second direction D2. Although FIG. 19D depicts the attachment portion 1940 with four projections 1942-1948, other numbers of projections are possible. Moreover, the projections 1942-1948 may extend along different directions D than the two generally orthogonal directions D1, D2 depicted in FIG. 19D. For example, each of the projections 1942-1948 can extend along a unique direction.

To locate the attachment portion 1940 at the intended position, the attachment portion 1940 can be positioned in, at, or adjacent to the securing portion 1904 of the fixture 1900 such that the attachment portion 1940 engages the engagement surfaces 1918. For example, as shown in FIG. 19D, the first projection 1942 of the attachment portion 1940 can engage the first engagement surface 1918a, the second projection 1944 can engage the second engagement surface 1918b, and the third projection 1946 can engage the third engagement surface 1918c. In some embodiments, a first vertical surface 1942a of the first projection 1942 can be configured to contact the first engagement surface 1918a, a first vertical surface 1944a of the second projection 1944 can be configured to contact the second engagement surface 1918b, and a first horizontal surface 1946a of the third projection 1946 can be configured to contact the third engagement surface 1918c. Accordingly, a second vertical surface of the first projection 1942, a second vertical surface of the second projection 1944, a second horizontal surface of the third projection 1946, and all surfaces of the fourth projection 1948 are not constrained by the securing portion 1904. This design of the securing portion 1904 allows the attachment portion 1940 to be constrained in two degrees of freedom, e.g., along the first and second directions D1, D2. Moreover, in some cases a distance between the first and second vertical surfaces of the first projection 1942, the first and second vertical surfaces of the second projection 1944, the first and second horizontal surfaces of the third projection 1946, etc. may be different than an intended distance between the respective surfaces due to tolerance stacking and/or manufacturing errors. The securing portions disclosed herein address these limitations by allowing attachment portions of various widths to be aligned at the intended position.

Although FIGS. 19A-19D depict a securing portion 1904 including three engagement surfaces 1918, other configurations are possible. The securing portion 1904 can include two or more engagement surfaces 1918 configured to engage two or more surfaces of the attachment portion 1940. In various embodiments, the securing portion 1904 includes three or more engagement surfaces 1918 configured to engage three or more surfaces of the attachment portion 1940. In various embodiments, for example, a securing portion can include a first protrusion including (i) a first engagement surface configured to engage the second vertical surface of the first projection of the attachment portion and (ii) a second engagement surface configured to engage the first horizontal surface of the third projection of the attachment portion and a second protrusion including a third engagement surface configured to engage the first vertical surface or the second vertical surface of the second projection. In some embodiments, the securing portion includes a first engagement surface configured engage the first horizontal surface of the third projection, a second engagement surface configured to engage the first horizontal surface of the fourth projection, and the first or second vertical surface of the first or second projections.

The first engagement surface 1918a, the second engagement surface 1918b, and/or the third engagement surface 1918c can have a shape corresponding to and/or derived from a shape of a corresponding projection (e.g., the first projection 1942, the second projection 1944, the third projection 1946, etc.). For example, as shown in FIG. 19D, each of the first, second, and third engagement surfaces 1918a, 1918b, 1918c can be substantially flat to engage a substantially flat surface of the first, second, and third projections 1942, 1944, 1946 of the attachment portion 1940, respectively. As shown in FIGS. 19B-19D, the first and second engagement surfaces 1918a, 1918b can be substantially parallel to each other and/or the third engagement surface 1918c can be substantially orthogonal to the first engagement surface 1918a and/or the second engagement surface 1918b. In some embodiments, the first engagement surface 1918a is spaced apart from the second engagement surface 1918b and/or the third engagement surface 1918c along the second direction D2. The first engagement surface 1918a and/or the third engagement surface 1918c can be spaced apart from the second engagement surface 1918b along the first direction D1.

Prior to setting a shape of the appliance, the appliance can be releasably secured to the fixture 1900. In various embodiments, the attachment portion 1940 can be releasably secured to the securing portion 1904 of the fixture 1900. For example, as shown in FIG. 19D, one or more elongated members 1950 (e.g., a ligature wire, a cord, a braid, a coil, etc.) can be wrapped around the attachment portion 1940 and the securing portion 1904. A first elongated member 1950a can be wrapped around the attachment portion 1940 and the securing portion 1904 such that the first elongated member 1950a is positioned within the first groove 1212a in the securing portion 1904 and extends across the attachment portion 1940 along a diagonal path between a first corner between the first and fourth projections 1942, 1948 and a second corner between the second and third projections 1944, 1946. Such a diagonal path can reduce or eliminate play between the attachment portion 1940 and the securing portion 1904 in two dimensions. For example, the diagonal path can reduce or eliminate (i) any vertical play between the first vertical surface 1942a of the first projection 1942 of the attachment portion 1940 and the first engagement surface 1918a and (ii) any horizontal play between the first horizontal surface 1946a of the third projection 1946 of the attachment portion 1940 and the third engagement surface 1918c. The first elongated member 1950a extends along a direction that is disposed at an angle of about 10 degrees to about 80 degrees with respect to the first direction D1 and/or the second direction D2. In some embodiments, the first elongated member 1950a extends along a direction that is disposed at approximately 45 degrees with respect to the first direction D1 and/or the second direction D2. Moreover, wrapping the first elongated member 1950a around the attachment portion 1940 and the securing portion 1904 can reduce or eliminate any play between the attachment portion 1940 and the surface 1905 of the securing portion 1904. The first groove 1912a can extend through the securing portion 1904 along a direction that is generally parallel to the diagonal path across which the first elongated member 1950a extends such that the first groove 1912a guides the first elongated member 1950a along the desired diagonal path. In some embodiments, a second elongated member (not depicted) is wrapped around the securing portion 1904 and the attachment portion 1940 such that the second elongated member is positioned within the second groove 1912b in the securing portion 1904 and extends across the attachment portion 1940, through an opening in the attachment portion 1940, and through the opening 1914 in the securing portion 1904.

In some embodiments, securing the attachment portions 1940 of the appliance to the securing portions 1904 of the fixture 1900 can cause the anchor of the appliance to substantially conform to the body portion 1902 of the fixture 1900. Additionally or alternatively, fasteners (e.g., ligature wires, clamps, etc.) may be used to cause the anchor of the appliance to substantially conform to the body portion 1902 of the fixture 1900. Moreover, fasteners other than ligature wire may be used to manipulate the appliance into the 3D configuration and/or secure the appliance to the fixture 1900. For example, a clip, a clamp, a positive mold, a pin, a screw, and/or other fasteners can be used.

The fixture 1900 can be manufactured based on a fixture digital model. For example, the digital model or associated data can be provided to a fabricating system to produce a physical model based on the digital model. In one example, the digital model and/or data can be used to 3D print a model of the fixture 1900 in wax. The wax model may then be used to investment cast the fixture 1900 in brass or other suitable material. In some embodiments, the fixture 1900 can be 3D printed directly in brass or other suitable material (e.g., stainless steel, bronze, a ceramic or other material that tolerates high temperatures required for heat treatment). In such embodiments, the fixture 1900, including the body portion 1902, the securing portion 1904, the protrusions 1908, the channels 1910, the recesses 1912, etc. can be designed to prevent or reduce the support material required on critical surfaces of the fixture 1900 (e.g., the first surface 1903 of the body portion 1902, the surface 1905 of the securing portion 1904, etc.) to print the fixture 1900.

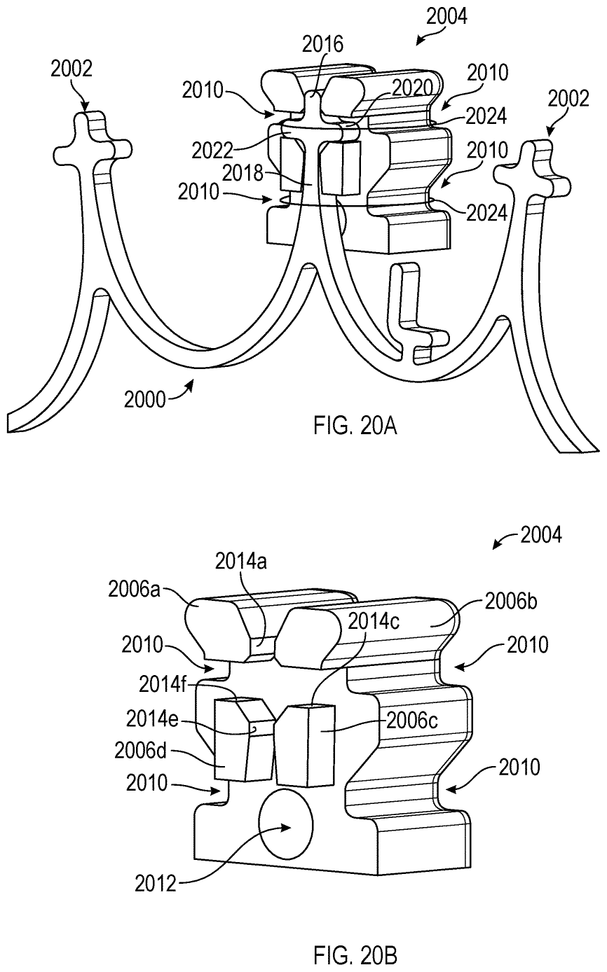

FIG. 20A depicts an appliance 2000 comprising attachment portions 2002, one of which is engaged with a securing portion 2004 of a fixture configured in accordance with several embodiments of the present technology. For ease of understanding, only one securing portion 2004 of the fixture is shown in FIG. 20A. However, the fixture can comprise multiple securing portions 2004 and/or a body portion (e.g., such as body portion 1902, etc.). The securing portion 2004 can be configured to releasably an attachment portion 2002, which can facilitate manipulating the appliance into a desired 3D configuration. The appliance 2000 can be shape set (e.g., heat treated, etc.) while secured to the fixture such that the attachment portion remains located at the intended position once the appliance is removed from the fixture. The intended position at which the securing portion 2004 is configured to retain the attachment portion can substantially correspond to and/or be derived from a desired position of the tooth to be treated. In operation, an arm and/or a connector of the appliance 2000 can move the attachment portion 2002 to the intended position, thereby moving the tooth to the desired position via the attachment portion 2002.

FIG. 20B is an isolated view of the securing portion 2004 of FIG. 20A. The securing portion 2004 can comprise a surface 2005 configured to be positioned adjacent to and/or in contact with an attachment portion 2002. The securing portion 2004 can include one or more protrusions 2006 configured to locate the attachment portion 2002 of the appliance 2000 at the intended position. For example, the securing portion 2004 depicted in FIGS. 20A and 20B includes a first protrusion 2006a, a second protrusion 2006b, a third protrusion 2006c, and a fourth protrusion 2006d (collectively referred to as “protrusions 2006”) extending away from the surface 2005. The protrusions 2006 define channels therebetween that receive the attachment portion 2002. The channels can comprise a first channel 2008a and a second channel 2008b (referred to collectively as “channels 2008”). As shown in FIG. 20A, the attachment portion 2002 can be positioned against the surface 2005 between the protrusions 2006. The securing portion 2004 can further include one or more grooves 2010 and/or openings 2012 configured to receive a fastener at least partially therein. For example, as shown in FIG. 20A, one or more ligature wires 2024 can be positioned within the grooves 2010 and wrapped around the attachment portion 2002 and the securing portion 2004 to secure the attachment portion 2002 to the securing portion 2004.

Although the channels 2008 in FIGS. 20A and 20B are defined by protrusions 2006 extending away from the surface 2005, in some embodiments the securing portion 2004 includes channels 2008 formed by recesses in the surface 2005. The channels 2008 would thus extend into the thickness of the securing portion 2004. In some embodiments, the securing portion 2004 does not include protrusions 2006 or channels 2008. Instead, the securing portion 2004 can comprise printed markings, for example, on the securing portion 2004 that are configured to indicate the intended position of the attachment portion 2000. In such embodiments, the corresponding attachment portion can be aligned with the markings and an integrated restraint (such as any disclosed herein) or a separate restraint (such as a ligature wire, coil, tie, suture, thread, etc.) can be used to secure the attachment portion in place.

According to some embodiments, for example as shown in FIG. 20A, the attachment portion 2002 can be positioned in, at, or adjacent to the securing portion 2004 such that the attachment portion 2002 is located at its intended position. In some embodiments, the attachment portion 2002 is positioned substantially parallel with and/or in contact with the surface 2005 of the securing portion 2004. In some embodiments, the securing portion 2004 and/or protrusions 2006 include one or more engagement surfaces 2014 configured to facilitate alignment of the attachment portion 2002 with the intended position. For example, the securing portion 2004 shown in FIGS. 20A and 20B includes a first engagement surface 2014a, a second engagement surface (not visible), a third engagement surface 2014c, a fourth engagement surface (not visible), a fifth engagement surface 2014e, and/or a sixth engagement surface 2014f. The first engagement surface 2014a can be a surface of the first protrusion 2006a, the second engagement surface can be a surface of the second protrusion 2006b, the third engagement surface 2014c and the fourth engagement surface can be surfaces of third protrusion 2006c, and the fifth and sixth engagement surfaces 2014e, 2014f can be surfaces of the fourth protrusion 2006d.

As shown in FIG. 20A, in some embodiments the attachment portion 2002 of the appliance 2000 is generally T-shaped. The attachment portion 2000 can comprise a first projection 2016 extending along a first direction, a second projection 2018 extending along the first direction, a third projection 2020 extending along a second direction angled with respect to the first direction, and/or a fourth projection 2022 extending along the second direction (collectively “projections 2016-2022” and “directions”). In some embodiments, the first direction is generally orthogonal to the second direction. Although FIG. 20A depicts the attachment portion 2002 with four projections 2016-2022, other numbers of projections are possible. Moreover, the projections 2016-2022 may extend along different directions than the two generally orthogonal directions depicted in FIG. 20A. For example, each of the projections 2016-2022 can extend along a unique direction.

To locate the attachment portion 2002 at the intended position, the attachment portion 2002 can be positioned in, at, or adjacent to the securing portion 2004 of the fixture such that the attachment portion 2004 engages the engagement surfaces 2014. For example, as shown in FIG. 20A, the first projection 2016 of the attachment portion 2002 can engage the first and second engagement surfaces, the second projection 2018 can engage the third and fifth engagement surfaces, the third projection 2020 can engage the fourth engagement surface, and the fourth projection 2022 can engage the sixth engagement surface. This design of the securing portion 2004 allows the attachment portion 2002 to be constrained in two degrees of freedom, e.g., along the first and second directions while also allowing attachment portions of various widths to be aligned at the intended position.

In some embodiments, an elongated member such as a ligature wire can be used to secure an attachment portion of an appliance to a securing portion of a shape forming fixture. The elongated member can advantageously prevent or limit motion of the attachment portion relative to the securing portion and/or facilitate positioning of the attachment portion at its intended position (e.g., by reducing or eliminating play between the attachment portion and the securing portion, etc.). However, wrapping one or more elongated members around each securing portion can be time consuming and labor intensive. For example, because a shape forming fixture may comprise fourteen to sixteen securing portions, it can take a substantial amount of time to secure each attachment portion to a corresponding securing portion. Additionally, wrapping the elongated members around the attachment portion and securing portion while keeping the attachment portion located at an intended positions may be difficult and require an operator securing the appliance to the fixture to have excellent dexterity. To address these challenges, securing portions in accordance with the present technology can be configured to releasably retain an attachment portion in a manner that is accurate, efficient, and scalable.

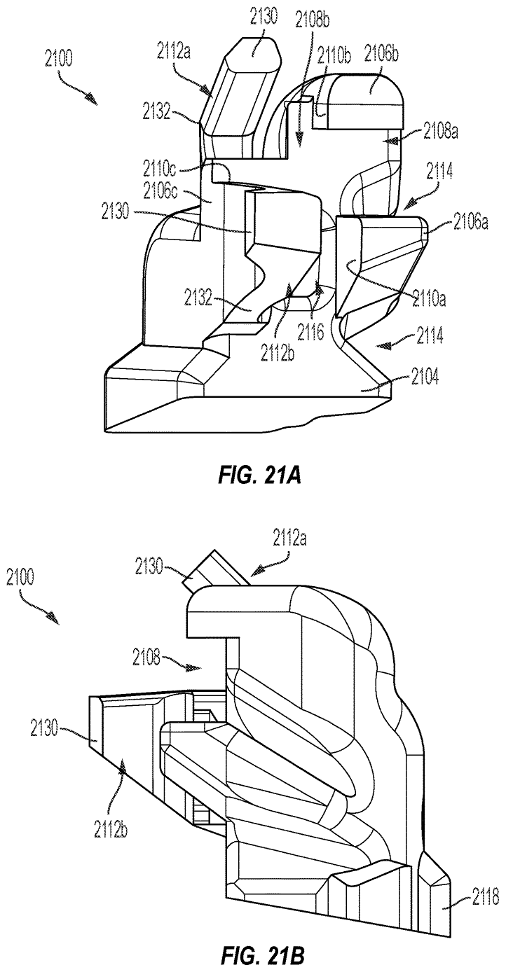

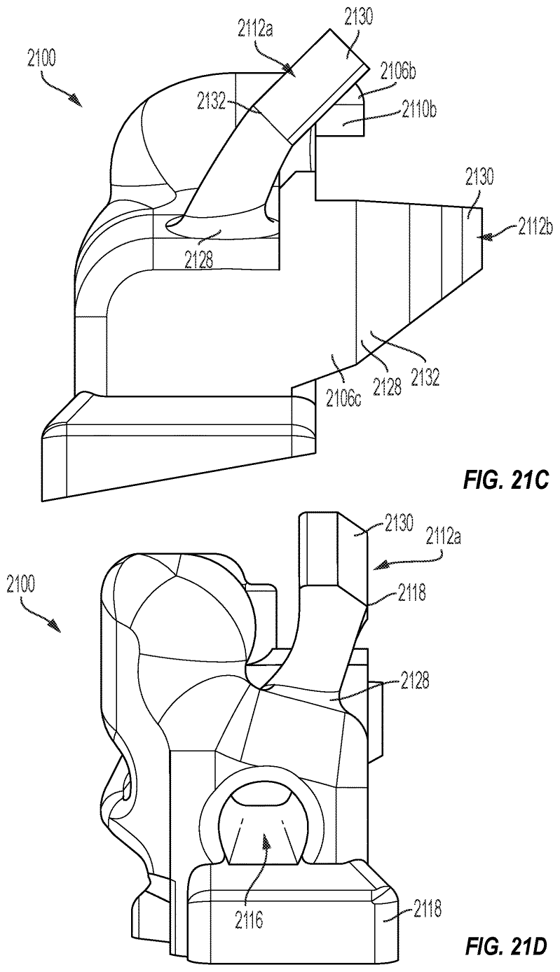

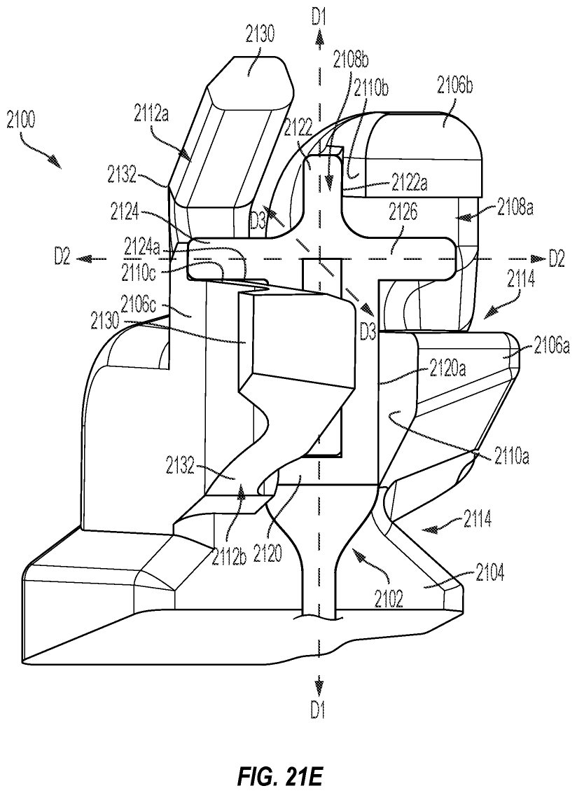

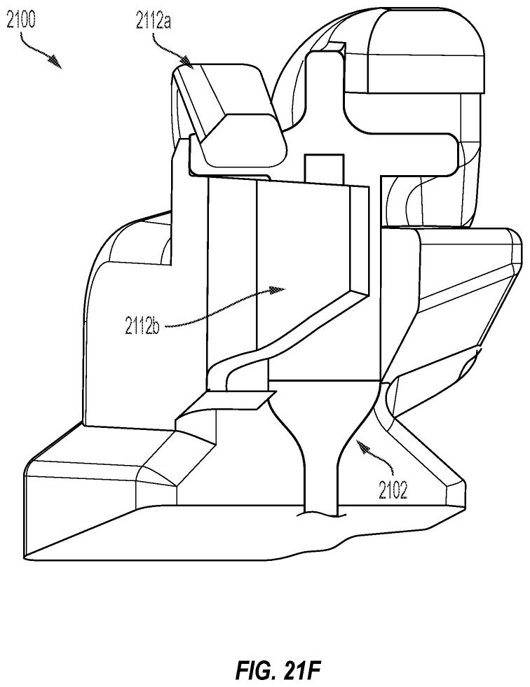

FIGS. 21A-21E are various views of an example securing portion 2100 designed to address the above-noted challenges. Specifically, FIGS. 21A-21D are perspective, left, right, and back views, respectively, of the securing portion 2100 and FIG. 21E is a perspective view of the securing portion 2100 shown in FIGS. 21A-21D releasably secured to an attachment portion 2102 of an appliance. The securing portion 2100 is configured to retain the attachment portion 2102 at an intended location, which can substantially correspond to and/or be derived from a desired position of one of a patient's teeth. In some embodiments, the intended position is defined relative to another portion of the appliance and/or an anatomical feature of the patient (e.g., a gingival landmark, a tooth, etc.). The securing portion 2100 can be configured to releasably retain the attachment portion 2102 at the intended position during a shape setting procedure such that, after the shape setting procedure, the appliance can be separated from the shape forming fixture and the attachment portion 2102 remains at its intended position.

As shown in FIGS. 21A-21E, the securing portion 2100 can comprise a backing surface 2104 configured to be positioned in contact with, or adjacent to, the attachment portion 2102 of the appliance, as well as protrusions 2106 and/or channels 2108 configured to locate the attachment portion 2102 of the appliance at its intended position. In some embodiments, the protrusions 2106 form one or more engagement surfaces 2110 configured to limit motion of the attachment portion 2102 along at least one direction (e.g., first direction D1, second direction D2, third direction D3, others, etc.). The securing portion 2100 can further comprise one or more restraints 2112 that are manipulable between open configuration in which the attachment portion 2102 is movable relative to the securing portion 2100 and a closed configuration in which the restraints 2112 limit or prevent motion of the attachment portion 2102 relative to the securing portion 2100 along at least one direction.

The securing portion 2100 depicted in FIGS. 21A-21E includes a first protrusion 2106a, a second protrusion 2106b, and a third protrusion 2106c extending away from the backing surface 2104. The protrusions 2106 define a first channel 2108a and a second channel 2108b, which form a gap between the protrusions 2106 that is configured to receive the attachment portion 2102 therein. Although FIGS. 21A-21E depict the channels 2108 being defined by protrusions 2106 extending away from the backing surface 2104 (e.g., along the third direction D3), in some embodiments the securing portion 2100 includes channels 2108 extending into a thickness of the securing portion 2100 and/or along another direction (e.g., the first direction D1, the second direction D2, etc.). In some embodiments, the securing portion 2100 has more or fewer than three protrusions (e.g., one protrusion, two protrusions, four protrusions, etc.) or more or fewer channels 2108. In some embodiments, the securing portion 2100 does not include protrusions 2106 or channels 2108. Instead, the securing portion 2100 can comprise printed markings, for example, on the securing portion 2100 that are configured to indicate the intended position of the attachment portion 2102. In such embodiments, the attachment portion 2102 can be aligned with the markings and an integrated restraint (such as 2112a) or a separate restraint (such as a ligature wire, coil, tie, suture, thread, etc.) can be used to secure the attachment portion 2102 in place.

In some embodiments, the securing portion 2100 includes a first engagement surface 2110a, a second engagement surface 2110b, and a third engagement surface 2110c. The first engagement surface 2110a can be a surface of the first protrusion 2106a, the second engagement surface 2110b can be a surface of the second protrusion 2106b, and the third engagement surface 2110c can be a surface of third protrusion 2106c. In some embodiments, the securing portion 2100 has more or fewer than three engagement surfaces (e.g., one engagement surface, two engagement surfaces, four engagement surfaces, etc.).

The restraints 2112 can be configured to be folded, bent, twisted, hinged, or otherwise manipulated or moved between an open configuration in which the attachment portion 2102 can be received and removed and a closed configuration in which the restraint 2112 limits or prevents motion of the attachment portion 2102 relative to the securing portion 2100 along at least one direction. In some embodiments, the securing portion 2100 includes one or more grooves 2114 and/or openings 2116 configured to receive an elongated member (e.g., a ligature wire, a coil, a thread, etc.) at least partially therein, which can be employed for securing the attachment portion 2102 to the securing portion 2100 (instead of or in addition to the restraint 2112). In such embodiments, the elongated member would wrap around the securing portion 2100 and attachment portion 2102 while positioned in the grooves 2114.

According to some embodiments, for example as shown in FIG. 21E, the attachment portion 2102 is positioned at the backing surface 2104 of the securing portion 2100, within the channels 2108 and between the protrusions 2106 such that the attachment portion 2102 is located at its intended position. In some embodiments, the attachment portion 2102 is positioned in contact with the backing surface 2104 of the securing portion 2100 and in contact with the engagement surfaces 2110.

As shown in FIG. 21E, in some embodiments the securing portion 2100 can be configured to receive and secure an attachment portion 2102 that has multiple cantilevered portions. For example, the attachment portion 2102 can comprise a first projection 2120, a second projection 2122, a third projection 2124, and a fourth projection 2126. When the attachment portion 2102 is positioned in the channels 2108 of the securing portion 2100, the first projection 2120 and the second projection 2122 can extend along the first direction D1 and the third projection 2124 and the fourth projection 2126 can extend along the second direction D2 that is angled relative to the first direction D1. In some embodiments, for example as shown in FIG. 21E, the first direction D1 is generally orthogonal to the second direction D2. In other embodiments the first and second directions D1, D2 are angled but non-orthogonal. Although FIG. 21E depicts the attachment portion 2102 with four projections, other numbers of projections are possible. Moreover, the projections may extend along different directions than the two generally orthogonal directions D1, D2 depicted in FIG. 21E. For example, each of the projections 2120-2126 can extend in a unique direction.

To locate the attachment portion 2102 at the intended position, the attachment portion 2102 can be positioned in, at, or adjacent to the securing portion 2100 such that the attachment portion 2102 engages the engagement surfaces 2110. For example, as shown in FIG. 21E, when the attachment portion 2102 is restrained by the securing portion 2100, the first engagement surface 2110a can abut the first projection 2120 of the attachment portion 2102, the second engagement surface 2110b can abut the second projection 2122, and the third engagement surface 2110c can abut the third projection 2124. In some embodiments, the first engagement surface 2110a faces distally and is configured to abut a first vertical surface 2120a of the first projection 2120. As such, the first engagement surface 2110a prevents or limits medial movement of the attachment portion 2102. The second engagement surface 2110b faces distally and is configured to abut a first vertical surface 2122a of the second projection 2122. As such, the second engagement surface 2110b prevents or limits medial movement of the attachment portion 2102. The third engagement surface 2110c faces occlusally and is configured to contact a first horizontal surface 2124a of the third projection 2124. As such, the third engagement surface 2110c prevents or limits gingival movement of the attachment portion 2102. Accordingly, a second vertical surface of the first projection 2120, a second vertical surface of the second projection 2122, a second horizontal surface of the third projection 2124, and all surfaces of the fourth projection 2126 are not constrained by the securing portion 2100. This design of the securing portion 2100 allows the attachment portion 2102 to be constrained in two degrees of freedom, e.g., along the first and second directions D1, D2, while allowing for variation in the dimensions of the attachment portion 2102 and/or the projections 2120-2126. Allowance of such variation can be advantageous because, in some cases, a distance between the first and second vertical surfaces of the first projection 2120, the first and second vertical surfaces of the second projection 2122, the first and second horizontal surfaces of the third projection 2124, etc. may vary due to tolerance stacking and/or manufacturing errors.

In some embodiments, one or more elongated members (e.g., a ligature wire, a cord, a braid, a coil, etc.) can be used in addition to or in place of one or more of the restraints 2112 to secure the attachment portion 2102 to the securing portion 2100. The one or more elongated members can be wrapped around the attachment portion 2102 and the securing portion 2100. For example, an elongated member can be wrapped around the attachment portion 2102 and the securing portion 2100 such that the elongated member is at least partially positioned within one or more of the grooves 2114 and/or openings 2116 in the securing portion 2100. An elongated member can extend across the attachment portion 2102 along a diagonal path to reduce or eliminate play between the attachment portion 2102 and the securing portion 2100 in two dimensions.

The securing portion 2100 shown in FIGS. 21A-21E comprises two restraints 2112, first restraint 2112a and second restraint 2112b, that are manipulable between an open configuration and a closed configuration. Each of the restraints 2112 extends from a first end portion 2128 at the securing portion 2100 to a second, free end portion 2130. In the open configuration, the second end portion 2130 of the restraint 2112 is positioned away from the securing portion 2100 such that the attachment portion 2102 can move relative to the securing portion 2100 without obstruction by the restraint 2112. In the closed configuration, the second end portion 2130 is positioned closer to the securing portion 2100 than when the restraint 2112 was in the open configuration such that the restraint 2112 prevents or limits relative motion between the attachment portion 2102 and the securing portion 2100 along at least one direction. In some embodiments, the securing portion 2100 only includes a single integrated restraint (such as the first restraint 2112a or the second restraint 2112b). In some embodiments, the securing portion 2100 comprises more than two integrated restraints (e.g., three restraints, four restraints, etc.).

In some embodiments, for example as shown in FIG. 21F, the first restraint 2112a can be configured to bend along an occlusogingival direction. The free end of the first restraint 2112a can be more occlusal when in the open configuration and more gingival when in the closed configuration. For example, the first restraint 2112a can be bent gingivally from an open configuration-towards the attachment portion 2102-until the attachment portion 2102 is positioned between the second end portion 2130 of the first restraint 2112a and the backing surface 2104 of the securing portion 2100. In this manner, the first restraint 2112a can prevent or limit motion of the attachment portion 2102 along the third direction D3. In some embodiments, the first restraint 2112a can be configured to compress the attachment portion 2102 against the backing surface 2104 of the securing portion 2100 in the closed configuration, which can also limit motion of the attachment portion 2102 along the first direction D1 and/or the second direction D2. The first restraint 2112a can be bent occlusally from a closed configuration-away from the securing member-until the attachment portion 2102 can be removed from the securing portion 2100.

In some embodiments, the first restraint 2112a extends from a gingival aspect of the securing portion 2100 (rather than an occlusal aspect as shown in FIG. 21E). In such embodiments, the free end of the first restraint can be more gingival when in the open configuration and more occlusal when in the closed configuration. For example, the first restraint can be bent occlusally from an open configuration-towards the attachment portion 2102-until the attachment portion 2102 is positioned between the second end portion of the first restraint and the backing surface 2104 of the securing portion 2100.

The second restraint 2112b can, in some embodiments, be configured to bend along a mesiodistal dimension. The free end of the second restraint 2112b can be more distal when in the open configuration and more distal when in the closed configuration (or vice versa depending which side of the securing portion 2100 the restraint 2112b extends from). For example, the second restraint 2112b can be bent mesially from an open configuration-towards the attachment portion 2102—until the attachment portion 2102 is positioned between the second end portion 2130 of the second restraint 2112b and the backing surface 2104 of the securing portion 2100. In this manner, the second restraint 2112b can prevent or limit motion of the attachment portion 2102 along the third direction D3. In some embodiments, the second restraint 2112b can be configured to compress the attachment portion 2102 against the backing surface 2104 of the securing portion 2100 in the closed configuration, which can also limit motion of the attachment portion 2102 along the first direction D1 and/or the second direction D2.

The restraints 2112 can be configured to move between the open and closed configurations based on a geometry and/or a material property of the restraints 2112. For example, the restraints 2112 can comprise one or more articulable regions 2132 at which the restraint 2112 can fold, bend, twist, hinge, rotate, or otherwise deform or move. In some embodiments, the articulable region 2132 can have a reduced thickness relative to other regions of the restraint 2112. As but one example, the articulable region 2132 can have a reduced stiffness relative to other regions of the restraint 2112. Additionally or alternatively, the articulable region 2132 can comprise the entire restraint 2112. The restraint 2112 can move between the open and closed configurations as a result of elastic deformation and/or plastic deformation of the articulable region 2132. In some embodiments, the articulable region 2132 comprises a mechanical joint such as a revolute joint, a universal joint, a prismatic joint, etc.

According to various embodiments, one or more of the restraints 2112 can be monolithic with the securing portion 2100. For example, the securing portion 2100 and restraints 2112 can be formed as a single, continuous component via additive manufacturing, investment casting, milling, machining, or any other suitable manufacturing technique. In some embodiments, the restraints 2112 comprise the same material(s) as the securing portion 2100. Additionally or alternatively, the restraints 2112 or one or more regions thereof can comprise a different material from the securing portion 2100. Such restraints 2112 and securing portion 2100 can be manufactured via multi-material 3D printing, for example.

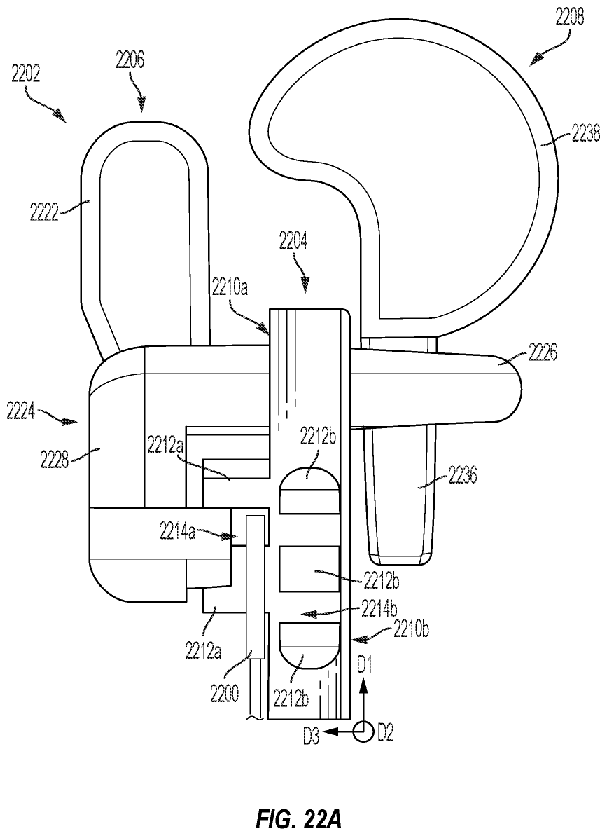

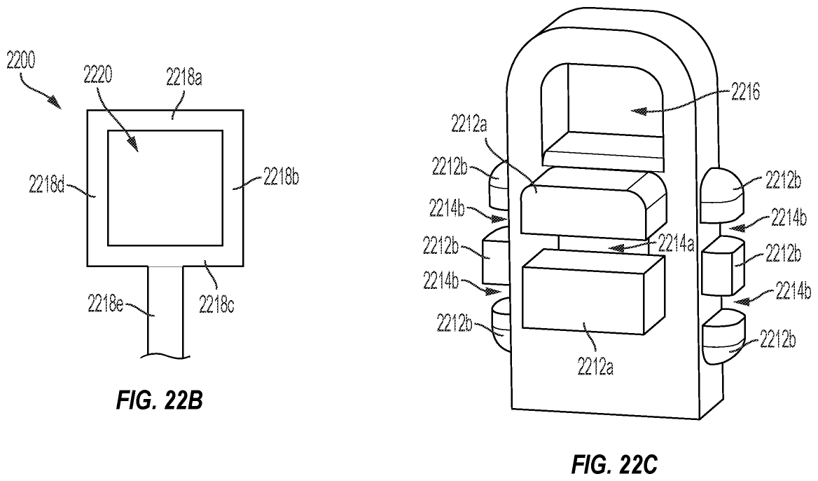

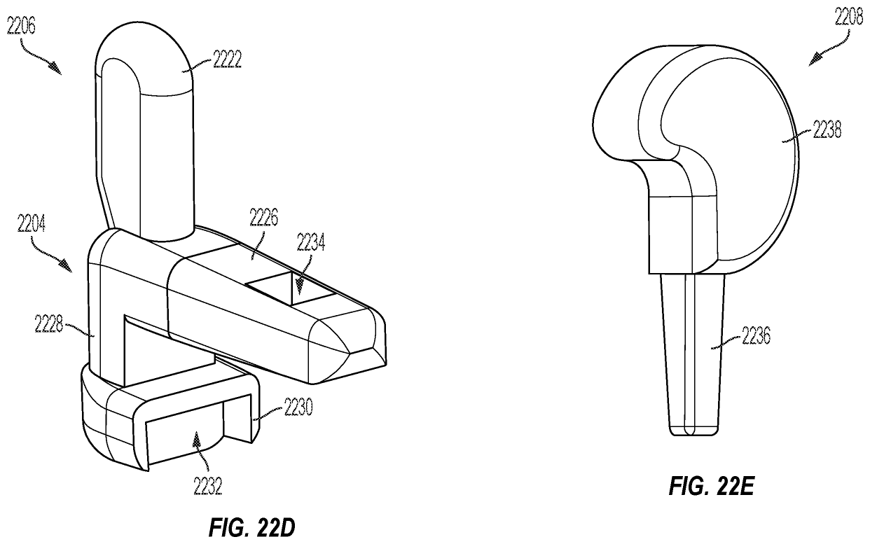

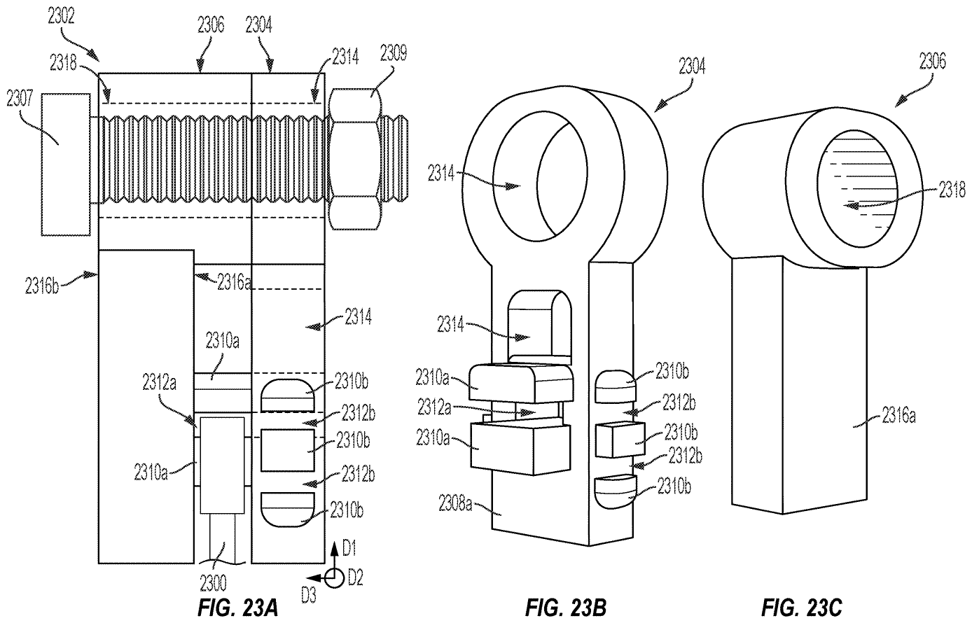

In some embodiments it may be advantageous for a restraint to be separate from the securing portion (e.g., not monolithic with the securing portion). For example, a restraint that is separate from the securing portion can be reused multiple times with the same securing portion for shape forming procedures and/or can be used with securing portions of another fixture, which can reduce costs associated with manufacturing the restraints. FIGS. 22A-23C depict example embodiments of securing assemblies comprising separate securing portions and restraints.

FIG. 22A is a side view of an attachment portion 2200 (shown isolated in FIG. 22B) retained by a securing assembly 2202 comprising a securing portion 2204 (shown isolated in FIG. 22C), a restraint 2206 (shown isolated in FIG. 22D), and a fastener 2208 (shown isolated in FIG. 22E). The securing portion 2204 can be configured to position the attachment portion 2200 at an intended position, and the restraint 2206 and fastener 2208 can cooperate to retain the attachment portion 2200 at the intended position.

The securing portion 2204 can comprise a first broad surface 2210a and, optionally, a second broad surface 2210b opposite the first broad surface 2210a along a thickness of the securing portion 2204. One or more protrusions 2212 and/or one or more channels 2214 of the securing portion 2204 can be configured to facilitate positioning the attachment portion 2200 at an intended position relative to the securing portion 2204. For example, as shown in FIGS. 22A and 22C, the securing portion 2204 can comprise first protrusions 2212a extending away from the first broad surface 2210a (e.g., along a third direction D3) to define a first channel 2214a that is configured to receive the attachment portion 2200 at least partially therein. The securing portion 2204 can comprise second protrusions 2212b extending at an angle with respect to the first and/or second broad surfaces 2210a, 2210b (e.g., along a second direction D2) that define second channels 2214b, which can be configured to receive a fastener at least partially therein to facilitate securing the attachment portion 2200 to the securing portion 2204. In some embodiments, the second channels 2214b are configured to receive an elongated member such as a ligature wire to secure the attachment portion 2200 to the securing portion 2204 alone or in cooperation with the restraint 2206. Additionally or alternatively, the securing portion 2204 can define one or more openings 2216 extending at least partially therethrough and configured to receive a fastener at least partially therein.

As shown in FIG. 22B, the attachment portion 2200 can comprise a first projection 2218a, a second projection 2218b, a third projection 2218c, and a fourth projection 2218d, each extending from a first end at an adjacent one of the projections to a second end at another adjacent one of the projections to define an aperture 2220. In some embodiments, the attachment portion 2200 comprises a fifth projection 2218e extending from a first end at one of the first-fourth projections 2218a-d to a second end away from the attachment portion 2200 (e.g., at an arm of the appliance, at another attachment portion, at an anchor of the appliance, etc.).

When the attachment portion 2200 is at least partially positioned within the first channel 2214a, the first protrusions 2212a of the securing portion 2204 prevent or limit motion of the attachment portion 2200. For example, as shown in FIG. 22A, the first protrusions 2212a can limit motion of the attachment portion 2200 along the second direction D2 and/or a first direction D1. The second and first directions D2, D1 can extend along and/or substantially parallel to the first broad surface 2210a of the securing portion 2204. In some embodiments, the second and first directions D2, D1 are substantially perpendicular to one another. One of the first protrusions 2212a of the securing portion 2204 can be positioned within the aperture 2220 of the attachment portion 2200 such that the first projection 2218a of the securing portion 2204 is positioned between the first protrusions 2212a of the attachment portion 2200. For example, as shown in FIG. 22A, the lowermost first protrusion 2212a along the first direction D1 can be positioned within the aperture 2220. In such embodiments, the uppermost first protrusion 2212a can engage the first projection 2218a to limit upward motion of the attachment portion 2200 along the first direction D1 and the lowermost first protrusion 2212a can engage the first projection 2218a to limit downward motion of the attachment portion 2200 along the first direction D1. The lowermost first protrusion 2212a can also engage the second projection 2218b and/or the fourth projection 2218d to limit motion of the attachment portion 2200 along the second direction D2. Accordingly, the securing portion 2204 is configured to limit motion of the attachment portion 2200 along one or more directions to facilitate positioning the attachment portion 2200 at an intended location.

In the embodiments shown in FIGS. 22A-22E (and others) the securing portion 2204 constrains motion of the attachment portion 2200 along two directions (e.g., the second and first directions D2, D1). However, an intended position of the attachment portion 2200 may be defined in three dimensions. Accordingly, a restraint that constrains motion of the attachment portion 2200 along a third direction can be beneficial and/or necessary to accurately locate the attachment portion 2200 at its intended position. The restraint 2206 shown in FIGS. 22A and 22D is an example of a restraint configured to be secured to the securing portion 2204 to constrain motion of the attachment portion 2200 along the third direction D3.

As shown in FIG. 22D, the restraint 2206 can comprise a grasping portion 2222 and a restraining portion 2224. The grasping portion 2222 can have an ergonomic design such that a human operator securing the restraint 2206 to the securing portion 2204 can easily grasp the grasping portion 2222 and manipulate the restraint 2206. For example, the grasping portion 2222 can have a contoured shape, a size sufficient to enable an operator to use multiple fingers and/or the palm of their hand to grasp the grasping portion 2222, etc. Additionally or alternatively, the grasping portion 2222 can be configured to be grasped and manipulated by a machine configured to secure the restraint 2206 to the securing portion 2204. In some embodiments, the restraint 2206 does not include the grasping portion 2222.

The restraining portion 2224 can be configured to secure the restraint 2206 to the securing portion 2204 and/or limit motion of the attachment portion 2200 relative to the securing portion 2204. For example, as shown in FIG. 22D, the restraining portion 2224 can comprise a first region 2226 and a second region 2228 angled with respect to the first region 2226. The restraint 2206 can be manipulated such that the first region 2226 extends through one of the openings 2216 of the securing portion 2204. When the first region 2226 is positioned within the opening 2216 of the securing portion 2204, for example as shown in FIG. 22A, the second region 2228 limits motion of the attachment portion 2200 away from the securing portion 2204 along the third direction D3 away from the first broad surface 2210a of the securing portion 2204.

When the restraint 2206 is secured to the securing portion 2204 (e.g., via the fastener 2208), the restraint 2206 can prevent or limit motion of the attachment portion 2200 relative to the securing portion 2204 to facilitate retention of the attachment portion 2200 at its intended location. The second region 2228 of the restraining portion 2224 can comprise a limiting surface 2230 that is spaced apart from the first broad surface 2210a of the securing portion 2204 by a predetermined distance along the third direction D3 when the restraint 2206 is secured to the securing portion 2204. In operation, motion of the attachment portion 2200 away from the securing portion 2204 along the third direction D3 can be limited by engagement of the limiting surface 2230 with the attachment portion 2200. In some embodiments, for example as shown in FIGS. 22A and 22D, the second region 2228 of the restraining portion 2224 comprises a recess 2232 configured to at least partially receive one or more of the protrusions 2212 of the securing portion 2204.

In some embodiments, the restraining portion 2224 is configured to engage the fastener 2208. For example, as shown in FIG. 22D, the first region 2226 of the restraining portion 2224 can define an opening 2234 extending at least partially therethrough that is configured to receive the fastener 2208 therein.

The fastener 2208 of the securing assembly 2202 can be configured to releasably couple to the restraint 2206 and/or the securing portion 2204 to facilitate and/or enable securing of the restraint 2206 to the securing portion 2204. The fastener 2208 can comprise any suitable element for coupling the restraint 2206 to the securing portion 2204 including, for example, a pin, a rod, a dowel, a screw, a bolt, a nail, a clip, a clamp, a spring, combinations thereof, or other suitable fasteners. In some embodiments, the fastener 2208 has a first region 2236 sized and shaped to releasably couple to the first region 2226 of the restraining portion 2224 of the restraint 2206 and a second region 2238 sized and shaped to facilitate grasping and manipulation of the fastener 2208. For example, as shown in FIGS. 22A and 22E, the first region 2236 can comprise a tapered pin configured to be positioned at least partially within the opening 2234 of the first region 2226 of the restraining portion 2224 of the restraint 2206. Additionally or alternatively, the second region 2238 of the fastener 2208 can have an ergonomic design. In some embodiments, the second region 2238 of the fastener 2208 has a maximum and/or average dimension greater than a dimension of the opening 2234 in the restraint 2206 such that the second region 2238 prevents the fastener 2208 from slipping through the opening 2234. In such embodiments, the fastener 2208 can be configured to engage the second broad surface 2210b of the securing portion 2204 to prevent or limit motion of the restraint 2206 away from the securing portion 2204 along the third direction D3.

FIG. 23A is a side view of an attachment portion 2300 releasably secured to a securing assembly 2302 in accordance with several embodiments of the present technology. The securing assembly 2302 can comprise a securing portion 2304 (shown isolated in FIG. 23B), a restraint 2306 (shown isolated in FIG. 23C), and a fastener 2307. The securing portion 2304 can be configured to position the attachment portion 2300 at an intended location and the restraint 2306 and securing portion 2304 can be configured to be secured to one another via the fastener 2307 such that the restraint 2306 facilitates locating and/or retaining the attachment portion 2300 at its intended location.

The securing portion 2304 can be similar to any other securing portion disclosed herein, except as detailed below. For example, the securing portion 2304 shown in FIGS. 23A and 23B comprises a first broad surface 2308a and, optionally, a second broad surface 2308b opposite the first broad surface 2308a along a thickness of the securing portion 2304. The securing portion 2304 can comprise one or more protrusions 2310 and/or one or more channels 2312, which may be defined by the protrusion 2310. The protrusions and/or channels 2312 can be configured to locate the attachment portion 2300 at an intended position relative to the securing portion 2304. For example, as shown in FIGS. 23A and 23B, the securing portion 2304 can comprise first protrusions 2310a extending away from the first broad surface 2308a along a third direction D3 and defining a first channel 2312a that is configured to receive the attachment portion 2300 at least partially therein. The securing portion 2304 can comprise second protrusions 2310b extending at an angle with respect to the first and/or second broad surfaces 2308a, 2308b (e.g., along a second direction D2) that define second channels 2312b configured to receive an elongated member (e.g., a ligature wire, etc.) at least partially therein to facilitate securing the attachment portion 2300 to the securing portion 2304. In some embodiments, the securing portion 2304 defines one or more openings 2314 configured to receive one or more fasteners.

When the attachment portion 2300 is at least partially positioned within the first channel 2312a, the first protrusions 2310a of the securing portion 2304 restrain motion of the attachment portion 2300 relative to the securing portion 2304 along the second direction D2 and/or a first direction D1. The second and first directions D2, D1 can extend along and/or substantially parallel to the first broad surface 2210a of the securing portion 2204. In some embodiments, the second and first directions D2, DI are substantially perpendicular to one another.

The restraint 2306 can be configured to be releasably secured to the securing portion 2304 such that the restraint 2306 prevents or limits motion of the attachment portion 2300 relative to the securing portion 2304 in at least one direction. For example, the restraint 2306 shown in FIGS. 23A and 23C is configured to prevent or limit motion of the attachment portion 2300 away from the securing portion 2304 along the third direction D3. The restraint 2306 can comprise a first broad surface 2316a and a second broad surface 2316b opposite the first broad surface 2316a along a thickness of the restraint 2306. In some embodiments, the restraint 2306 defines an opening 2318 configured to receive the fastener 2307 at least partially therein.

As shown in FIGS. 23A-23C, the opening 2318 of the restraint 2306 can be configured to be aligned with a corresponding one of the openings 2314 of the securing portion 2304 such that the fastener 2307 can be inserted through the openings 2318, 2314. Such a fastener can comprise a pin, a rod, a dowel, a screw, a bolt, a nail, a clip, a clamp, a spring, or any other suitable fastener. For example, as shown in FIG. 23A, the fastener 2307 can comprise a hex bolt configured to be inserted into the openings 2318, 2314. A nut 2309 can be screwed onto the hex bolt such that the nut and bolt prevent or limit separation of the restraint 2306 and the securing portion 2304 along the third direction D3. In some embodiments, the securing portion 2304 and/or the restraint 2306 does not comprise one or more of the openings shown in FIGS. 23A-23C. For example, the securing portion 2304 can comprise a pin configured to be inserted into the opening 2318 of the restraint 2306 in place of the opening 2314 shown in FIG. 23B.

When the restraint 2306 is secured to the securing portion 2304, the first broad surface 2316a of the restraint 2306 can be spaced apart from the first broad surface 2308a of the securing portion 2304 to define a dimension of the first channel 2312a along the third direction D3. In this manner, the first broad surfaces 2316a, 2308a can cooperate to prevent or limit motion of the attachment portion 2200 along the third direction D3.

A shape forming fixture of the present technology can be configured to cause an appliance to assume a desired 3D configuration by conforming the appliance to the fixture. For example, a shape forming fixture can comprise a body portion including an appliance-facing surface having a topography based at least in part on a topography of a patient's gingiva. An appliance can be conformed to the shape forming fixture such that one or more portions of the appliance have a topography that is complementary to the topography of the appliance-facing surface of the fixture, and thereby a topography of the patient's gingiva. Such shaping of the appliance can improve patient comfort by preventing or limiting painful impingement of the patient's gingiva by the appliance and/or excessive spacing between the appliance and the patient's gingiva that may cause tongue irritation, speech dysfunction, etc. In some embodiments, simply securing attachment portions of an appliance to securing portions of the fixture may be sufficient to cause the appliance to conform to the fixture; however, this is not always the case. To ensure that the appliance conforms to the fixture, ligature wire can be tightly wrapped around the appliance and fixture. However, this procedure may require wrapping multiple ligature wires around the fixture and appliance, which can be time consuming and laborious.

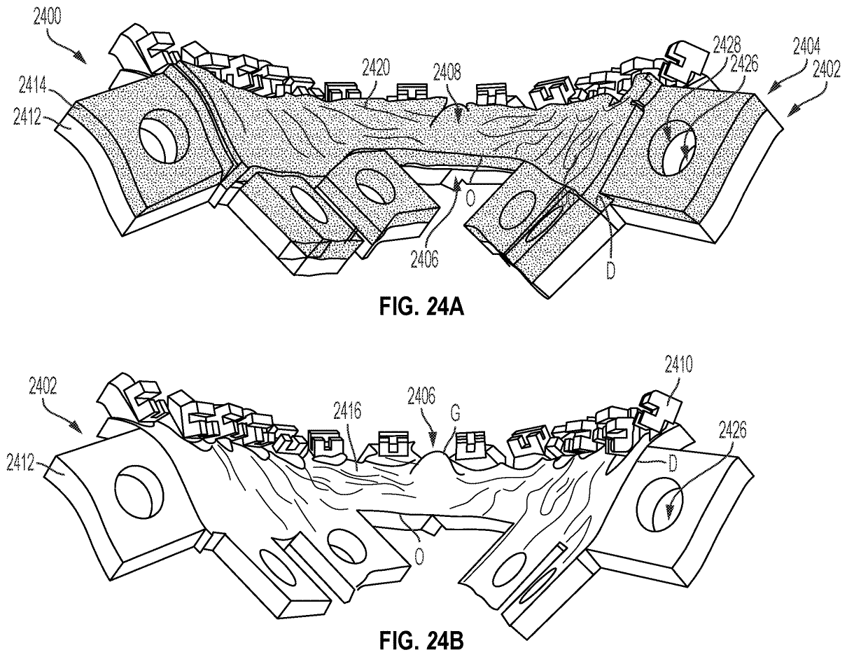

To address the previously-noted challenges, a shape forming fixture of the present technology can comprise two or more forming members that can be used to quickly and easily cause the appliance to conform to the forming members and assume a desired 3D configuration. FIG. 24A depicts such a shape forming fixture 2400 comprising a first forming member 2402 (also shown isolated in FIG. 24B) and a second forming member 2404. As shown in FIGS. 24A and 24B, each of the first and second forming members 2402, 2404 can comprise a body portion 2406, 2408 and, optionally, one or more securing portions 2410 configured to releasably retain attachment portions of an appliance. The appliance can be positioned between the first and second forming members 2402, 2404, which can then be releasably secured to one another such that the appliance conforms to the first and second forming members 2402, 2404. In some embodiments, the first forming member 2402 and/or the second forming member 2404 comprises one or more fastening portions 2412, 2414 configured to facilitate coupling of the first and second forming members 2402, 2404 to one another.

The body portion 2406 of the first forming member 2402 comprises a broad surface 2416 having a first topography corresponding at least in part to a topography of a gingival surface of a patient. In some embodiments, the first topography comprises a plurality of peaks and valleys. The first topography can correspond at least in part to a topography of a lingual surface of a patient's gingiva of the lower dental arch. The gingival surface can be an actual gingival surface (e.g., as characterized in the OTA data, the OTA digital model, a treatment tracking scan, etc.) or a predicted gingival surface (e.g., as characterized in the FTA after gingival morphing has occurred). In some embodiments, the first topography is modified locally or globally with respect to the topography of the gingival surface. For example, the first topography can be smoothed with respect to the topography of the gingival surface (e.g., an amplitude of the peaks and valleys can be reduced), the first topography can be roughened with respect to the topography of the gingival surface, a local peak of the first topography can be modified relative to a corresponding local peak of the gingival topography, etc. Additionally or alternatively, a position of the broad surface 2416 relative to the securing portions 2410 can be modified with respect to a position of the corresponding gingival surface of the patient relative to the patient's teeth.

The body portion 2408 of the second forming member 2404 comprises a broad surface 2420 having a second topography that is at least partially complementary to the first topography of the broad surface 2416 of the first forming member 2402. For example, the broad surface 2420 of the second forming member 2404 can have a valley where the broad surface 2416 of the first forming member 2402 has a peak.

In operation, an appliance can be positioned between the broad surfaces 2416, 2420 of the first and second forming members 2402, 2404. The appliance can be at least partially secured to the first forming member 2402 by securing attachment portions of the appliance to securing portions 2410 of the first forming member 2402. The securing portions 2410 can be similar to any of the securing portions 2410 disclosed herein. For example, positions of the securing portions 2410 can be based on actual and/or modified positions of a patient's teeth. As shown in FIGS. 24A and 24B, in some embodiments the securing portions 2410 extend away from the body portion 2406 of the first forming member 2402 in an occlusal direction, a buccal direction, and/or a lingual direction. In some embodiments, for example as shown in FIG. 24A, the first forming member 2402 includes securing portions 2410 and the second forming member 2404 does not include securing portions 2410. Additionally or alternatively, the second forming member 2404 can comprise securing portions 2410 and, optionally, the first forming member 2402 may not comprise securing portions 2410.

After the appliance has been positioned between the surfaces 2416, 2420 of the first and second forming members 2402, 2404, the forming members 2402, 2404 can be releasably coupled to one another. In some embodiments, each of the forming members 2402, 2404 comprises one or more fastening portions configured to facilitate coupling of the forming members 2402, 2404 to one another. For example, as shown in FIGS. 24A and 24B, the first forming member 2402 can comprise first fastening portions 2412 and the second forming member 2404 can comprise second fastening portions 2414 with the first and second fastening portions 2412, 2414 defining first and second openings 2426, 2428, respectively, extending therethrough. The first and second forming members 2402, 2404 can comprise the same number of fastening portions or different numbers of fastening portions. The first and/or second fastening portions 2412, 2414 can extend away from the body portion 2406, 2408 of their respective forming member 2402, 2404. For example, the fastening portions 2412, 2414 can extend away from a gingival edge and/or surface G of the body portion 2406, 2408 along a gingival direction (see FIGS. 24A and 24B), away from a distal edge and/or surface D of the body portion 2406, 2408 along a distal direction (see FIGS. 24A and 24B), and/or away from an occlusal edge and/or surface O of the body portion 2406, 2408 (not shown). Additionally or alternatively, any of the fastening portions 2412, 2414 can extend away from the body portion 2406, 2408 along a lingual and/or buccal direction.

To secure the first and second forming members 2402, 2404 to one another, the first and second fastening portions 2412, 2414 can be positioned at or adjacent to one another such that one of the first openings 2426 is aligned with a corresponding one of the second openings 2428. The first and second openings 2426, 2428 can be configured to receive at least partially receive a fastener such that the fastener extends through corresponding first and second openings 2426, 2428. Such a fastener can comprise a pin, a rod, a dowel, a screw, a bolt, a nail, a clip, a clamp, a spring, or any other suitable fastener. For example, a hex bolt can be inserted into the openings 2426, 2428 and a nut can be screwed onto the hex bolt such that the nut and bolt prevent or limit separation of the first and second forming members 2402, 2404 at the first and second fastening portions 2412, 2414. Additionally or alternatively, one or more of the fastening portions 2412, 2414 can comprise a fastener. For example, one or more of the first fastening portions 2412 can comprise a ball lock pin configured to be positioned at least partially within one of the second openings 2428 of a corresponding one of the second fastening portions 2414 to engage the second fastening portion 2414 and prevent or limit separation of the first and second forming members 2402, 2404.

Coupling the first and second forming members 2402, 2404 to one another with the appliance positioned between the broad surfaces 2416, 2420 can cause the appliance to conform to the broad surfaces 2416, 2420. The forming members 2402, 2404 can compress the appliance between the broad surfaces 2416, 2420. In some embodiments, a compressive force applied to the appliance by the forming members 2402, 2404 can be controlled and scaled by a human operator and/or a machine performing the compressing.

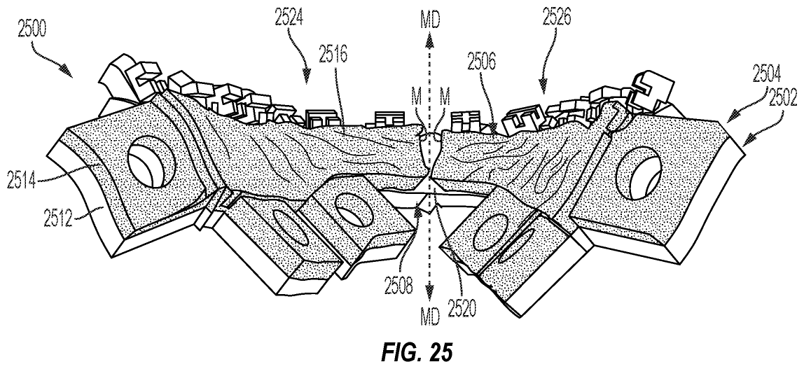

As shown in FIG. 24A, in some embodiments the body portion 2408 of the second forming member 2404 has distal edges D that are substantially aligned with corresponding distal edges D of the body portion 2406 of the first forming member 2402. In these and other embodiments, the body portion 2408 of the second forming member 2404 can be continuous between its distal edges D. However, in some embodiments the body portion of the second forming member can comprise two or more discrete regions that are separate from one another and configured to be independently secured to the first forming member. FIG. 25 depicts a shape forming fixture 2500 comprising a first forming member 2502 and a second forming member 2504. Each of the first and second forming members 2502, 2504 can comprise a body portion 2506, 2508 and, optionally, one or more securing portions 2510 configured to releasably retain attachment portions of an appliance. The appliance can be positioned between the first and second forming members 2502, 2504, which can then be releasably secured to one another such that the appliance conforms to the first and second forming members 2502, 2504. The first forming member 2502 and/or the second forming member 2504 can comprise one or more fastening portions 2512, 2514 configured to facilitate coupling of the first and second forming members 2502, 2504 to one another.

The body portion 2506 of the first forming member 2502 comprises a first broad surface 2516 and a second broad surface (not visible) opposite the first broad surface 2516 along a thickness of the body portion 2506. The first broad surface 2516 of the first forming member 2502 can have a first topography corresponding at least in part to a topography of a gingival surface of a patient, as described herein. The body portion 2508 of the second forming member 2504 comprises a first broad surface 2520 and a second broad surface (not visible) opposite the first broad surface 2520 along a thickness of the body portion 2508. The first broad surface 2520 of the second forming member 2504 can have a second topography that is at least partially complementary to the first topography of the first broad surface 2516 of the first forming member 2502. For example, the first broad surface 2520 of the second forming member 2504 can have a valley where the first broad surface 2516 of the first forming member 2502 has a peak.

The first and second topographies of the first broad surfaces 2516, 2520 can comprise a plurality of peaks and valleys of various shapes and sizes. Such topographies may be challenging to manufacture with high accuracy due to their nonlinear and complex geometries. As a result, it may also be challenging to align the first and second forming members 2502, 2504 such that peaks of the first forming member 2502 are aligned with corresponding valleys of the second forming member 2504 and vice versa. To facilitate alignment and fastening of the first and second forming members 2502, 2504, it can be advantageous to account for possible variations and/or errors in manufacturing of the forming members when designing the first and second forming members 2502, 2504 by including a tolerance and/or allowable play between the first and second forming members 2502, 2504.

To address the previously-noted challenges, the body portion 2508 of the second forming member 2504 can comprise first and second discrete regions 2524, 2526 that each individually have an area that is smaller than an area of the first broad surface 2516 of the first forming member 2502. In some embodiments, the first and second discrete regions 2524, 2526 are configured to be positioned on either side of a mesiodistal midline MD of the body portion 2506 of the first forming member 2502. In the embodiment depicted in FIG. 25, and in others, the second fastening portions 2514 of the second forming member 2504 can be located at generally distal, gingival, and/or occlusal positions relative to the body portion 2508 of the second forming member 2504. Accordingly, the first and second discrete regions 2524, 2526 can each comprise a free mesial edge M that is not necessarily fastened to the first forming member 2502 and/or the other discrete region. The free mesial edges M of the first and second discrete regions 2524, 2526 can permit relative motion of the first and second discrete regions 2524, 2526 to facilitate securing the second forming member 2504 to the first forming member 2502 such that local peaks and valleys of the first surfaces 2516, 2520 are aligned.

In addition to (or instead of) positioning attachment portions of an appliance at intended positions and/or conforming an appliance to a shape forming fixture, it can be useful to position certain other portions of the appliance at intended positions relative to the attachment portions and/or the patient's anatomy. For example, if a portion of an anchor of an appliance is positioned more distally than intended, a force applied to a tooth by an arm of the appliance extending from the specific portion of the anchor to the tooth may differ from a force intended to be applied to the tooth. In some embodiments, positioning certain portions of an appliance at intended positions relative to a gingiva portion (e.g., body portion) of a shape forming fixture can facilitate conforming the appliance to the gingiva portion, which can prevent or limit gingival impingement or oral tissue (e.g., tongue, lip, etc.) irritation when the appliance is installed in the patient's mouth.

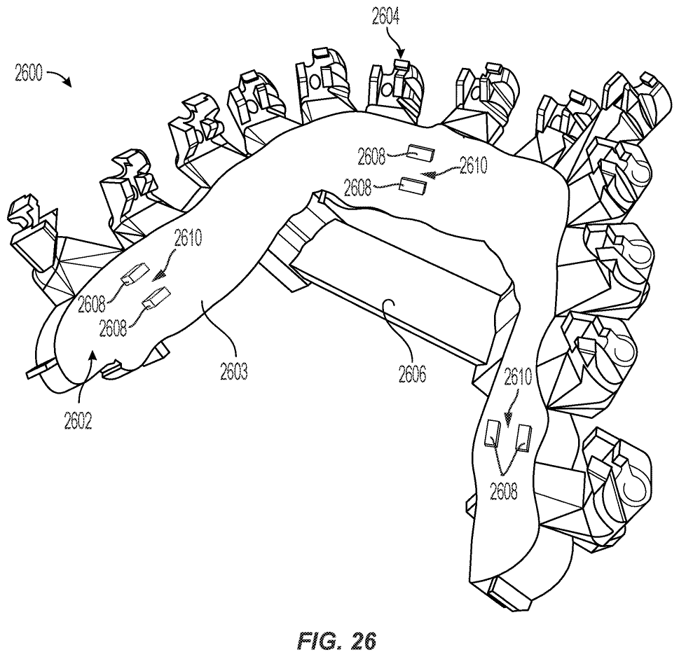

FIG. 26 depicts a fixture 2600 configured in accordance with several embodiments of the present technology. The fixture 2600 can be similar to fixture 1700, fixture 1900, or any other fixture disclosed herein, except as described below. The fixture 2600 can comprise a body portion 2602 and one or more securing portions 2604 carried by the body portion 2602. The body portion 2602 and the securing portions 2604 can be monolithic or the securing portions 2604 can be separate pieces that are coupled to the body portion 2602. The body portion 2602 of the fixture 2600 can have a first surface 2603 at a lingual side of the fixture 2600 and a second surface (not visible) at the buccal side of the fixture 2600 and opposite the first surface 2603 along a thickness of the body portion 2602. The first surface 2603 and/or the second surface can have a shape substantially corresponding to a shape of the patient's gingiva in the OTA, the FTA, and/or one or more ITAs. In some embodiments, the body portion 2602 can be a modified version of the gingiva portion of the OTA digital model, and/or the FTA digital model. In some embodiments, the fixture 2600 includes one or more structural components that generally do not directly engage the appliance and rather stabilize the body portion and/or securing portions. The fixture 2600 in FIG. 26, for example, includes a stabilizer 2606 that extends between opposite sides of the body portion 2602.

The fixture 2600 is configured to be releasably secured to an appliance and retain the appliance in a desired 3D configuration. For example, each of the securing portions 2604 can be configured to releasably retain an attachment portion of the appliance at an intended position with respect to the anchor, other attachment portions, biasing elements, etc. The intended position at which the securing portion 2604 is configured to retain the attachment portion can substantially correspond to and/or be derived from a desired position of the tooth to be treated.

In some embodiments, the appliance is releasably secured to the fixture 2600 such that one or more portions of the appliance substantially conforms to the first surface 2603 of the body portion 2602 of the fixture 2600. As shown in FIG. 26, the fixture 2600 can comprise one or more protrusions 2608 extending away from the first surface 2603 of the body portion 2602. The protrusions 2608 can be configured to facilitate positioning of one or more portions of the appliance in contact with the first surface 2603 and/or locating one or more portions of the appliance at intended positions. In some embodiments, for example as shown in FIG. 26, the fixture 2600 can comprise pairs of protrusions 2608 that are spaced apart from one another along a mesiodistal direction of the body portion 2602. Each pair of protrusions 2608 can be spaced apart along an occlusogingival direction to define gaps 2610 between the protrusions 2608. An anchor of an appliance can be positioned in the gaps 2610 such that the portions of the anchor within the gaps 2610 are located at specific positions along the mesiodistal and occlusogingival directions relative to the body portion 2602 of the fixture. The protrusions 2608 can prevent or limit motion of portions of the anchor in the gaps 2610 along the mesiodistal and occlusogingival directions. In some embodiments, a fastener such as ligature wire, a clamp, a magnet, etc. can be used to secure the anchor to the fixture 2600 once the anchor has been positioned in the gaps 2610 and locate the anchor at an intended position relative to the first surface 2603 along a buccolingual direction. For example, a ligature wire can be wrapped around the body portion 2602 and the anchor to prevent or limit motion of the anchor away from the first surface 2603 of the body portion 2602 and/or cause the anchor to conform to the first surface 2603.

Although three pairs of rectangular protrusions 2608 are shown in FIG. 26, other numbers, shapes, combinations, and locations of the protrusions 2608 are possible. For example, at a given mesiodistal location along the first surface 2603, a single protrusion 2608 can be positioned near a gingival edge G of the first surface 2603 to limit or prevent gingivally directed motion of the appliance relative to the first surface 2603 without constraining occlusally direction motion of the appliance at the given mesiodistal location. In some embodiments, the protrusions 2608 can be configured to substantially surround the appliance.

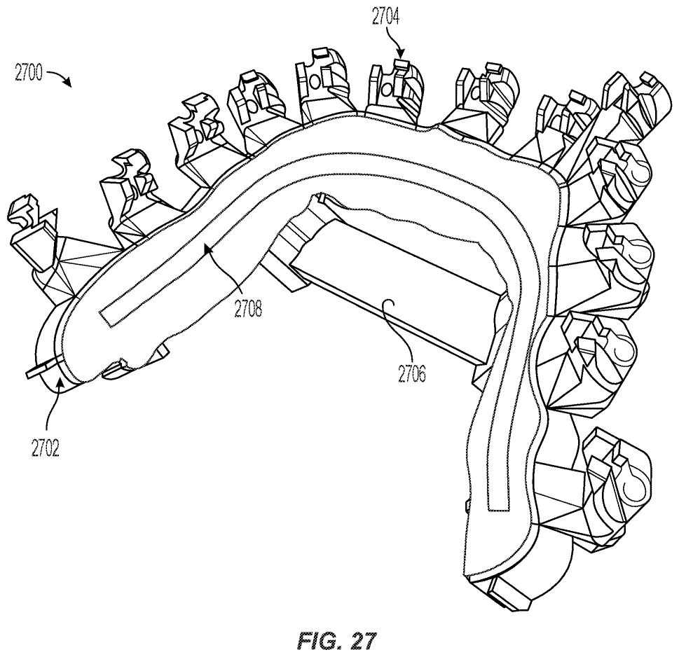

FIG. 27 depicts an example of a fixture 2700 configured to facilitate retention of an appliance in a desired 3D configuration. The fixture 2700 can comprise a body portion 2702 having a first surface at a lingual side of the fixture 2700 and a second surface (not visible) at the buccal side of the fixture 2700 and opposite the first surface along a thickness of the body portion 2702, one or more securing portions 2704 carried by the body portion 2702, and/or one or more structural components 2706 configured to stabilize the body portion 2702 and/or securing portions 2704. The first surface and/or the second surface can have a shape substantially corresponding to and/or based on a shape of the patient's gingiva in the OTA, the FTA, and/or one or more ITAs. The fixture 2700 can be similar to any of the fixtures disclosed herein (e.g., fixture 1700, fixture 1900, fixture 2600, etc.) except as detailed below.

As shown in FIG. 27, the body portion 2702 can have a non-uniform thickness such that the body portion 2702 comprises a groove 2708. The groove 2708 can be configured to receive one or more portions of an appliance at least partially therein to facilitate locating one or more portions of the appliance at intended positions relative to the body portion 2702. In some embodiments, for example as shown in FIG. 27, the groove 2708 can have a shape substantially corresponding to a desired shape of an anchor of an appliance when the appliance is in a 3D configuration. Accordingly, the anchor of the appliance can be positioned in the groove 2708 to position the anchor in a specific, desired 3D shape. The groove 2708 can have a width dimension and/or a length dimension substantially corresponding to a width dimension or a length dimension, respectively, of the anchor it is configured to receive. In some embodiments, the groove 2708 has a width dimension and/or a length dimension slightly larger than the corresponding dimension of the anchor to facilitate insertion of the anchor into the groove 2708. According to various embodiments, the groove 2708 can have a thickness dimension corresponding to a thickness dimension of the anchor it is configured to receive. In these and other embodiments, a broad surface of the groove 2708 positioned within the body portion 2702 that the anchor is configured to be positioned against can have a topography and/or shape substantially corresponding to a topography and/or shape of a corresponding region of a patient's gingiva. For example, the groove 2708 can be formed by extruding portions of the first surface surrounding the groove 2708 in a lingual direction. Accordingly, the broad surface 2708 of the groove 2708 can have the shape and topography of the portion of the original first surface that is not extruded. Additionally or alternatively, the groove 2708 can be formed by reducing a thickness of the body portion 2702 at the groove 2708 such that the groove 2708 extends away from the first surface and into a thickness of the body portion 2702. In some examples, the groove 2708 has a thickness dimension that is small and/or negligible. The groove 2708 can have a thickness that is greater at a perimeter of the groove 2708 than at a center of the groove 2708 to facilitate retention of the anchor within the perimeter of the groove 2708 while maintaining the anchor at a desired distance from the patient's actual gingiva.

### Conclusion

Although many of the embodiments are described above with respect to systems, devices, and methods for orthodontic treatment, the technology is applicable to other applications and/or other approaches. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-27.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A device for holding an orthodontic appliance in a three-dimensional configuration while forming a shape of the orthodontic appliance, the orthodontic appliance comprising an attachment portion configured to be secured to an orthodontic bracket coupled to a tooth of a patient, the device comprising:
a body portion comprising a surface having a shape corresponding at least in part to a gingiva of a patient;
a securing portion carried by the body portion and configured to retain the attachment portion of the orthodontic appliance in a desired position while forming the shape of the orthodontic appliance, wherein the securing portion comprises a first engagement surface, a second engagement surface, and a gap between the first and second engagement surfaces, wherein the gap is configured to receive the attachment portion such that the first engagement surface limits motion of the attachment portion relative to the securing portion along a first dimension and the second engagement surface limits motion of the attachment portion relative to the securing portion along a second dimension angled with respect to the first dimension; and
a restraint configured to limit motion of the attachment portion with respect to the securing portion along, at least, a third dimension substantially perpendicular to at least one of the first dimension or the second dimension.

2. The device of claim 1, wherein the restraint is integral with the securing portion.

3. The device of claim 1, wherein the restraint comprises an arm extending from a first end portion at the securing portion to a second end portion spaced apart from the securing portion, and wherein the arm is movable between an open configuration and a closed configuration.

4. The device of claim 3, wherein, when the arm is in the closed configuration and the attachment portion is positioned in the gap, the arm limits motion of the attachment portion away from the securing portion.

5. The device of claim 3, wherein the arm is movable between the open and closed configurations via deformation of the arm.

6. A device for forming a three-dimensional configuration of an orthodontic appliance comprising an attachment portion configured to be secured to an orthodontic bracket coupled to a tooth of a patient, the attachment portion comprising first and second regions extending along a first direction and third and fourth regions extending along a second direction disposed at an angle to the first direction, wherein, when the appliance is installed in a mouth of a patient, the first region is closer to the patient's gingiva than the second, third, and fourth regions and the third and fourth regions are closer to the patient's gingiva than the second region, the device comprising:
a body portion comprising a surface corresponding at least in part to a gingival surface of a patient; and
a securing portion carried by the body portion and configured to retain the attachment portion of the orthodontic appliance at an intended position, the securing portion comprising first and second engagement surfaces that are substantially parallel to the first direction and a third engagement surface that is substantially parallel to the second direction, wherein, when the attachment portion is retained by the securing portion at the intended position, the first region engages the first engagement surface, the second region engages the second engagement surface, and at least one of the third region or the fourth region engages the third engagement surface; and
a restraint configured to limit motion of the attachment portion with respect to the securing portion along a third dimension substantially perpendicular to at least one of the first direction or the second direction.

7. The device of claim 6, wherein the restraint is integral with the securing portion.

8. The device of claim 6, wherein the restraint comprises an arm extending from a first end portion at the securing portion to a second end portion spaced apart from the securing portion, and wherein the arm is movable between an open configuration and a closed configuration.

9. The device of claim 8, wherein, when the arm is in the closed configuration and the attachment portion is positioned in the gap, the arm limits motion of the attachment portion away from the securing portion.

10. The device of claim 8, wherein the arm is movable between the open and closed configurations via deformation of the arm.

11. The device of claim 6, wherein, when the attachment portion is retained by the securing portion at the intended position, a first surface of the first region engages the first engagement surface, a first surface of the second region engages the second engagement surface, and a first surface of at least one of the third region or the fourth region engages the third engagement surface.

12. The device of claim 11, wherein, when the attachment portion is retained by the securing portion at the intended position, a second surface of the first region opposite the first surface along a width of the first region does not engage the securing portion.

13. The device of claim 11, wherein, when the attachment portion is retained by the securing portion at the intended position, a second surface of the second region opposite the first surface along a width of the second region does not engage the securing portion.

14. The device of claim 11, wherein, when the attachment portion is retained by the securing portion at the intended position, a second surface of the third region opposite the first surface along a width of the third region does not engage the securing portion.

15. The device of claim 11, wherein, when the attachment portion is retained by the securing portion at the intended position, a second surface of the fourth region opposite the first surface along a width of the fourth region does not engage the securing portion.

16. The device of claim 6, wherein the third engagement surface is spaced apart from the first engagement surface along the second direction.

17. The device of claim 6, wherein at least one of the first engagement surface or the third engagement surface is spaced apart from the second engagement surface along the second direction.

18. The device of claim 6, wherein the first and second directions are substantially orthogonal.

19. The device of claim 6, wherein the intended position corresponds to or is derived from a desired position of a tooth of the patient to be moved by the appliance.

20. The device of claim 6, wherein when the attachment portion is retained by the securing portion, one or more portions of the appliance substantially conforms to the body portion of the device.
